(19) United States
(12) Patent Application Publication
(10) Pub. No.: US 2018/0048042 A1
(43) Pub. Date: Feb. 15, 2018

(54) RECHARGEABLE ELECTROCHEMICAL SYSTEM USING TRANSITION METAL PROMOTER

(71) Applicants: Massachusetts Institute of Technology, Cambridge, MA (US); Toyota Motors Europe R&D, Zaventem (BE)

(72) Inventors: Yang Shao-Horn, Newton, MA (US); Koffi Pierre Claver Yao, Somerville, MA (US); Fanny Barde, Zaventem (BE)

(73) Assignees: Massachusetts Institute of Technology, Cambridge, MA (US); Toyota Motors Europe R&D, Zaventem (BE)

(21) Appl. No.: 15/552,912

(22) PCT Filed: Feb. 26, 2016
(86) PCT No.: PCT/US2016/019951

§ 371 Date: Aug. 23, 2017

Related U.S. Application Data
(60) Provisional application No. 62/121,036, filed on Feb. 26, 2015.

(51) Int. Cl. H01M 12/08; H01M 12/06; H01M 8/22; H01M 6/38; H01M 6/50; H01M 8/18; H01M 4/86; H01M 4/96

(52) U.S. Cl. CPC H01M 12/08; H01M 4/8647; H01M 12/06; H01M 4/96; H01M 6/385; H01M 6/5077; H01M 8/184; H01M 8/225; H01M 4/382

(57) ABSTRACT

An electrochemical system can include transition metal nanoparticles as a promoter for an electrode. The transition metal nanoparticles can include molybdenum (Mo), chromium (Cr), and/or the oxides thereof, which can lower recharge potentials and enhance the efficiency. These promoters promote especially the generation of oxygen and this for several cycles of usage of the electrochemical system which is, as a result, rechargeable.

### CLAIM OF PRIORITY

This application claims the benefit of prior U.S. Provisional Application No. 62/121,036 filed on Feb. 26, 2015, which is incorporated by reference in its entirety.

### TECHNICAL FIELD

This invention relates to promoters for batteries.

### BACKGROUND

Lithium-ion (Li-ion) batteries have enabled the recent proliferation of lightweight, long-lived, portable electronic devices. Unfortunately, Li-ion batteries are too expensive and their energy density is too low to enable mass-production of electric vehicles, and there is significant interest in developing new low-cost, high-energy density battery systems. See, M. Armand and J. M. Tarascon, Nature, 2008, 451, 652, and P. G. Bruce, S. A. Freunberger, L. J. Hardwick and J.-M. Tarascon, Nat. Mater., 2012, 11, 19, each of which is incorporated by reference in its entirety. The lithium-air/lithium-oxygen (Li—O₂) battery chemistry currently enjoys great scientific attention as a next-generation rechargeable battery, owing to their high theoretical gravimetric energy density (2000 Wh·kg⁻¹). See, Y.-C. Lu, B. M. Gallant, D. G. Kwabi, J. R. Harding, R. R. Mitchell, M. S. Whittingham and Y. Shao-Horn, Energy Environ. Sci., 2013, 6, 750, which incorporated by reference in its entirety. Analysis by Gallagher et al. predicts gravimetric energy densities of ˜300 Wh·kg⁻¹ for system-level applications in electric vehicles, a twofold increase in energy density relative to Li-ion cells. See, K. G. Gallagher, S. Goebel, T. Greszler, M. Mathias, W. Oelerich, D. Eroglu and V. Srinivasan, Energy Environ. Sci., 2014, 7, 1555, which is incorporated by reference in its entirety. However, many challenges must be resolved before practical Li—O₂ devices can be produced. In particular, Li—O₂ batteries suffer from high charging potentials, low round-trip efficiency, and limited cycle life, which have been attributed to the reactivity of Li—O₂ discharge products and poor oxidation kinetics of Li₂O₂ formed upon discharge. See, M. M. Ottakam Thotiyl, S. A. Freunberger, Z. Peng, Y. Chen, Z. Liu and P. G. Bruce, Nat. Mater., 2013, 12, 1050, B. M. Gallant, R. R. Mitchell, D. G. Kwabi, J. Zhou, L. Zuin, C. V. Thompson and Y. Shao-Horn, J. Phys. Chem. C, 2012, 116, 20800, B. D. McCloskey, A. Speidel, R. Scheffler, D. C. Miller, V. Viswanathan, J. S. Hummelshøj, J. K. Nørskov and A. C. Luntz, J. Phys. Chem. Lett., 2012, 3, 997, M. M. Ottakam Thotiyl, S. A. Freunberger, Z. Peng and P. G. Bruce, J. Am. Chem. Soc., 2013, 135, 494, and Y. Shao, S. Park, J. Xiao, J.-G. Zhang, Y. Wang and J. Liu, ACS Catal., 2012, 2, 844, each of which is incorporated by reference in its entirety.

### SUMMARY

A metal-air electrochemical system can include a first electrode and a second electrode, and an electrolyte in contact with the first electrode and the second electrode, wherein the second electrode includes a promoter including a transition-metal-containing species. In certain embodiments, the first electrode can include lithium (Li). The second electrode can include oxygen.

In certain embodiments, the transition-metal-containing species can be molybdenum (Mo)-containing species. In certain embodiments, the promoter can be in form of nanoparticles.

In certain embodiments, the promoter further can include a metal selected from a group consisting of Ru, Ir, Pt, Au, Cr, and Ni. In certain embodiments, the promoter can include a transition metal oxide. In certain embodiments, the promoter can include a molybdenum oxide.

In certain embodiments, the promoter can include a lithiated molybdenum oxide. In certain embodiments, the promoter can include a Mo metal, a molybdenum oxide, a lithiated molybdenum oxide, a molybdenum sulfide, or any combination thereof. In certain embodiments, the promoter can further include carbon.

In certain embodiments, the second electrode can be pre-filled with Li₂O₂. In certain embodiments, Li₂O₂ can be formed during discharge.

In certain embodiments, the electrolyte can be non-aqueous. In certain embodiments, the electrochemical system can include a conductive support. In certain embodiments, the conductive support can include Au or Al.

In certain embodiments, the second electrode can further include a binder. In certain embodiments, the binder can be an ionomer.

In certain embodiments, the promoter can be partially dissolved in the electrolyte.

An electrode can include a Mo-containing promoter. In certain embodiments, the Mo-containing promoter is in form of nanoparticles. In certain embodiments, the Mo-containing promoter can further include a metal selected from a group consisting of Ru, Au, Cr, and Ni.

In certain embodiments, the Mo-containing promoter can include a molybdenum oxide. In certain embodiments, the Mo-containing promoter can include a lithiated molybdenum oxide. In certain embodiments, the promoter can include a Mo metal, a molybdenum oxide, a lithiated molybdenum oxide, a molybdenum sulfide, or any combination thereof. In certain embodiments, the Mo-containing promoter can further include carbon.

In certain embodiments, the electrode can be pre-filled with Li₂O₂. In certain embodiments, the electrode can further include a binder. In certain embodiments, the binder can be an ionomer.

In certain embodiments, the electrode can be a cathode in a Li-air battery.

A composition can include a Mo-containing material, where the composition is a promoter for an electrode in an electrochemical system. In certain embodiments, the Mo-containing material can be in form of nanoparticles. In certain embodiments, the Mo-containing material further can include a metal selected from a group consisting of Ru, Au, Cr, and Ni.

In certain embodiments, the Mo-containing material can include a molybdenum oxide. In certain embodiments, the Mo-containing material can include a lithiated molybdenum oxide. In certain embodiments, the promoter can include a Mo metal, a molybdenum oxide, a lithiated molybdenum oxide, a molybdenum sulfide, or any combination thereof. In certain embodiments, the Mo-containing material can further include carbon.

In certain embodiments, the composition can further include a binder. In certain embodiments, the binder can be an ionomer.

In certain embodiments, the electrochemical system is a Li-air battery.

A method of generating oxygen can include providing a first electrode and a second electrode, and an electrolyte in contact with the first electrode and the second electrode, wherein the second electrode includes a promoter, where the promoter includes a transition-metal-containing species, and applying an oxygen-generating voltage across the first electrode and the second electrode.

In certain embodiments, the method can further include lithiating the transition-metal-continaing species to a lithiated transition-metal-containing species, and delithiating the lithiated transition-metal-containing species to the metal-containing-containing species. In certain embodiments, the method can further include generating oxygen by repeating the lithiating the transition-metal-continaing species and the delithiating the lithiated transition-metal-containing species.

In certain embodiments, the first electrode can include Li. In certain embodiments, the second electrode can include oxygen.

In certain embodiments, the transition-metal-containing species is Mo-containing species. In certain embodiments, the promoter can be in form of nanoparticles. In certain embodiments, the promoter can further include a metal selected from a group consisting of Ru, Ir, Pt, Au, Cr, and Ni. In certain embodiments, the promoter can include a transition metal oxide. In certain embodiments, the promoter can include a molybdenum oxide. In certain embodiments, the promoter can include a lithiated molybdenum oxide. In certain embodiments, the promoter can include a Mo metal, a molybdenum oxide, a lithiated molybdenum oxide, a molybdenum sulfide, or any combination thereof In certain embodiments, the promoter can further include carbon.

In certain embodiments, the method can further include pre-filling the second electrode with Li₂O₂. In certain embodiments, the method can further include forming Li₂O₂ during discharge.

In certain embodiments, the electrolyte can be non-aqueous. In certain embodiments, the method can further include providing a conductive support. In certain embodiments, the conductive support can include Au or Al.

In certain embodiments, the method can further include providing a binder. In certain embodiments, the binder can be an ionomer.

In certain embodiments, the method can further include selecting the promoter and the electrolyte such that the promoter is partially dissolved in the electrolyte.

In certain embodiments, the method can further include lithiating the Mo-continaing species to a lithiated Mo-containing species, and delithiating the lithiated Mo-containing species to the metal-containing-containing species. In certain embodiments, the method can further include generating oxygen by repeating the lithiating the Mo-continaing species and the delithiating the lithiated Mo-containing species.

An electrochemical system can include a first electrode and a second electrode, and an electrolyte in contact with the first electrode and the second electrode, where the second electrode includes a promoter, wherein the promoter includes molybdenum (Mo), cobalt (Co), or manganese (Mn).

An electrode can include a promoter including a transition metal, where the transition metal is Mo, Co, or Mn.

A composition can include a transition metal, where the transition metal is Mo, Co, or Mn, and where the composition is a promoter for an electrode in a battery.

A method of generating oxygen can include providing a first electrode and a second electrode, and an electrolyte in contact with the first electrode and the second electrode, where the second electrode includes a promoter including a Cr-containing species, applying an oxygen-generating voltage across the first electrode and the second electrode, lithiating the Cr-continaing species to a lithiated Cr-containing species, and, delithiating the lithiated Cr-containing species to the Cr-containing species.

In certain embodiments, the method can further include generating oxygen by repeating the lithiating the Cr-continaing species and the delithiating the lithiated Cr-containing species.

In certain embodiments, the first electrode can include Li. In certain embodiments, the second electrode can include oxygen.

In certain embodiments, the promoter can be in form of nanoparticles. In certain embodiments, the promoter can further include a metal selected from a group consisting of Ru, Ir, Pt, Au, Mo, and Ni. In certain embodiments, the promoter can include a chromium metal oxide. In certain embodiments, the promoter can include a lithiated chromium oxide. In certain embodiments, the promoter can include a Cr metal, a chromium oxide, a lithiated chromium oxide, or any combination thereof In certain embodiments, the promoter can further include carbon.

In certain embodiments, the method can further include pre-filling the second electrode with Li₂O₂. In certain embodiments, the method can further include forming Li₂O₂ during discharge.

In certain embodiments, the electrolyte can be non-aqueous. In certain embodiments, the method can further include providing a conductive support. In certain embodiments, the conductive support can include Au or Al.

In certain embodiments, the method can further include comprising providing a binder. In certain embodiments, the binder can be an ionomer.

In certain embodiments, the method can further include comprising selecting the promoter and the electrolyte such that the promoter is partially dissolved in the electrolyte.

Other aspects, embodiments, and features will be apparent from the following description, the drawings, and the claims.

### BRIEF DESCRIPTION OF THE DRAWINGS

FIG. 1 is a schematic of a metal-air battery.

FIGS. 2A-2C show electrochemical performance of gold foil supported, carbon-free, promoter:Li₂O₂=0.667:1 electrodes. FIG. 2A is a graph showing promoter mass normalized current vs. charging time. FIG. 2B is a graph showing promoter mass normalized current vs. charge passed. FIG. 2C is a graph showing current normalized to the surface area of the promoter nanoparticle vs. charge passed.

FIGS. 3A-3B show electrochemical performance of carbon-supported, promoter: Carbon:Li₂O₂=0.667:1:1 electrodes. FIG. 3A is a graph showing current normalized to promoter metal nanoparticle mass vs. charging time. FIG. 3B is a graph depicting the same normalized current vs. capacity.

FIGS. 4A-4F show current normalized to mass of the promoter metal nanoparticles in carbon-containing VC:promoter:Li₂O₂:LiNafion=1:0.667:1:1 and carbon-free promoter:Li₂O₂=0.667:1 (mass ratios) electrodes at 3.9 V_{Li}. FIG. 4A is a graph showing current normalized per mass of promoter vs. capacity for carbon-containing electrodes. FIG. 4B is a graph showing potential dependent average current normalized per mass of promoter at 3.7, 3.8, 3.9 and 4.0 V_{Li}. FIG. 4C is a graph showing current per mass of promoter vs. charge in carbon-free electrodes. FIG. 4D and FIG. 4E show current per mass of promoter vs. time for carbon-containing and carbon-free electrodes, respectively. FIG. 4F is a graph showing activation time in carbon-free vs. carbon-containing electrodes.

FIGS. 5A-5B show electrochemical performance of metal oxide nanoparticles in carbon-containing VC:promoter:Li₂O₂:LiNafion=1:0.667:1:1 (mass ratios) electrodes at 3.9 V_{Li}. FIG. 5A is a graph showing current per mass of promoter vs. capacity. FIG. 5B is a graph showing current per mass of promoter vs. time.

FIGS. 6A-6B show electrochemical performance of carbon-containing VC: promoter:Li₂O₂:LiNafion=1:0.667:1:1 (mass ratios) electrodes at 3.9 V_{Li}. FIG. 6A is a graph showing current per promoter Brunauer Emmet and Teller (BET) specific surface area vs. capacity for metal nanoparticles promoted electrodes. FIG. 6B is a graph showing current per promoter BET specific surface area vs. capacity for metal oxide nanoparticles promoted electrodes.

FIGS. 7A-7B show experimental evidence of Cr⁶⁺ in tetrahedral environment using Cr K and L edge XAS in carbon-free Cr-promoted electrodes charged at 3.8 V_{Li}. FIG. 7A shows Cr K edge spectra of carbon-free pristine, half-charged and fully charged Cr:Li₂O₂ electrodes with reference K₂CrO₄. FIG. 7B shows Cr L edge spectra of Cr nanoparticles, pristine, half-charged, and fully charged electrodes in the surface sensitive total electron yield (TEY) mode.

FIGS. 8A-8B show surface sensitive transition metal L edge TEY spectra of Mo:Li₂O₂ and Co:Li₂O₂ for the metal nanopowder, pristine, half-charged, and fully charged electrodes at 3.9 V_{Li}. FIG. 8A shows Mo L edge spectra of Mo nanopowder, pristine, half-charged, and fully charged electrodes along with a reference spectrum of Li₂MoO₄. FIG. 8B shows Co L edge spectra of Mo nanopowder, pristine, half-charged, and fully charged electrodes.

FIG. 9 is a graph showing average BET specific surface area specific activity at 3.9 V_{Li} for carbon-free (open symbol) and carbon-containing (filled symbols) versus calculated enthalpies of chemical conversion Li₂O₂+MₐO_{b}±O₂→LiₓM_{y}O_{z} highlighted in Table 2. (Circles): Metal nanoparticles, (Squares): Metal oxides. Triangle markers are used for the case of Mn-based promoters. Dotted lines are provided as a guide and should not be interpreted as linear fits.

FIG. 10 is Raman spectroscopy of pristine carbon-free Mn:Li₂O₂ electrode, Mn nanopowder, and Li₂MnO₃ reference powder. Gold nanoparticles enhanced Raman was used in Mn:Li₂O₂ probing.

FIG. 11 shows X-ray diffraction of synthesized α-MnO₂ nanowires.

FIG. 12 shows electrochemical activities of Cr and Mo in carbon-based electrodes.

FIG. 13 shows X-ray absorption spectroscopy of Cr nanopowder and Cr₂O₃ showing oxidation state of the nanoparticle surfaces. Cr₂O₃ spectra shows that the surface of Cr nanoparticles are predominantly oxidized to Cr₂O₃.

FIG. 14 shows transition metal L edge spectra of Mo nanopowder showing oxidation state of the nanoparticle surfaces. Mo surfaces appear only partially oxidized.

FIG. 15 shows X-ray diffraction pattern of half-charged carbon-free Mo-catalyzed electrode. Clear formation of Li₂MoO₄ is observed in Mo:Li₂O₂ electrodes mid-charge.

FIG. 16 shows transition metal L edge spectra of Co nanopowder showing oxidation state of the nanoparticle surfaces. Surfaces of Co nanoparticles here are likely oxidized to Co₃O₄.

FIGS. 17A-17B show transition metal L edge spectra of Co-promoted and Mn-promoted electrodes at various state of charge.

FIGS. 18A-18C show the potential effect of impurities during Li₂O₂ oxidation in Mo-promoted electrodes (FIG. 18A), Cr-promoted electrodes (FIG. 18B), and Ru-promoted electrodes (FIG. 18C).

FIGS. 19A-19B show the effect of electrolyte water content on the activation of Li₂O₂ oxidation in VC carbon-promoted (VC:Li₂O₂:LiNafion=1:1:1) (FIG. 19A) and Mn-promoted (the least active promoter investigated) (VC:Mn:Li₂O₂:LiNafion=1:0.667:1:1) (FIG. 19B).

FIG. 20 shows schematic of proposed mechanism consisting of chemical conversion of Li₂O₂ with promoter to LiₓM_{y}O_{z} followed by delithiation of LiₓM_{y}O_{z}.

FIGS. 21A-21B show electrochemical performance of carbon-containing VC: promoter:Li₂O₂:LiNafion=1:0.667:1:1 (mass ratios) electrodes at 3.9 V_{Li}. FIG. 21A is a graph showing current per promoter BET specific surface area vs. time for metal nanoparticles promoted electrodes. FIG. 21B is a graph showing current per promoter BET specific surface area vs. time for metal oxide nanoparticles promoted electrodes.

FIG. 22 is a graph showing electrochemical performance of carbon-free Mo:Li₂O₂=0.667:1 (mass ratios, supported on aluminum foil) electrodes at 3.9 V_{Li} and associated background current (Mo on Al foil without Li₂O₂).

FIGS. 23A-23B show pressure tracking of O₂ consumption during first cycle discharge at 200 mA·g⁻¹_{Carbon}=300 mA·g⁻¹_{Promoter} of VC:(Cr, Mo, Ru):LiNafion=1:0.667:1 (mass ratios) electrodes in Li—O₂ cells. FIG. 23A is a graph showing discharge voltage vs. promoter-mass normalized charge. FIG. 23B is a graph showing promoter-mass normalized current and O₂ consumption rate vs. promoter-mass normalized charge.

FIGS. 24A-24F show DEMS tracking of O₂ and CO₂ production during potentiostatic charge at 3.9 V of Li₂O₂-preloaded VC:(Cr, Mo, Ru):Li₂O₂:LiNafion=1:0.66:1:1 (FIGS. 25A-25C) and VC:(Cr, Mo, Ru):LiNafion=1:0.66:1 (mass ratios) electrodes in Li—O₂ cells (FIGS. 25D-25F). FIGS. 24A and 24D show promoter-mass normalized current vs. promoter-mass normalized charge. FIGS. 24B and 24E show promoter-mass normalized O₂ production rate vs. promoter-mass normalized charge. FIGS. 24C and 24F show promoter-mass normalized CO₂ production rate vs. promoter-mass normalized charge.

FIGS. 25A-25B show first cycle charging e⁻/O₂ for Li₂O₂-preloaded VC:(Cr, Mo, Ru):Li₂O₂:LiNafion=1:0.66:1:1 (FIG. 25A) and VC:(Cr, Mo, Ru):LiNafion=1:0.66:1 (mass ratios) electrodes (FIG. 25B) in Li—O₂ cells. Grey dashed line highlights the ideal 2e⁻/O₂.

FIGS. 26A-26F show electron per O₂ during discharge and charge cycling under DEMS of VC:(Mo, Cr, Ru):LiNafion=1:0.667:1 (mass ratios) electrodes in Li—O₂ cells. FIGS. 26A-26C show electron per O₂ during galvanostatic discharge at 200 mA·g⁻¹_{Carbon}=300 mA·g⁻¹_{Promoter}. FIGS. 26D-26F show electron per O₂ during potentiostatic charge at 3.9 V.

FIGS. 27A-27F show cycling pressure and DEMS tracking of O₂ consumption and production of VC:(Mo, Cr, Ru):LiNafion=1:0.66:1 (mass ratios) electrodes in Li—O₂ cells. FIGS. 27A-27C show promoter-mass normalized O₂ consumption and voltage vs. promoter-mass normalized charge during galvanostatic discharge at 200 mA·g⁻¹_{Carbon}=300 mA·g⁻¹_{Promoter}; symbols are consumption rates and solid lines are voltage profiles. FIGS. 27D-27F show promoter-mass normalized O₂ production rate and current vs. promoter-mass normalized charge during potentiostatic charge at 3.9 V_{Li}; symbols are production rates and solid lines are current profiles. Scales of O₂ production rate and current are equivalent.

FIGS. 28A-28D show DEMS tracking vs. time of O₂, CO₂, CO, and H₂O production during potentiostatic charge at 3.9 V of Li₂O₂-preloaded VC:Mo:Li₂O₂:LiNafion=1:0.667:1:1. FIG. 28A shows unprocessed fraction of each species in gas stream measured at the mass spectrometer. FIG. 28B shows current normalized to the mass of Mo promoter. FIG. 28C shows non-normalized cumulative amount of each gas species generated. FIG. 29D shows non-normalized production rate for each species.

FIGS. 29A-29D show DEMS tracking vs. time of O₂, CO₂, CO, and H₂O production during potentiostatic charge at 3.9 V of Li₂O₂-preloaded VC:Cr:Li₂O₂:LiNafion=1:0.667:1:1. FIG. 29A shows unprocessed fraction of each species in gas stream measured at the mass spectrometer. FIG. 29B shows current normalized to the mass of Cr promoter. FIG. 29C shows non-normalized cumulative amount of each gas species generated. FIG. 29D shows non-normalized production rate for each species.

FIGS. 30A-30D show DEMS tracking vs. time of O₂, CO₂, CO, and H₂O production during potentiostatic charge at 3.9 V of Li₂O₂-preloaded VC:Ru:Li₂O₂:LiNafion=1:0.667:1:1. FIG. 30A shows unprocessed fraction of each species in gas stream measured at the mass spectrometer. FIG. 30B shows current normalized to the mass of Ru promoter. FIG. 30C shows non-normalized cumulative amount of each gas species generated. FIG. 30D shows non-normalized production rate for each species.

FIGS. 31A-31D show DEMS tracking vs. time of O₂, CO₂, CO, and H₂O production during potentiostatic charge at 3.9 V of Li₂O₂-preloaded VC:Mo:LiNafion=1:0.667:1. FIG. 31A shows unprocessed fraction of each species in gas stream measured at the mass spectrometer. FIG. 31B shows current normalized to the mass of Mo promoter. FIG. 31C shows non- normalized cumulative amount of each gas species generated. FIG. 31D shows non-normalized production rate for each species.

FIGS. 32A-32D show DEMS tracking vs. time of O₂, CO₂, CO, and H₂O production during potentiostatic charge at 3.9 V of Li₂O₂-preloaded VC:Cr:LiNafion=1:0.667:1. FIG. 32A shows unprocessed fraction of each species in gas stream measured at the mass spectrometer. FIG. 32B shows current normalized to the mass of Cr promoter. FIG. 32C shows non-normalized cumulative amount of each gas species generated. FIG. 32D shows non-normalized production rate for each species.

FIGS. 33A-33D show DEMS tracking vs. time of O₂, CO₂, CO, and H₂O production during potentiostatic charge at 3.9 V of Li₂O₂-preloaded VC:Ru:LiNafion=1:0.667:1. FIG. 33A shows unprocessed fraction of each species in gas stream measured at the mass spectrometer. FIG. 33B shows current normalized to the mass of Ru promoter. FIG. 33C shows non-normalized cumulative amount of each gas species generated. FIG. 33D shows non-normalized production rate for each species.

FIGS. 34A-34D show DEMS tracking vs. time of O₂, CO₂, CO, and H₂O production during potentiostatic charge at 4.4 V (oxidation of VC at 3.9 V_{Li} result in no current) of Li₂O₂-preloaded VC:Li₂O₂:LiNafion=1:1:1. FIG. 34A shows unprocessed fraction of each species in gas stream measured at the mass spectrometer. FIG. 34B shows current normalized to the mass of VC promoter. FIG. 34C shows non-normalized cumulative amount of each gas species generated. FIG. 34D shows non-normalized production rate for each species.

FIGS. 35A-35I show pressure tracking of O₂ consumption on discharge and DEMS tracking of O₂, CO₂, CO, and H₂O production during potentiostatic charge at 3.9 V_{Li} of O₂-electrodes VC:Mo:LiNafion=1:0.667:1. FIGS. 35A, 35D, and 35G show O₂ consumption vs. time on 1^{st}, 2^{nd}, and 3^{rd} cycles discharge. FIGS. 35B, 35E, and 35H show O₂ production vs. time on 1^{st},2^{nd}, and 3^{rd} cycles discharge FIGS. 35C, 35F, and 35I show O₂ production vs. promoter-mass normalized charge on 1^{st}, 2^{nd}, and 3^{rd} cycles charge.

FIGS. 36A-36F show pressure tracking of O₂ consumption on discharge and DEMS tracking of O₂, CO₂, CO, and H₂O production during potentiostatic charge at 3.9 V_{Li} of O₂-electrodes VC:Cr:LiNafion=1:0.667:1. FIGS. 36A, 36D, and 36G show O₂ consumption vs. time on 1^{st}, 2^{nd}, and 3^{rd} cycles discharge. FIGS. 36B, 36E, and 36H show O₂ production vs. time on 1^{st}, 2^{nd}, and 3^{rd} cycles charge. FIGS. 36C and 36F show O₂ production vs. promoter-mass normalized charge on 1^{st}, 2^{nd}, and 3^{rd} cycles charge.

FIGS. 37A-37I show pressure tracking of O₂ consumption on discharge and DEMS tracking of O₂, CO₂, CO, and H₂O production during potentiostatic charge at 3.9 V_{Li} of O₂-electrodes VC:Ru:LiNafion=1:0.667:1. FIGS. 37A, 37D, and 37G show O₂ consumption vs. time on 1^{st}, 2^{nd}, and 3^{rd} cycles discharge. FIGS. 37B, 37E, and 37H show O₂ production vs. time on 1^{st}, 2^{nd}, and 3^{rd} cycles charge. FIGS. 37C, 37F, and 37I show O₂ production vs. promoter-mass normalized charge on 1^{st}, 2^{nd}, and 3^{rd} cycles charge.

FIG. 38 shows the schematic comparison of delithiation of Mo and Mn.

### DETAILED DESCRIPTION

Lithium-oxygen batteries have been referred to as the “holy grail” of battery chemistries for its potential to provide three times the gravimetric energy density of Li-Ion batteries and as such enable similar ranges as current internal combustion engines at comparable system weights. Thus far however, the Li—O₂ electrochemistry is confronted with severe instabilities of electrolyte and carbon-based cathodes which results in poor cycle life and efficiencies. More fundamentally, recharge requires large voltages for oxidation of the insulating Li₂O₂ deposited on discharge resulting in low round trip efficiencies.

Electrochemical systems, electrodes, and compositions including catalytic materials are described, where the catalytic material includes a transition metal. In some cases, the transitional metal can be a molybdenum (Mo). The systems can operate with improved activity, e.g., at low absolute value of the overpotential, high current density, significant efficiency, stability, or a combination of these. The catalytic materials can also be free of expensive precious metals or precious metal oxides. The systems also can operate at or higher than neutral pH, without necessarily requiring highly pure solvent sources, or any combination. The systems, electrodes, systems, and compositions are useful in applications such as energy storage, energy use, and oxygen generation.

Electrolytic devices, fuel cells, and metal-air batteries are non-limiting examples of electrochemical devices provided herein. Energy can be supplied to electrolytic devices by photovoltaic cells, wind power generators, or other energy sources.

Electrolysis refers to the use of an electric current to drive an otherwise non-spontaneous chemical reaction. For example, electrolysis involves a change in redox state of at least one species, and/or formation and/or breaking of at least one chemical bond, by the application of an electric current. Electrolysis of water generally involves splitting water into oxygen gas and hydrogen gas, or oxygen gas and another hydrogen-containing species, or hydrogen gas and another oxygen-containing species, or a combination. In some embodiments, the systems described herein are capable of catalyzing the reverse reaction. That is, a system can be used to produce energy from combining hydrogen and oxygen gases (or other fuels) to produce water.

A power source may supply DC or AC voltage in an electrochemical system. Non-limiting examples include batteries, power grids, regenerative power supplies (e.g., wind power generators, photovoltaic cells, tidal energy generators), generators, and the like. The power source can include one or more such power supplies (e.g., batteries and a photovoltaic cell). In a particular embodiment, the power supply can be one or more photovoltaic cells. In some cases, an electrochemical system may be constructed and arranged to be electrically connectable to and able to be driven by a photovoltaic cell (e.g., the photovoltaic cell may be the voltage or power source for the system). Photovoltaic cells include a photoactive material, which absorbs and converts light to electrical energy.

An electrochemical system may be combined with additional electrochemical system to form a larger device or system. This may take the form of a stack of devices or subsystems (e.g., fuel cell and/or electrolytic device and/or metal-air battery) to form a larger device or system.

Various components of a device, such as the electrodes, power source, electrolyte, separator, container, circuitry, insulating material, gate electrode, etc. can be fabricated by those of ordinary skill in the art from any of a variety of components, as well as those described in any of those patent applications described herein. Components may be molded, machined, extruded, pressed, isopressed, infiltrated, coated, in green or fired states, or formed by any other suitable technique. Those of ordinary skill in the art are readily aware of techniques for forming components of devices herein.

Generally speaking, an electrochemical system includes two electrodes (i.e., an anode and a cathode) in contact with an electrolyte. The electrodes are electrically connected to one another; the electrical connection can, depending on the intended use of the system, include a power source (when the desired electrochemical reactions require electrical energy) or an electrical load (when the desired electrochemical reactions produce electrical energy). An electrochemical system can be used for producing, storing, or converting chemical and/or electrical energy.

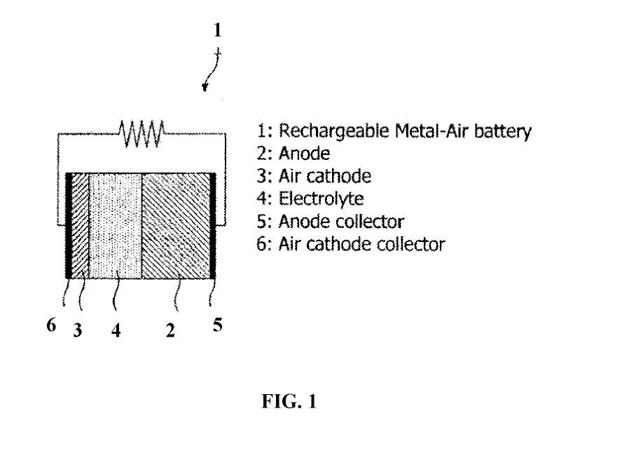

FIG. 1 schematically illustrates a rechargeable metal-air battery 1, which includes anode 2, air cathode 3, electrolyte 4, anode collector 5, and air cathode collector 6. Electrodes (anode 2 and air cathode 3 can each individually include a catalytic material; in particular, in the configuration shown, anode 2 can include a promoter effective for enhanced kinetics and charging efficiency.

Further details of devices and systems, including details of electrode construction, are known in the art. In this regard, see, for example, US Patent Application Publication No. 2009/0068541, which is incorporated by reference in its entirety.

An electrochemical system can include a first electrode and a second electrode; and an electrolyte in contact with the first electrode and the second electrode; wherein the second electrode includes a promoter, where the promoter includes a transition-metal-containing species.

Promoter is defined as a chemical compound capable of being chemically lithiated by lithium oxides and proceeding through delithiation.

The transition-metal-containing-species can include transition metals including Sc, Ti, V, Cr, Mn, Fe, Co, Ni, Cu, Zn, Y, Zr, Nb, Mo, Tc, Ru, Rh, Pd, Ag, Cd, Hf, Ta, W, Re, Os, Ir, Pt, Au, or Hg. In certain embodiments, the transition-metal-containing-species can include transition metal oxides, lithiated transition metal oxides, or transition metal sulfurs. The species can be a molecule, an oxide, a carbide or a sulfide of the transition-metal. Particularly useful transition metal species can include Mo, Cr, Ru, Mn, Fe, Co, Ni, Cu, oxides thereof, lithiated oxides thereof including chemically litiated oxides, or sulfurs thereof. In certain embodiments, the transition metal-containing-species can also include rare earth metals or alkaline earth metals as well as transition metals. Rare earth metals include Sc, Y, La, Ce, Pr, Nd, Pm, Sm, Eu, Gd, Tb, Dy, Ho, Er, Tm, Yb, and Lu. Alkaline earth metals include Be, Mg, Ca, Sr, Ba, and Ra. Transition metals include Sc, Ti, V, Cr, Mn, Fe, Co, Ni, Cu, Zn, Y, Zr, Nb, Mo, Tc, Ru, Rh, Pd, Ag, Cd, Hf, Ta, W, Re, Os, Ir, Pt, Au, and Hg. Particularly useful rare earth metals can include La. Particularly useful alkaline earth metals can include Ca, Sr, and Ba. Particularly useful transition metals can include first-row transition metals, for example, Cr, Mn, Fe, Co, Ni, and Cu. Representative materials include LaCrO₃, LaMnO₃, LaFeO₃, LaCoO₃, LaNiO₃, LaNi_{0.5}Mn_{0.5}O₃, LaCu_{0.5}Mn_{0.5}O₃, La_{0.5}Ca_{0.5}MnO_{3-δ}, La_{0.5}Ca_{0.5}FeO_{3-δ}, La_{0.75}Ca_{0.25}FeO₃₋₆₇ , La_{0.5}Ca_{0.5}CoO_{3-δ}, LaMnO_{3-δ}, and Ba_{0.5}Sr_{0.5}Co_{0.8}Fe_{0.2}O_{3-δ}.

The binder can be a polymer. For example, the polymer can be a polyolefin or a fluorinated polyolefin. In some examples, the binder can be an ionomer, such as sulfonated tetrafluoroethlyene, for example, Nafion, or an ion-exchanged Nafion such as lithim nafion. The promoter disclosed herein enables to decompose at a lower voltage and at faster kinetics, the main product of reaction (Li₂O₂) formed during the typical discharge of a lithium (Li)-air (or Li—O₂) battery. As a result, the lithium-air battery using such a promoter is rechargeable and its columbic efficiency is improved. Also, the kinetics of the electrochemical reactions is improved, i.e. the charge of the battery can be faster. Also this promoter can promote O₂ formation during charge and this for several cycles.

In Li-air (Li—O₂) battery, Li and O₂ combine during the discharge to form Li₂O₂. During the charge Li₂O₂ should decompose and go back to its initial state as O₂ and Li. The decomposition process of Li₂O₂ is known to be sluggish and to happen with a high overvoltage compared to the expected thermodynamic voltage.

Therefore, it is desired (1) to increase the current associated with Li₂O₂ decomposition or Li-air (Li—O₂) battery charging, (2) to decrease/speed up the reaction time for Li₂O₂ decomposition happening during the charge of a Li-air (Li—O₂) battery, (3) to propose a promoter as efficient as precious metal but presenting a lower cost (e.g. Ru-containing promoter is efficient for Li₂O₂ decomposition but is expensive), and (4) to promote the O₂ formation during charge for several cycles, instead of unwanted other species such as CO₂ coming from electrolyte decomposition.

Cr-based compounds (e.g. Cr—NP, Cr₂O₃, LaCrO₃) have been proposed as catalysts for a Li-air battery. See, K. P. C. Yao, Y.-C. Lu, C. V. Amanchukwu, D. G. Kwabi, M. Risch, J. Zhou, A. Grimaud, P. T. Hammond, F. Bardé and Y. Shao-Horn, Phys. Chem. Chem. Phys., 2014, 16, 2297, which is incorporated by reference in its entirety. A review article describes the use of 7 various families of materials to act as catalyst for aqueous or non-aqueous Li-air batteries. See, Z-L Wang, D. Xu, J-J. Xu, X-B. Zhang, Chem. Soc. Rev., 2014, 43, 7746, which is incorporated by reference in its entirety. Recently, molybdenum disulfide was proposed as a catalyst for a Li-air battery. See, Mohammad Asadi, Bijandra Kumar, Cong Liu, Patrick Phillips, Poya Yasaei,

Amirhossein Behranginia, Peter Zapol, Robert F. Klie, Larry A. Curtiss, and Amin Salehi-Khojin, ACS Nano, Articles ASAP, Publication Date (Web): Jan. 20, 2016, which is incorporated by reference in its entirety. A Mo₂C/CNT composite was also proposed as a cathode for a Li—O₂ battery, Won-Jin Kwak, Kah Chun Lau, Chang-Dae Shin, Khalil Amine, Larry A Curtiss, and Yang-Kook Sun, ACS Nano, 2015, 9 (4), pp 4129-4137, which is incorporated by reference in its entirety.

Disclosed herein is a Li-air battery or Li—O₂ battery using molybdenum (Mo)-containing materials as “promoter” for the air cathode used in a metal-air battery. The Li-Air battery or Li—O₂ battery can be non-aqueous. In certain embodiments, the Mo-containing promoter can include Mo metal particles. In certain embodiments, the Mo-containing promoter can be in form of nanoparticles, or a composite including nanoparticles. In certain embodiments, the Mo-containing promoter can include a second or a third material based on carbon, such as Mo/CNT, Mo/CNF, and Mo/graphene or another metal such as for example Mo/Ru, Mo/Au, Mo/Cr, and Mo/Ni. In certain embodiments, the Mo-containing promoter can include an oxide, for example, MoP_{w}, with 0<w<4, such as MoO₂, MoO₃, etc. or a mixture of such oxides. In certain embodiments, the Mo-containing promoter can include a lithiated oxide with formulae LiₓMo_{y}O_{z} with 0<x<7 and 0<y<3 and 1<z<10. For example, the Mo-containing promoter can include Li₂MoO₄, Li₄MoO₅, Li₂MoO₃, LiMoO₂, where y=1, Li₆Mo₂O₇ . . . where y=2, Li₄Mo₃O₈ . . . where y=3, or a mixture of such oxides. In certain embodiments, the Mo-containing promoter can include a mixture of any of the component described above; for example, Mo/MoO_{w} or Mo/LiₓMo_{y}O_{z} or Mo/MoO_{w}/LiₓMo_{y}O_{z}.

A Li-air battery or Li—O₂ Battery also can include chromium (Cr)-containing materials as “promoter” for the air cathode used in a metal-air battery. The Li-Air battery or Li—O₂ battery can be non-aqueous. In certain embodiments, the Cr-containing promoter can include Cr metal particles. In certain embodiments, the Cr-containing promoter can be in form of nanoparticles, or a composite including nanoparticles. In certain embodiments, the Cr-containing promoter can include a second or a third material based on carbon, such as Cr/CNT, Cr/CNF, and Cr/graphene or another metal such as for example Cr/Ru, Cr/Au, Cr/Mo, and Cr/Ni. In certain embodiments, the Cr-containing promoter can include an oxide, for example, CrO_{w}, with 0<w, such as Cr₂O₃, CrO₂, CrO₃ etc. or a mixture of such oxides. In certain embodiments, the Cr-containing promoter can include a lithiated oxide with formulae LiₓCr_{y}O_{z} with 0<x<10 and 0<y<4 and 0<z<10. For example, the Cr-containing promoter can include Cr metal particles, chromium oxides, lithiated chromium oxides, or a mixture of such oxides. The lithiated oxide can be chemically lithiated and then electrochemically delithiated in the battery. In certain embodiments, the Cr-containing promoter can include a mixture of any of the component described above; for example, Cr/CrO_{w} or Cr/LiₓCr_{y}O_{z} or Cr/CrO_{w}/LiₓCr_{y}O_{z}.

The specific surface area of the promoter is a key criterion. The specific surface area is typically measured using N₂ (or other gases) adsorption tests on the material based on the Brunauer, Emmett and Teller (BET) method. From these measurements, for example, the BET value of the specific surface area is determined and expressed in m²/g. The promoter can have preferentially nanometer particle size. The promoter can preferentially present an enthalpy of reaction normal to Li₂O₂ which is negative. The promoters can preferentially present an ability to get partially dissolved in the electrolyte solution. The promoter can be one of the components of the positive air (or O₂) electrode. In certain embodiments, the promoter can be contained in a Li₂O₂ pre-filled electrode. In certain embodiments, Li₂O₂ can be formed in situ during the discharge process. In certain embodiments, the air electrode can contain carbon. In certain embodiments, the battery described above can preferentially contain an electrolyte which favors Li₂O₂ as main discharge reaction products. In certain embodiments, such electrolytes can be dimethoxyethane (DME), glymes, dimethyl sulfoxide (DMSO), ionic liquid (DEME, PP13 . . . ), polymer, gel, or ceramic solid state electrolyte.

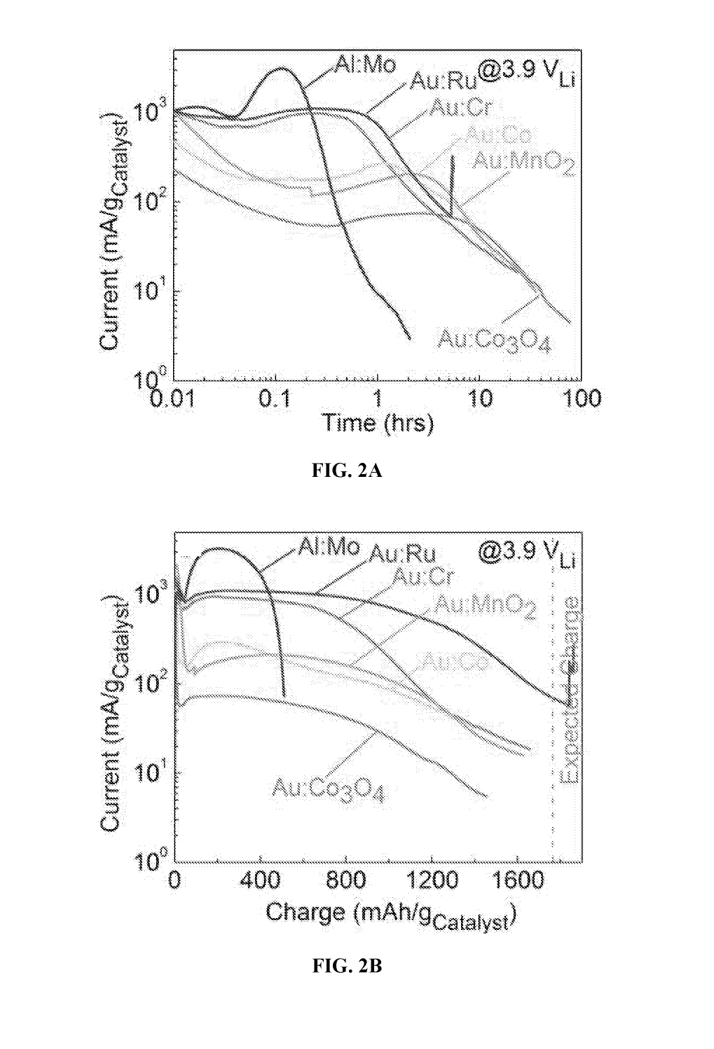

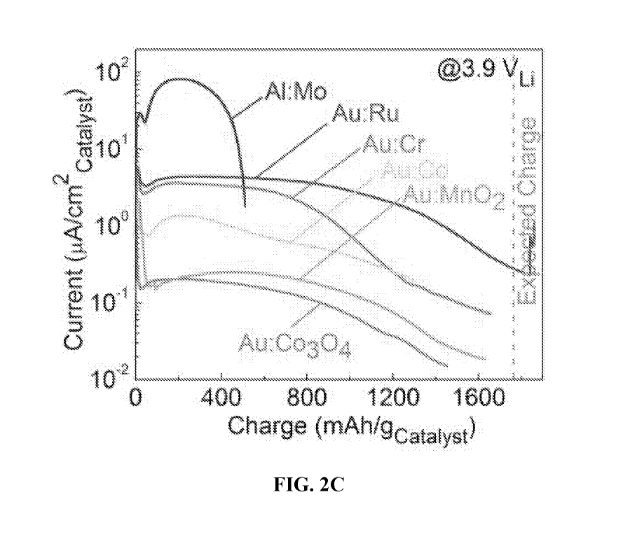

For example, in certain embodiments, Mo nanoparticles can be used as a promoter for Li₂O₂ decomposition in a carbon-free electrode containing Li₂O₂ and the promoter deposited on a conductive support (Au or Al) (see FIGS. 2A-2C).

Briefly, gold foil supported carbon-free and aluminum foil supported carbon-containing electrodes were fabricated at a fixed promoter:Li₂O₂ ratio of 0.667:1. Both carbon-free and carbon-containing electrodes were fabricated following methods reported previously (see, K. P. C. Yao, Y.-C. Lu, C. V. Amanchukwu, D. G. Kwabi, M. Risch, J. Zhou, A. Grimaud, P. T. Hammond, F. Bardé and Y. Shao-Horn, Phys. Chem. Chem. Phys., 2014, 16, 2297, which is incorporated by reference in its entirety) and described below. In carbon-free electrodes, ratios were set to promoter:Li₂O₂=0.667:1 and pressed at 5 tons onto a ½ inch gold substrate upon homogenization in isopropanol. All electrodes and electrochemical cells fabrication were performed baring atmospheric exposure in Argon filled gloveboxes (MBraun, H₂O₂ content below 0.1 ppm, O₂ content below 1%). In addition to fabrication in water-free environment, all electrodes were dried at 70° C. in a Buchi oven under less than 30 mbar vacuum for a minimum of 12 hours. The cells consisted of a 15 mm diameter lithium foil with 150 μL 0.1 M LiClO₄/DME on 2 Celgard C480 capped with a Li₂O₂-preloaded electrode. The 0.1 M LiClO₄ in 1,2 dimethoxyethane electrolyte was acquired from BASF with measured water content below 10 ppm by Karl Fischer titration. The cell is charged at a constant potential fixed to 3.9V vs. Li/Li⁺ in this example.

FIGS. 2A-2C clearly highlights the beneficial effect of using Mo particles as a promoter for Li₂O₂ decomposition in carbon free electrodes. Especially, the current normalized to the specific surface area (FIG. 2C) of the promoter and associated with Li₂O₂ decomposition is one order of magnitude higher compared with promoter s including Ru or Cr.

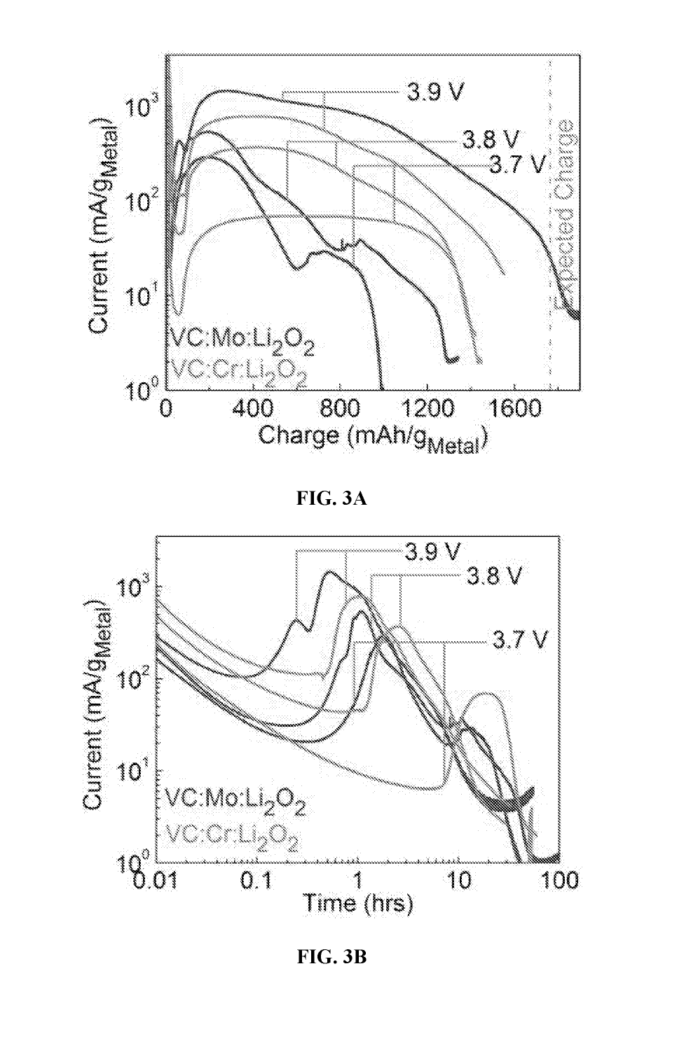

In certain embodiments, Mo nanoparticles can be used as a promoter for Li₂O₂ decomposition in a carbon-containing electrode containing the promoter, Li₂O₂, carbon and a binder (see FIGS. 3A-3B). FIGS. 3A-3B show potential dependent Li₂O₂ oxidation activity of carbon-containing VC:Cr, Mo:Li₂O₂:LiNafion=1:0.667:1:1 electrodes compared at 3.7, 3.8, and 3.9 V_{Li}.

Briefly, carbon-containing electrodes using Vulcan XC72 carbon (VC) as electrically conducting backbone were deposited on battery grade aluminum foil at the ratio of promoter: VC:Li₂O₂:LiNafion binder=0.667:1:1:1. All electrodes and electrochemical cells fabrication were performed baring atmospheric exposure in Argon filled gloveboxes (MBraun, H₂O₂ content below 0.1 ppm, O₂ content below 1%). In addition to fabrication in water-free environment, all electrodes were dried at 70° C. in a Buchi® oven under less than 30 mbar vacuum for a minimum of 12 hours. The cells consisted of a of a 15 mm diameter lithium foil with 150 μL 0.1 M LiClO₄/DME on 2 Celgard C480 capped with a Li₂O₂-preloaded electrode. The 0.1 M LiClO₄ in 1,2 dimethoxyethane electrolyte was acquired from BASF with measured water content below 20 ppm by Karl Fischer titration. The cell is charged at a constant potential fixed to 3.9V, 3.8V or 3.7V vs. Li/Li+ in this example.

FIG. 3A highlights the beneficial effect of using Mo particles as a promoter for Li₂O₂ decomposition in carbon containing electrodes. Especially, the current normalized to the specific surface area of the promoter and associated with Li₂O₂ decomposition is higher compared with Cr promoter, which is itself higher than the current previously reported. This advantage of the present invention is confirmed at various applied potentials which are 3.7V, 3.8V, and 3.9V vs. Li/Li⁺.

FIG. 3B highlights another beneficial effect of the present invention. The time of reaction for Li₂O₂ decomposition is reduced by a factor of 10 (if applying a charging voltage of 3.7V) for the promoter described in the present invention compared to a promoter reported previously. At higher voltages (3.8V and 3.9V) this effect is also observed but is less important.

Briefly, carbon-containing electrodes using Vulcan XC72 carbon as electrically conducting backbone were deposited on battery grade celgard C480 separator at the ratio of promoter:VC:LiNafion binder=0.667:1:1:1). All electrodes and electrochemical cells fabrication were performed baring atmospheric exposure in Argon filled gloveboxes (MBraun, H₂O content below 0.1 ppm, O₂ content below 1%). In addition to fabrication in water-free environment, all electrodes were dried at 70° C. in a Buchi® oven under less than 30 mbar vacuum for a minimum of 12 hours. The cells consisted of a of a 15 mm diameter lithium foil with 150 μL electrolyte on 2 Celgard C480 capped with a carbon-containing electrode. The water content in electrolyte was below 20 ppm by Karl Fischer titration. The cell is charged at a constant potential fixed to 3.9V vs. Li/Li⁺ in this example.

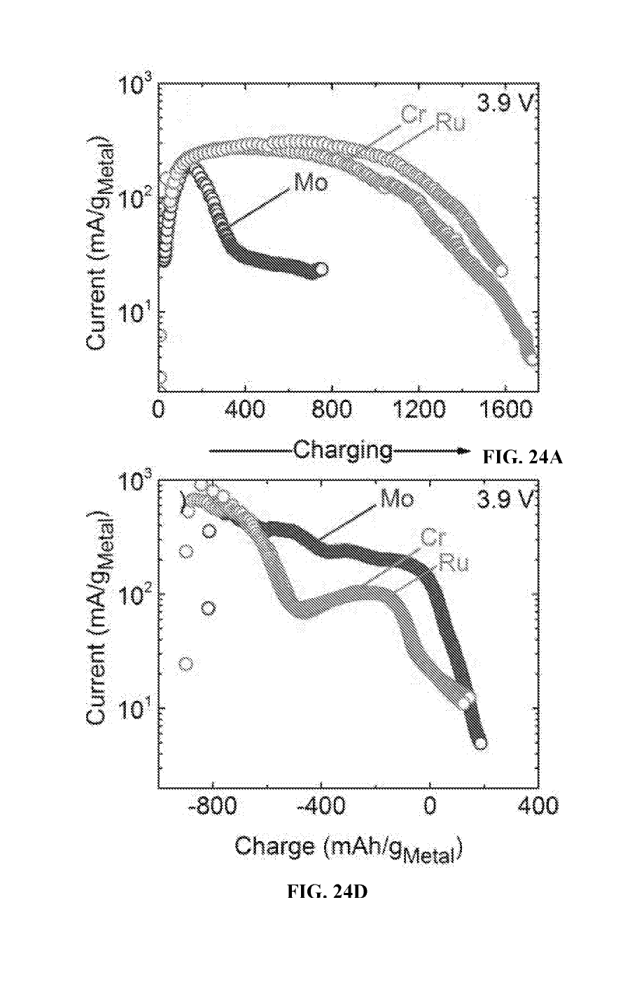

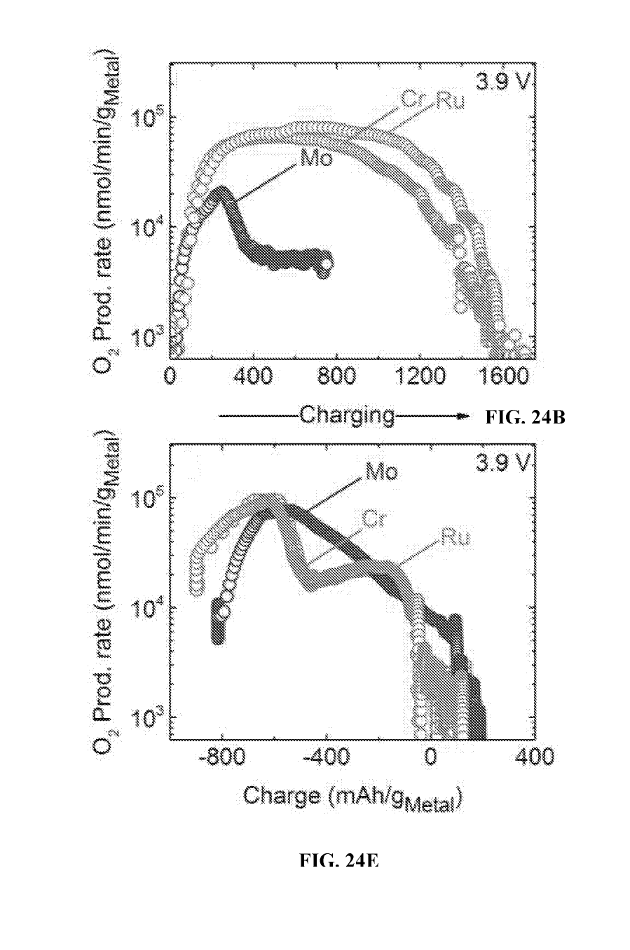

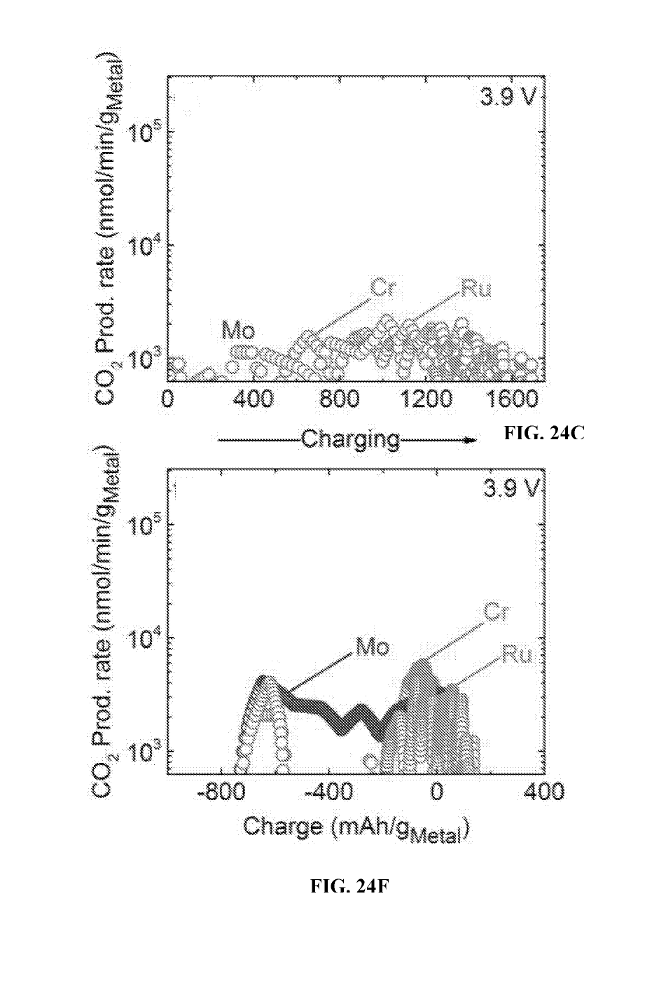

In this example, Li₂O₂ was produced in situ in the cell, not added in the electrode. During the cell cycling, in situ DEMS was performed and gas released during charging identified and quantified. Using the promoters described here, mainly O₂ gas is released and this for several consecutive cycles (FIGS. 24A-24F, 25A-25B, 26A-26F and 27A-27F).

The effort of identifying the best materials has yet to probe the mechanism of enhancement and thereby obtain predictive capability. In the sections presented below, the mechanistic origin of the influence of transition metals and oxides on the Li₂O₂ oxidation kinetics was examined. The results suggest that these materials act as reaction promoters rather than promoters. The enthalpies of conversion of the reactant Li₂O₂ and transition metal (oxides) towards formation of a lithium metal oxide is strongly correlated to electrochemical activity, which offers a rule for identifying promoters of high activity.

Solid-State Activation of Li₂O₂ Oxidation Kinetics and Implications for Li—O₂ Batteries

As one of the most theoretically promising next-generation chemistries, Li—O₂ batteries are the subject of intense research to address their stability, cycling, and efficiency issues. The recharge kinetics of Li—O₂ are especially sluggish, prompting the use of metal nanoparticles as reaction promoters. In this work, the underlying pathway of kinetics enhancement by transition metal and oxide particles was probed using a combination of electrochemistry, X-ray absorption spectroscopy, and thermochemical analysis in carbon-free and carbon-containing electrodes. Disclosed herein is the high activity of the group VI transition metals Mo and Cr, which are comparable to noble metal Ru and coincide with XAS measured changes in surface oxidation state matched to the formation of Li₂MoO₄ and Li₂CrO₄. A strong correlation between conversion enthalpies of Li₂O₂ with the promoter surface (Li₂O₂+MₐO_{b}±O₂→LiₓM_{y}O_{z}) and electrochemical activity is found that unifies the behaviour of solid-state promoters. In the absence of soluble species on charge and the decomposition of Li₂O₂ proceeding through solid solution, enhancement of Li₂O₂ oxidation is mediated by chemical conversion of Li₂O₂ with slow oxidation kinetics to a lithium metal oxide. The mechanistic findings shown below provide new insights into the selection and/or employment of electrode chemistry in Li—O₂ batteries.

The kinetics of Li₂O₂ oxidation in Li—O₂ batteries have been investigated by a number of groups, who show that the charging performance is strongly impacted by the morphology of the Li₂O₂ produced during discharge. For thin layers of Li₂O₂, McCloskey et al. have computed and experimentally measured low charging overpotentials (<0.2 V by cyclic voltammetry) to posit that electrocatalysis for the oxygen evolution reaction (OER) from Li₂O₂ oxidation may not be necessary. See, Y.-C. Lu and Y. Shao-Horn, J. Phys. Chem. Lett., 2012, 4, 93, J. S. Hummelshøj, A. C. Luntz and J. K. Nørskov, J. Chem. Phys., 2013, 138, Y. Mo, S. P. Ong and G. Ceder, Phys. Rev. B, 2011, 84, 205446, B. D. McCloskey, R. Scheffler, A. Speidel, D. S. Bethune, R. M. Shelby and A. C. Luntz, J. Am. Chem. Soc., 2011, 133, 18038, and B. D. McCloskey, R. Scheffler, A. Speidel, G. Girishkumar and A. C. Luntz, J. Phys. Chem. C, 2012, 116, 23897, each of which is incorporated by reference in its entirety. Similarly, Lu et al. have reported evidence showing that electrocatalysis is unnecessary during the removal of the first sub- nanometer of deposited Li₂O₂, where electrochemical oxidation of Li₂O₂ can proceed from first delithiation to form lithium-deficient Li₂₋ₓO₂ followed by oxygen evolution from Li₂O₂. See, Y.-C. Lu, B. M. Gallant, D. G. Kwabi, J. R. Harding, R. R. Mitchell, M. S. Whittingham and Y. Shao-Horn, Energy Environ. Sci., 2013, 6, 750, and Y.-C. Lu and Y. Shao-Horn, J. Phys. Chem. Lett., 2012, 4, 93, each of which is incorporated by reference in its entirety. This concept is consistent with DFT findings and recent results by Ganapathy et al. showing solid-solution lithium deficient Li₂₋ₓO₂ using in operando X-ray diffraction during charge. See, S. Kang, Y. Mo, S. P. Ong and G. Ceder, Chem. Mater., 2013, 25, 3328, and S. Ganapathy, B. D. Adams, G. Stenou, M. S. Anastasaki, K. Goubitz, X.-F. Miao, L. F. Nazar and M. Wagemaker, J. Am. Chem. Soc., 2014, each of which is incorporated by reference in its entirety.

Thicker deposits of Li₂O₂ (i.e. greater depth of discharge) have been shown to require greater overpotentials to oxidize, particularly on carbon electrodes. See, B. M. Gallant, R. R. Mitchell, D. G. Kwabi, J. Zhou, L. Zuin, C. V. Thompson and Y. Shao-Horn, J. Phys. Chem. C, 2012, 116, 20800, M. M. Ottakam Thotiyl, S. A. Freunberger, Z. Peng and P. G. Bruce, J. Am. Chem. Soc., 2013, 135, 494, Y.-C. Lu and Y. Shao-Horn, J. Phys. Chem. Lett., 2012, 4, 93, R. R. Mitchell, B. M. Gallant, C. V. Thompson and Y. Shao-Horn, Energy Environ. Sci., 2011, 4, 2952, F. Li, R. Ohnishi, Y. Yamada, J. Kubota, K. Domen, A. Yamada and H. Zhou, Chem. Commun., 2013, 49, 1175, R. Black, J.-H. Lee, B. Adams, C. A. Mims and L. F. Nazar, Angew. Chem. Int. Ed., 2013, 52, 392, and Y. Cao, S.-R. Cai, S.-C. Fan, W.-Q. Hu, M.-S. Zheng and Q.-F. Dong, Faraday Discuss., 2014, each of which is incorporated by reference in its entirety. This phenomenon is attributed to two different effects: (1) the formation of byproducts during discharge that require a greater potential to oxidize (see, B. M. Gallant, R. R. Mitchell, D. G. Kwabi, J. Zhou, L. Zuin, C. V. Thompson and Y. Shao-Horn, J. Phys. Chem. C, 2012, 116, 20800, B. D. McCloskey, A. Speidel, R. Scheffler, D. C. Miller, V. Viswanathan, J. S. Hummelshøj, J. K. Nørskov and A. C. Luntz, J. Phys. Chem. Lett., 2012, 3, 997, M. M. Ottakam Thotiyl, S. A. Freunberger, Z. Peng and P. G. Bruce, J. Am. Chem. Soc., 2013, 135, 494, B. D. McCloskey, J. M. Garcia and A. C. Luntz, J. Phys. Chem. Lett., 2014, 5, 1230, and S. A. Freunberger, Y. Chen, N. E. Drewett, L. J. Hardwick, F. Bardé and P. G. Bruce, Angew. Chem. Int. Ed., 2011, 50, 8609, each of which is incorporated by reference in its entirety) and (2) the insulating nature of Li₂O₂, which increases the potential needed to drive the oxidation reaction (see, V. Viswanathan, K. S. Thygesen, J. S. Hummelshøj, J. K. Nørskov, G. Girishkumar, B. D. McCloskey and A. C. Luntz, J. Chem. Phys., 2011, 135, S. P. Ong, Y. Mo and G. Ceder, Phys. Rev. B, 2012, 85, 081105, M. D. Radin, J. F. Rodriguez, F. Tian and D. J. Siegel, J. Am. Chem. Soc., 2012, 134, 1093, and P. Albertus, G. Girishkumar, B. McCloskey, R. S. Sanchez-Carrera, B. Kozinsky, J. Christensen and A. C. Luntz, J. Electrochem. Soc., 2011, 158, A343). One group of the main byproducts is carbonates such as Li₂CO₃, which can form from electrolyte decomposition and/or from an interaction between Li₂O₂ and carbon electrodes. High charging overpotentials (typically greater than 1 V) have been reported for a variety of carbon electrodes, from simple porous carbon to graphene, to carbon nanofibers'¹⁷ and nanotubes⁶ at moderate rates 50 to 100 mA·g⁻¹_{carbon}. See, M. M. Ottakam Thotiyl, S. A. Freunberger, Z. Peng and P. G. Bruce, J. Am. Chem. Soc., 2013, 135, 494, Y.-C. Lu and Y. Shao-Horn, J. Phys. Chem. Lett., 2012, 4, 93, F. Li, R. Ohnishi, Y. Yamada, J. Kubota, K. Domen, A. Yamada and H. Zhou, Chem. Commun., 2013, 49, 1175, Y. Cao, S.-R. Cai, S.-C. Fan, W.-Q. Hu, M.-S. Zheng and Q.-F. Dong, Faraday Discuss., 2014, T. Cetinkaya, S. Ozcan, M. Uysal, M. O. Guler and H. Akbulut, J. Power Sources, 2014, 267, 140, R. R. Mitchell, B. M. Gallant, C. V. Thompson and Y. Shao-Horn, Energy Environ. Sci., 2011, 4, 2952, and B. M. Gallant, R. R. Mitchell, D. G. Kwabi, J. Zhou, L. Zuin, C. V. Thompson and Y. Shao-Horn, J. Phys. Chem. C, 2012, 116, 20800, each of which is incorporated by reference in its entirety. In contrast, several groups have reported improved charging performance when carbon-free electrodes were used, such as nanoporous gold, TiC, and Ru on TiSi₂. See, Z. Peng, S. A. Freunberger, Y. Chen and P. G. Bruce, Science, 2012, 337, 563, M. M. Ottakam Thotiyl, S. A. Freunberger, Z. Peng, Y. Chen, Z. Liu and P. G. Bruce, Nat. Mater., 2013, 12, 1050, and J. Xie, X. Yao, I. P. Madden, D.-E. Jiang, L.-Y. Chou, C.-K. Tsung and D. Wang, J. Am. Chem. Soc., 2014, 136, 8903, each of which is incorporated by reference in its entirety. Regarding, the insulating nature of Li₂O₂, Viswanathan et al. have estimated that 5-10 nm layers of insulating Li₂O₂ is sufficient to drive overpotentials greater than 0.6 V. See, V. Viswanathan, K. S. Thygesen, J. S. Hummelshøj, J. K. Nørskov, G. Girishkumar, B. D. McCloskey and A. C. Luntz, J. Chem. Phys., 2011, 135, each of which is incorporated by reference in its entirety.

Several reports have shown that the addition of metal nanoparticles (using either noble or transition metals) show a quantifiable reduction in charging overpotential (see, F. Li, R. Ohnishi, Y. Yamada, J. Kubota, K. Domen, A. Yamada and H. Zhou, Chem. Commun., 2013, 49, 1175., R. Black, J.-H. Lee, B. Adams, C. A. Mims and L. F. Nazar, Angew. Chem. Int. Ed., 2013, 52, 392, Z. Jian, P. Liu, F. Li, P. He, X. Guo, M. Chen and H. Zhou, Angew. Chem. Int. Ed., 2014, 53, 442, F. Li, Y. Chen, D.-M. Tang, Z. Jian, C. Liu, D. Golberg, A. Yamada and H. Zhou, Energy Environ. Sci., 2014, 7, 1648, C. Kavakli, S. Meini, G. Harzer, N. Tsiouvaras, M. Piana, A. Siebel, A. Garsuch, H. A. Gasteiger and J. Herranz, ChemCatChem, 2013, 5, 3358, K. Song, J. Jung, Y.-U. Heo, Y. C. Lee, K. Cho and Y.-M. Kang, Phys. Chem. Chem. Phys., 2013, 15, 20075, J. R. Harding, Y.-C. Lu, Y. Tsukada and Y. Shao-Horn, Phys. Chem. Chem. Phys., 2012, 14, 10540, K. P. C. Yao, Y.-C. Lu, C. V. Amanchukwu, D. G. Kwabi, M. Risch, J. Zhou, A. Grimaud, P. T. Hammond, F. Bardé and Y. Shao-Horn, Phys. Chem. Chem. Phys., 2014, 16, 2297, J. Ming, W. J. Kwak, J. B. Park, C. D. Shin, J. Lu, L. Curtiss, K. Amine and Y. K. Sun, Chemphyschem, 2014, 15, 2070, and B. G. Kim, H.-J. Kim, S. Back, K. W. Nam, Y. Jung, Y.-K. Han and J. W. Choi, Sci. Rep., 2014, 4, each of which is incorporated by reference in its entirety), and can enhance the kinetics of the Li₂O₂ oxidation reaction, yet the origin of this enhancement is not fully understood. No soluble species derived from solid Li₂O₂ have yet been identified on charge using electron paramagnetic resonance, Raman, and rotating ring-disk techniques, which would support a heterogeneous catalysis mechanism. See, R. Cao, E. D. Walter, W. Xu, E. N. Nasybulin, P. Bhattacharya, M. E. Bowden, M. H. Engelhard and J.-G.

Zhang, ChemSusChem, 2014, 7, 2436, Z. Peng, S. A. Freunberger, L. J. Hardwick, Y. Chen, V. Giordani, F. Bark P. Novak, D. Graham, J.-M. Tarascon and P. G. Bruce, Angew. Chem. Int. Ed., 2011, 50, 6351, M. J. Trahan, I. Gunasekara, S. Mukerjee, E. J. Plichta, M. A. Hendrickson and K. M. Abraham, J. Electrochem. Soc., 2014, 161, A1706, M. J. Trahan, S. Mukerjee, E. J. Plichta, M. A. Hendrickson and K. M. Abraham, J. Electrochem. Soc., 2013, 160, A259, and C. N. Satterfield, Heterogeneous catalysis in practice, McGraw-Hill New York, 1980, each of which is incorporated by reference in its entirety. McCloskey et al. attribute the measured enhancement to the catalysis of electrolyte decomposition and efficient removal of parasitic products. See, B. D. McCloskey, R. Scheffler, A. Speidel, D. S. Bethune, R. M. Shelby and A. C. Luntz, J. Am. Chem. Soc., 2011, 133, 18038, which is incorporated by reference in its entirety. In addition, Black et al. proposed that catalyst surfaces promote efficient transport of Li₂₋ₓO₂ species on the electrode surfaces. See, R. Black, J.-H. Lee, B. Adams, C. A. Mims and L. F. Nazar, Angew. Chem. Int. Ed., 2013, 52, 392, which is incorporated by reference in its entirety. Moreover, experiments with soluble redox mediators such as tetrathiafulvalene, 2,2,6,6-tetramethylpiperidinyloxyl, and iodine have shown to greatly reduce the overpotential required to charge Li—O₂ batteries, which suggests that the Li₂O₂ oxidation kinetics can be directly influenced by redox exchange with a promoter for surface charge transfer. See, G. V. Chase, S. Zecevic, T. W. Wesley, J. Uddin, K. A. Sasaki, P. G. Vincent, V. Bryantsev, M. Blanco and D. D. Addison, Soluble oxygen evolving catalysts for rechargeable metal-air batteries, USPTO, 2012/0028137, 2012, Y. Chen, S. A. Freunberger, Z. Peng, 0. Fontaine and P. G. Bruce, Nat. Chem., 2013, 5, 489, B. J. Bergner, A. Schürmann, K. Peppler, A. Garsuch and J. Janek, J. Am. Chem. Soc., 2014, 136, 15054, and H.-D. Lim, H. Song, J. Kim, H. Gwon, Y. Bae, K.-Y. Park, J. Hong, H. Kim, T. Kim, Y. H. Kim, X. Lepró, R. Ovalle-Robles, R. H. Baughman and K. Kang, Angew. Chem. Int. Ed., 2014, 53, 3926, each of which is incorporated by reference in its entirety. In summary, it is not yet understood how solid-state metal nanoparticles can alter the reaction pathways and enhance the kinetics of Li₂O₂ oxidation.

Disclosed herein is the enhancement of Li₂O₂ oxidation kinetics with transition metal nanoparticles, such as Co, Mo, Cr and Ru, using electrodes preloaded with commercial crystalline Li₂O₂ in both carbon-free and carbon-containing electrodes developed recently (see, J. R. Harding, Y.-C. Lu, Y. Tsukada and Y. Shao-Horn, Phys. Chem. Chem. Phys., 2012, 14, 10540, and K. P. C. Yao, Y.-C. Lu, C. V. Amanchukwu, D. G. Kwabi, M. Risch, J. Zhou, A. Grimaud, P. T. Hammond, F. Bardé and Y. Shao-Horn, Phys. Chem. Chem. Phys., 2014, 16, 2297, each of which is incorporated by reference in its entirety). Using Li₂O₂-loaded electrodes minimizes the interference of catalyst-dependent parasitic discharge products as well as crystallinity and morphology variations in electrochemically formed Li₂O₂ on the Li₂O₂ oxidation kinetics. See, B. M. Gallant, R. R. Mitchell, D. G. Kwabi, J. Zhou, L. Zuin, C. V. Thompson and Y. Shao-Horn, J. Phys. Chem. C, 2012, 116, 20800, S. A. Freunberger, Y. Chen, N. E. Drewett, L. J. Hardwick, F. Bardé and P. G. Bruce, Angew. Chem. Int. Ed., 2011, 50, 8609, and B. G. Kim, H.-J. Kim, S. Back, K. W. Nam, Y. Jung, Y.-K. Han and J. W. Choi, Sci. Rep., 2014, 4, each of which is incorporated by reference in its entirety. As the surfaces of these nanoparticles are likely oxidized, the activation of Li₂O₂ oxidation kinetics was also compared using corresponding metal oxides including MoO₃, Cr₂O₃, RuO₂, Co₃O₄, and α-MnO₂. Ex situ X-ray absorption spectroscopy (XAS) and inductively coupled plasma atomic emission spectra (ICP-AES) of electrodes before and after charging are used to provide insights into processes potentially responsible for the activation of Li₂O₂ kinetics. Correlating the enhanced Li₂O₂ oxidation kinetics with the enthalpy of conversion Li₂O₂+MₐO_{b}±O₂→LiₓM_{y}O_{z} allows us to propose a unifying descriptor and a pathway for the solid-state activation of Li₂O₂ electro-oxidation activity across transition metal nanoparticles and oxides. In light of the proposed mechanism, the added nanoparticles are referred as “promoters” throughout the text.

I. Increased Li₂O₂ Oxidation Kinetics With Nonprecious Transition Metal Nanoparticles

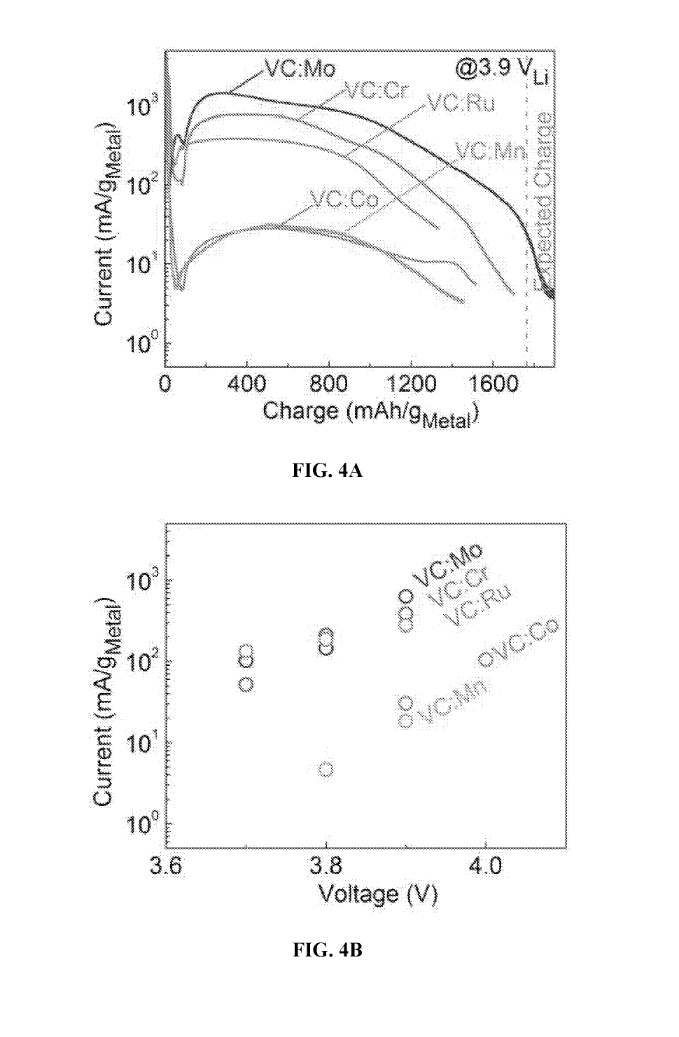

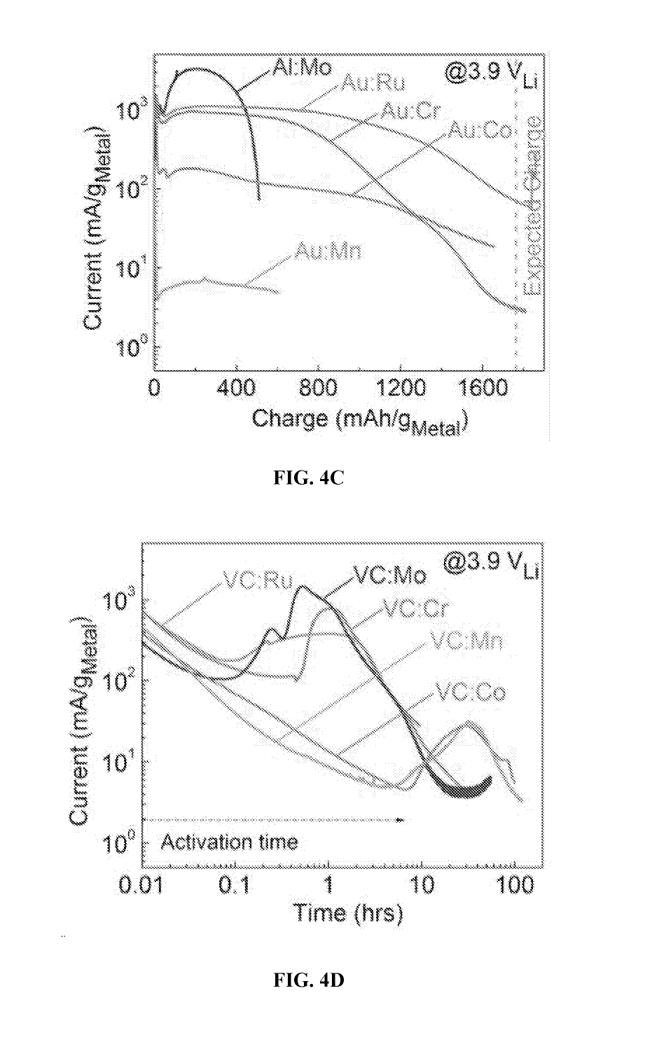

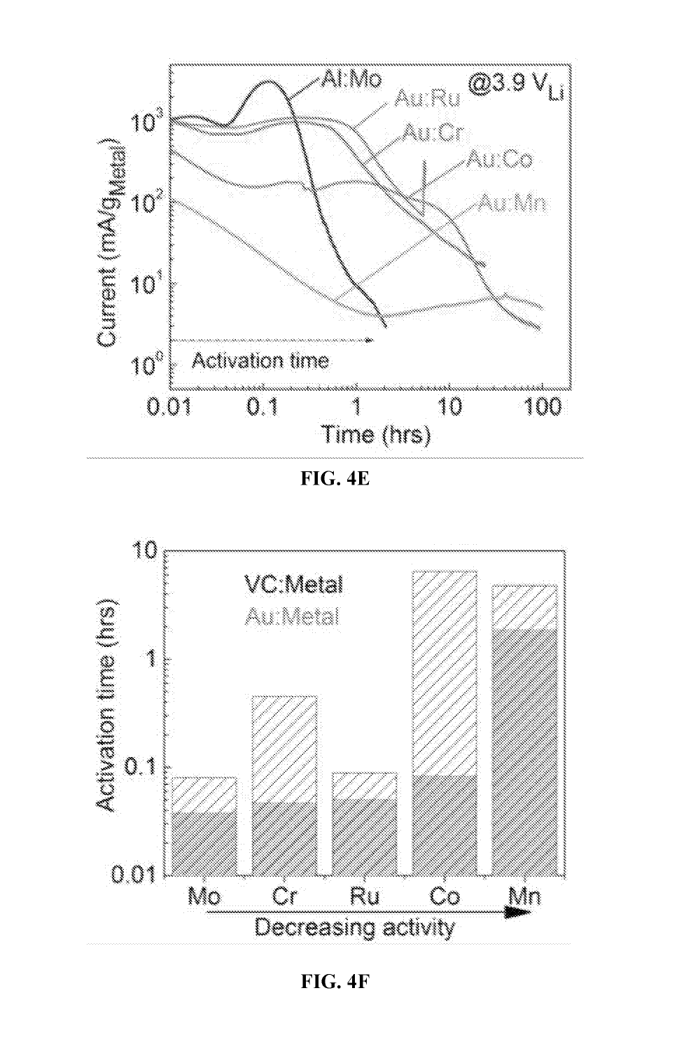

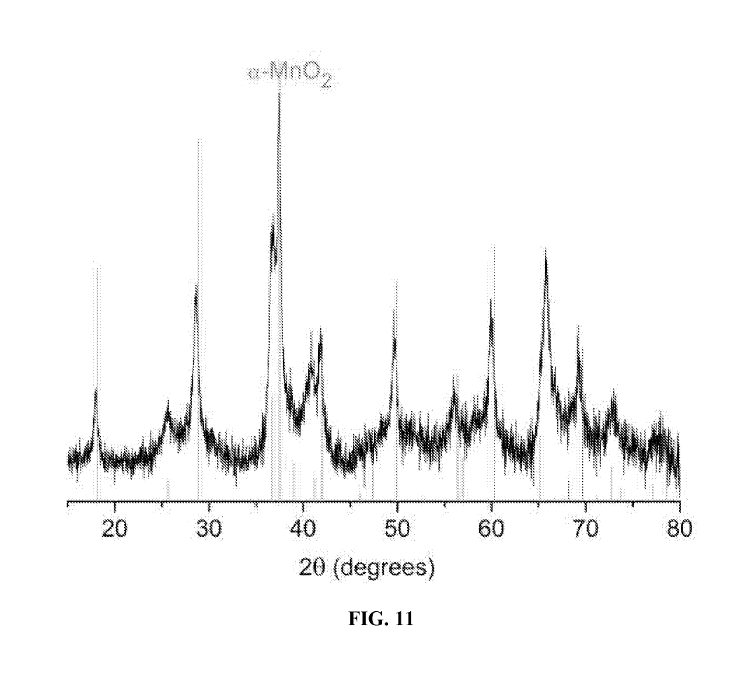

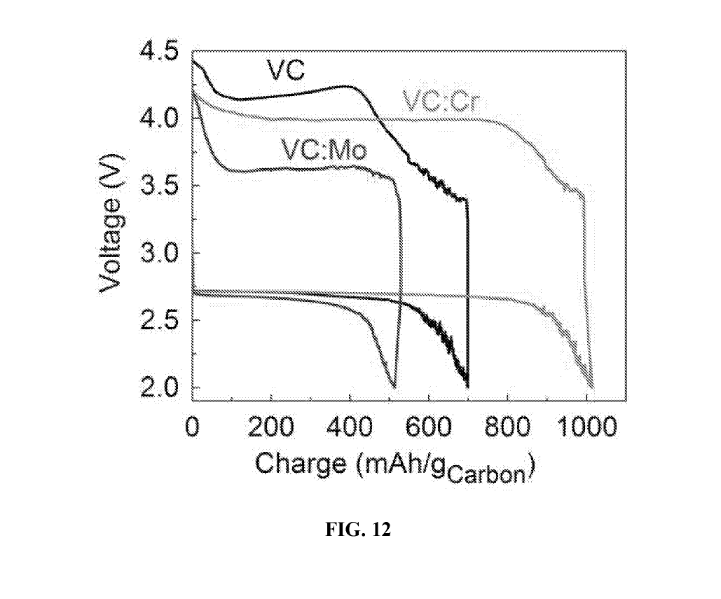

Carbon-containing and carbon-free Li₂O₂-loaded electrodes promoted by bulk transition metals nanoparticles Mo, Cr, Ru, Co, and Mn were examined, which revealed high activities of group VI Mo and Cr nanoparticles. Note that aluminum foil was used as support for carbon-free Mo electrodes due to embrittlement of the Au support in presence of Mo. FIG. 4A compares the gravimetric Li₂O₂ oxidation current (normalized per mass of promoter) of Cr and Mo compared to Co, Mn, and Ru in carbon-containing electrodes at 3.9 V vs. Li (V_{Li}). Cr and Mo were found to exhibit activities on the orders of 1000 mA·g⁻¹_{Promoter} at 3.9 V_{Li}, which is comparable to noble metal Ru in this work and previous studies (see, J. R. Harding, Y.-C. Lu, Y. Tsukada and Y. Shao-Horn, Phys. Chem. Chem. Phys., 2012, 14, 10540, which is incorporated by reference in its entirety), and more than an order of magnitude greater than those of Co and Mn. This enhancement of the Li₂O₂ oxidation kinetic is confirmed, in FIG. 12, during galvanostatic charging at 100 mA·g⁻¹_{Carbon} after discharge where approximately 600 and 200 mV reduction in the charging voltage compared to the base carbon support is observed for Mo and Cr electrodes, respectively. FIG. 12 shows galvanostatic performance of carbon-containing VC:promoter::LiNafion=1:0.667:1 (mass ratios) air electrodes at 100 mA/g_{Carbon}. The increased activity of Cr and Mo promoted is confirmed during charging after discharge (in operando formation of Li₂O₂ followed by its oxidation). Mo-promoted electrodes had higher oxidation currents than those by Cr at 3.7, 3.8, and 3.9 V_{Li}, as shown in FIGS. 3A-3B and 4B. The gravimetric oxidation currents of Li₂O₂ promoted by Mo, Cr, Ru, Co, and Mn was analysed in carbon-free electrodes (FIG. 4C), where a similar trend of Mo>Cr≈Ru>Co>Mn to that shown in FIG. 4A was observed. This result suggests that the reported reactivity of Li₂O₂ with carbon support does not alter the activity trend. See, B. D. McCloskey, A. Speidel, R. Scheffler, D. C. Miller, V. Viswanathan, J. S. Hummelshoj, J. K. Nørskov and A. C. Luntz, J. Phys. Chem. Lett., 2012, 3, 997, and D. M. Itkis, D. A. Semenenko, E. Y. Kataev, A. I. Belova, V. S. Neudachina, A. P. Sirotina, M. Havecker, D. Teschner, A. Knop-Gericke, P. Dudin, A. Barinov, E. A. Goodilin, Y. Shao-Horn and L. V. Yashina, Nano Lett., 2013, 13, 4697, each of which is incorporated by reference in its entirety. Furthermore, this result cannot be explained by the hypothesis previously reported by McCloskey et al. (B. D. McCloskey, R. Scheffler, A. Speidel, D. S. Bethune, R. M. Shelby and A. C. Luntz, J. Am. Chem. Soc., 2011, 133, 18038, which is incorporated by reference in its entirety) that kinetic enhancement of the Li₂O₂ oxidation by carbon-supported Pt, MnO₂ and Au during Li—O₂ cells charging is mainly an artefact of enhanced removal of parasitic discharge products. Considerably lower capacities than the expected (1168 mAh·g⁻¹_{Li2O2≡}=1751 mAh·g⁻¹ₘₑₜₐₗ) were observed for carbon-free Mo-promoted electrodes while recharge was reasonably complete in carbon and binder containing electrodes (FIG. 4A vs. FIG. 4C). This can be attributed to poor mixing of high-density Mo nanoparticles (10.3 g·cm⁻³) and the lower-density Li₂O₂ (2.31 g·cm⁻³) in isopropanol prior to fabrication of the carbon-free electrode.

The current profile versus time for the same five representative metal nanoparticle promoters are further analysed in FIGS. 4D, 4E, and 4F. The time delay incurred from the start of charging up to the first local minimum (initial current dip) is designated as “activation time” and graphed in FIG. 4F for carbon-free and carbon-containing electrodes. Except for Mn, the delay in electrode activation increased from carbon-free to carbon-containing electrodes from the order of tens of minutes in the absence of carbon to the order of hours in presence of a carbon support. This difference is likely due to the reactivity between carbon and Li₂O₂ resulting in the formation of Li₂CO₃ in the carbon-containing electrodes, which both decreases the exchange current of the Li₂O₂ oxidation reaction but also presents a high reversible redox potential of 3.5 V_{Li} adversarial to its oxidative removal. See, B. D. McCloskey, A. Speidel, R. Scheffler, D. C. Miller, V. Viswanathan, J. S. Hummelshøj, J. K. Nørskov and A. C. Luntz, J. Phys. Chem. Lett., 2012, 3, 997, M. M. Ottakam Thotiyl, S. A. Freunberger, Z. Peng and P. G. Bruce, J. Am. Chem. Soc., 2013, 135, 494, K. P. C. Yao, D. G. Kwabi, R. A. Quinlan, A. N. Mansour, A. Grimaud, Y.-L. Lee, Y.-C. Lu and Y. Shao-Horn, J. Electrochem. Soc., 2013, 160, A824, R. Wang, X. Yu, J. Bai, H. Li, X. Huang, L. Chen and X. Yang, J. Power Sources, 2012, 218, 113, and S. A. Freunberger, Y. Chen, Z. Peng, J. M. Griffin, L. J. Hardwick, F. Bardé, P. Novak and P. G. Bruce, J. Am. Chem. Soc., 2011, 133, 8040, each of which is incorporated by reference in its entirety. This phenomenon is well illustrated in the work of Thotiyl et al. showing as much as a 40-fold increase in Li₂CO₃ formation using a carbon electrode compared to a carbon-free TiC electrode. See, M. M. Ottakam Thotiyl, S. A. Freunberger, Z. Peng, Y. Chen, Z. Liu and P. G. Bruce, Nat. Mater., 2013, 12, 1050, and M. M. Ottakam Thotiyl, S. A. Freunberger, Z. Peng and P. G. Bruce, J. Am. Chem. Soc., 2013, 135, 494, each of which is incorporated by reference in its entirety. The impaired kinetics of Li₂O₂ oxidation in carbon-containing electrodes as compared to carbon-free electrodes reinforces the general trend of improved cell performance and cycling in carbon-free electrodes such as TiC and nanoporous gold. See, M. M. Ottakam Thotiyl, S. A. Freunberger, Z. Peng, Y. Chen, Z. Liu and P. G. Bruce, Nat. Mater., 2013, 12, 1050, and Z. Peng, S. A. Freunberger, Y. Chen and P. G. Bruce, Science, 2012, 337, 563, each of which is incorporated by reference in its entirety. Noteworthy is the general reduction in activation time (and time to current maximum) as the promoter activity increases. The delay prior to rise to peak current follows activity, hinting at more rapid nucleation of active species at the interface of the promoter and reactant Li₂O₂ for higher activity electrodes.

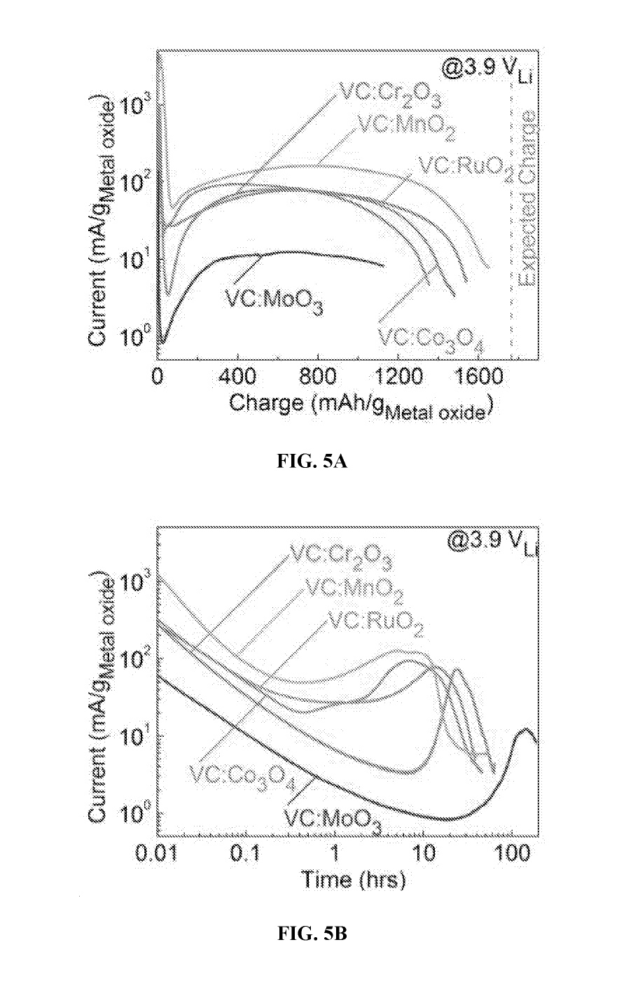

Metal oxides including MoO₃, Cr₂O₃, RuO₂, Co₃O₄ and α-MnO₂, were investigated in carbon-containing electrodes (FIGS. 5A-5B). Interestingly, the spread in the gravimetric activity among all the oxides examined is much smaller than that found for metal nanoparticles. This clustering of activities in the metal oxide was similarly observed using perovskites Ba_{0.5}Sr_{0.5}Co_{0.8}Fe_{0.2}O_{3.δ}, LaCrO₃, LaNiO₃, LaFeO₃, and LaMnO_{3+δ}. See, K. P. C. Yao, Y.-C. Lu, C. V. Amanchukwu, D. G. Kwabi, M. Risch, J. Zhou, A. Grimaud, P. T. Hammond, F. Bardé and Y. Shao-Horn, Phys. Chem. Chem. Phys., 2014, 16, 2297, which is incorporated by reference in its entirety. In addition, the gravimetric activities of metal oxides are lower than those of transition metals presented in FIG. 4A, especially for Cr and Mo-based particles. Moreover, in agreement with the “activation time” trend observed for metal nanoparticles, the delay to the Li₂O₂ oxidation current peak increases as activity decreases for the metal oxides (FIG. 5B). The activity of α-MnO₂ at 3.9 V_{Li} herein is in agreement with the work of Kavakli et al. using similarly preloaded electrodes and rates. See, C. Kavakli, S. Meini, G. Harzer, N. Tsiouvaras, M. Piana, A. Siebel, A. Garsuch, H. A. Gasteiger and J. Herranz, ChemCatChem, 2013, 5, 3358, which is incorporated by reference in its entirety.

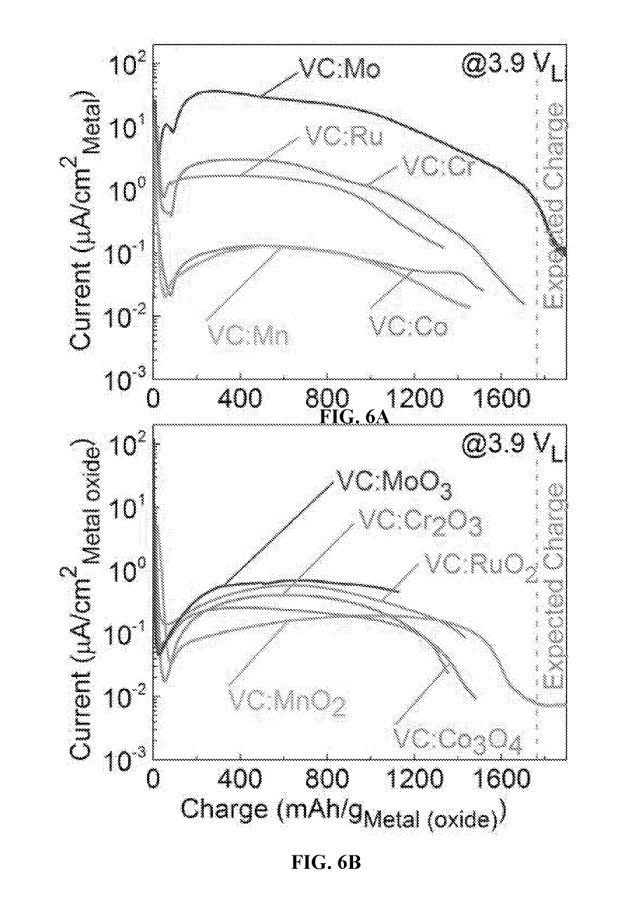

To examine the intrinsic activities across all the promoters studied, area-specific activities (normalized to the BET surface area of the promoter) in carbon-containing electrodes are shown in FIG. 6A for bulk metal nanoparticles and FIG. 6B for metal oxides. The following trend can be resolved: Mo>Cr≈Ru>MoO₃≈RuO₂≈Cr₂O₃>Co≈Co₃O₄≈α-MnO₂>Mn. Of particular interest is that transition metal nanoparticles have higher specific activities and shorter activation time than their corresponding oxides, particularly for highly active transition metals: Mo>MoO₃, Cr>Cr₂O₃ and Ru>RuO₂. The reduction in activity from metal to oxide cannot be explained fully by decreased electrical conductivity of oxides in the carbon network, especially considering that Ru and RuO₂ have resistivity of ˜8 μΩ·cm and ˜40 μΩ·cm, respectively. See, R. Powell, R. Tye and M. J. Woodman, Platinum Met. Rev., 1962, 6, 138, and L. Krusin-Elbaum and M. Wittmer, J. Electrochem. Soc., 1988, 135, 2610, each of which is incorporated by reference in its entirety. Here the observed activity trend may be related to the relative surface reactivity of the promoter with Li₂O₂ towards an intermediate product as investigated through XAS below. A mechanism for the observed promotion of the Li₂O₂ oxidation reaction will be detailed later.

II. Ex Situ XAS of Preloaded Li₂O₂ Electrodes During Electrochemical Oxidation

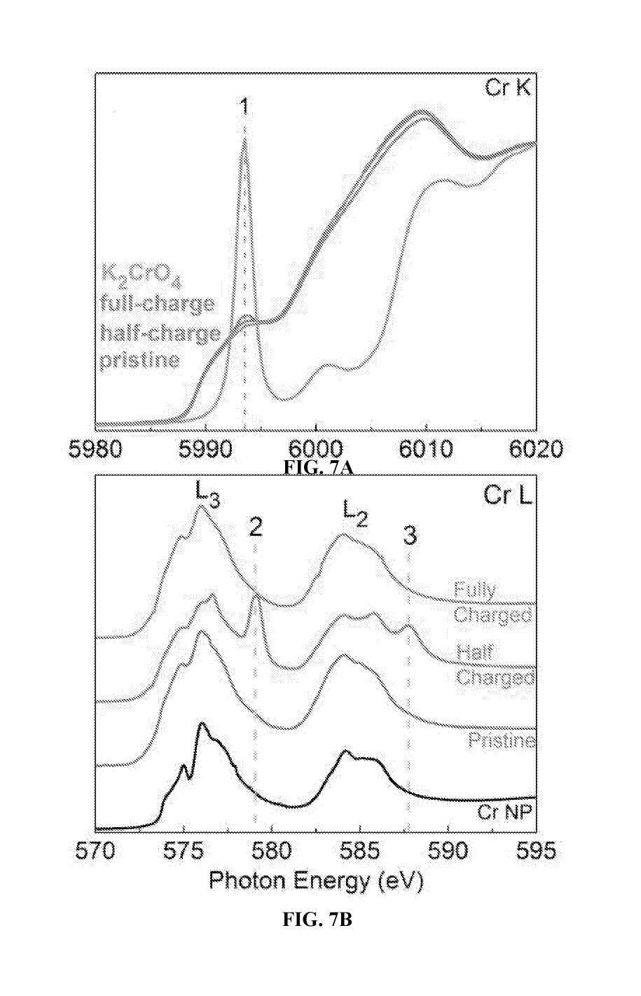

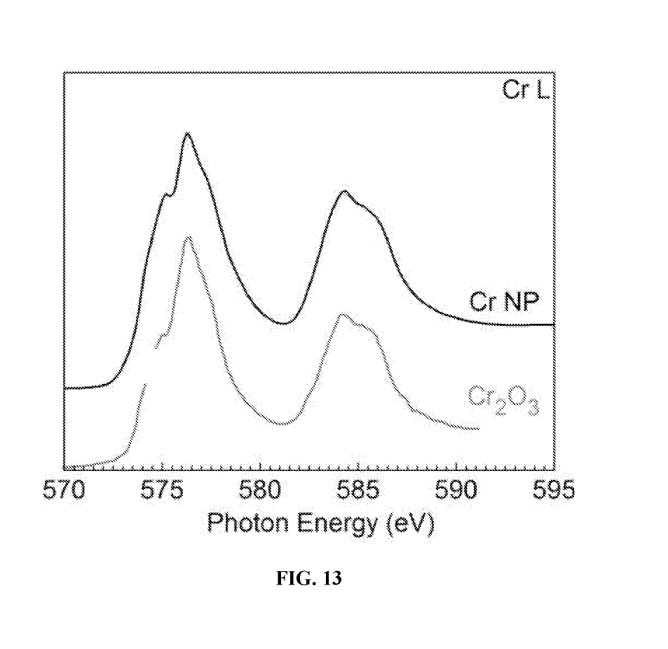

There were considerable changes in the oxidation state of Cr and Mo particles during charging using XAS data. The chemical changes in charged carbon-free Cr:Li₂O₂ electrodes at 3.8 V_{Li} using XANES spectra of the Cr K edge were probed, as shown in FIG. 7A. XANES Cr K edge data from the pristine electrode to the partially and fully charged electrodes in FIG. 7A show that the peak labelled as (1) at 5993.5 eV grows in intensity, which matches well with that of reference K₂CrO₄, indicating the formation of a CrO₄²⁻ environment on the surface of Cr nanoparticles. The small intensity of peak (1) found in the charged electrodes (FIG. 7A) suggests that the conversion to CrO₄² environment such as Li₂CrO₄ might be localized to the surface of Cr nanoparticles as XANES at the Cr K edge probes mainly the bulk of Cr nanoparticles. This hypothesis is further supported by Cr L edge data in FIG. 7B. FIG. 13 shows Cr L edge TEY XAS of Cr nanopowder versus Cr₂O₃. Cr₂O₃ is added to show that surfaces of the nanoparticles are oxidized. See, T. Neisius, C. T. Simmons and K. Köhler, Langmuir, 1996, 12, 6377, which is incorporated by reference in its entirety. Both edges show that the surfaces of Cr is oxidized to Cr3+ in a Cr2O3-like environment. Not only does the Cr L edge spectra of Cr particles and pristine electrode reveal Cr₂O₃-like surfaces (FIG. 13) but also the Cr L edge spectrum of an electrode charged at 3.8 V_{Li} shows strong conversion of Cr³⁺ to Cr⁶⁺ (peaks (2) and (3)), which is more visible than that shown previously at 3.9 V_{Li}. See, K. P. C. Yao, Y.-C. Lu, C. V. Amanchukwu, D. G. Kwabi, M. Risch, J. Zhou, A. Grimaud, P. T. Hammond, F. Bardé and Y. Shao-Horn, Phys. Chem. Chem. Phys., 2014, 16, 2297, which is incorporated by reference in its entirety.

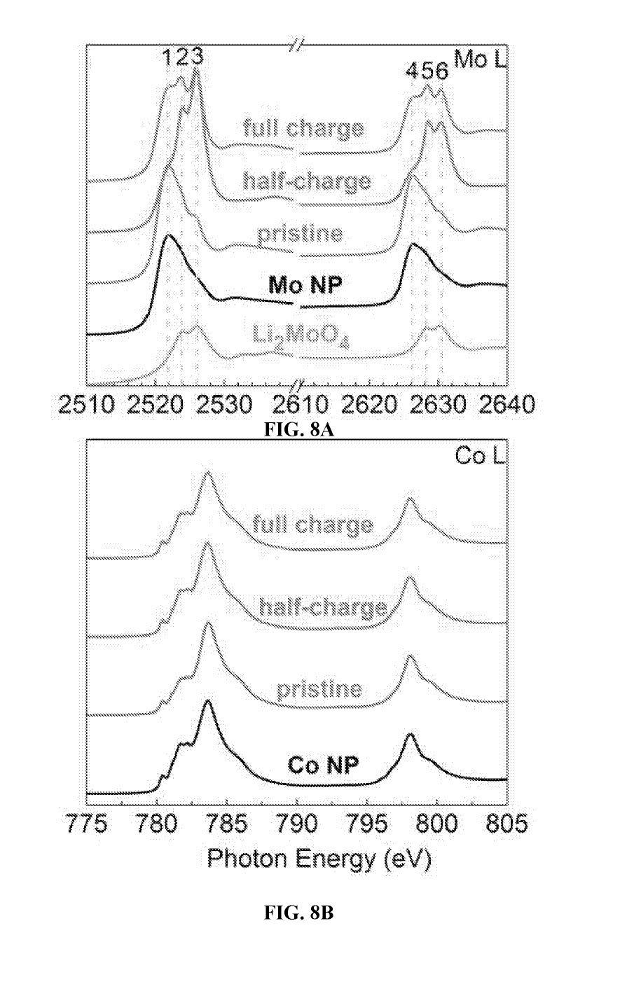

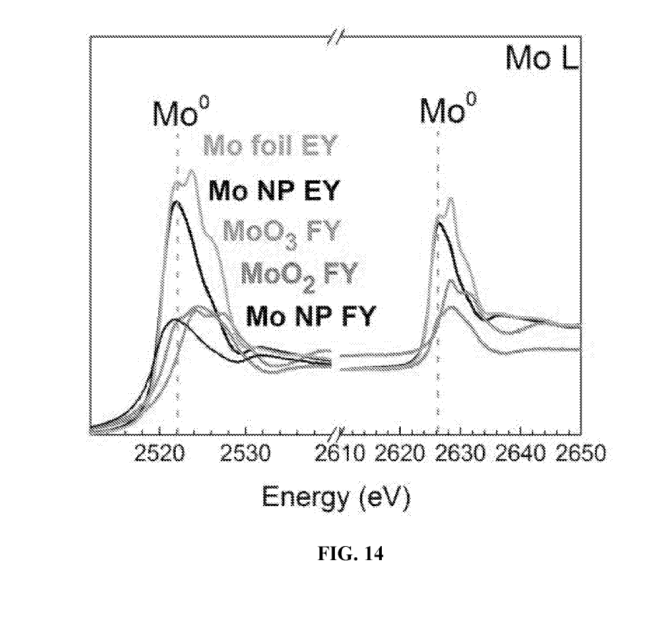

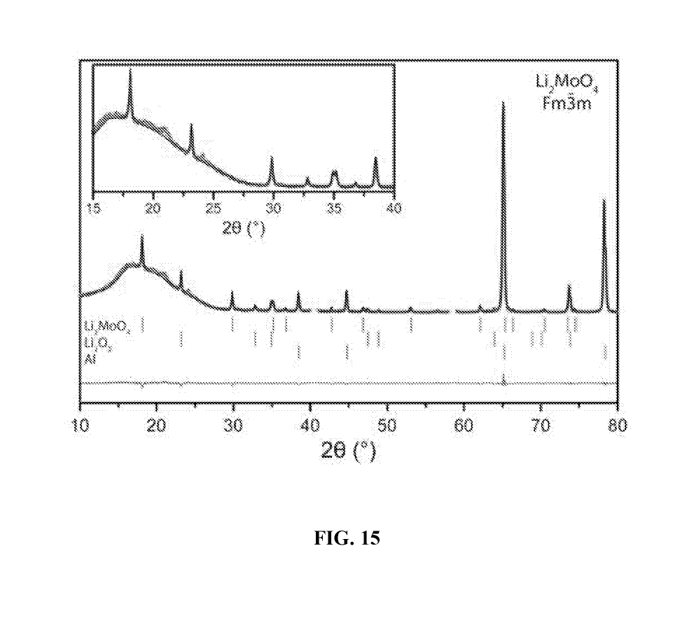

Comparing the Mo L edge spectra of MoO₂ and MoO₃ and a Mo foil, a significant fraction of Mo on the surface of Mo powder can be assigned to metallic Mo in addition to some with oxidation states of Mo⁴⁺ and Mo⁶⁺ (FIG. 14). FIG. 14 shows Mo L edge spectra of Mo nanopowder compared with those collected from reference MoO₃, MoO₂ and Mo foil, which indicate that the oxide layer on Mo powder is relatively thin. MoO₃ and MoO₂ are added to show that the surfaces of the nanoparticles are oxidized. This thin Mo layer likely allowed access to the bulk Mo metal for the formation of XRD detectable Li₂MoO₄ as shown in FIG. 15. Considering a signal depth of ˜75 A (estimated as three times the electron mean free path; see S. Tanuma, C. J. Powell and D. R. Penn, Surf Interface Anal., 2011, 43, 689, and S. L. M. Schroeder, G. D. Moggridge, R. M. Ormerod, T. Rayment and R. M. Lambert, Surf Sci., 1995, 324, L371, each of which is incorporated by reference in its entirety) during L edge probing of Mo, the oxide shell on Mo nanoparticles here appears less than ˜75 Å thick (or covers the surface incompletely), which likely allowed chemical conversion of the underlying Mo metal as shown by XRD. Comparing XAS data of the pristine carbon-free Mo:Li₂O₂ electrode with those of Mo powder, two new peaks labelled (3) and (6) in FIG. 8A at higher photon energies of 2526.0 and 2630.4 eV appear, which signals an increased oxidation of the Mo surface in contact with Li₂O₂.

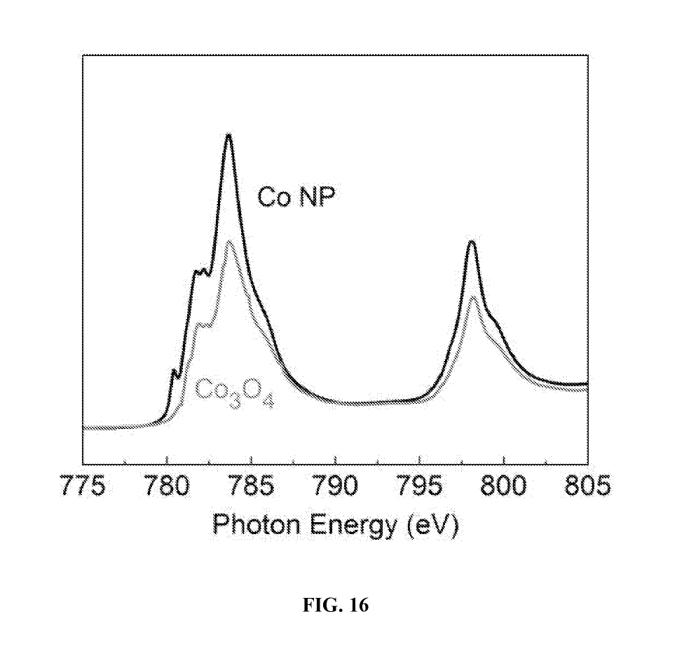

The spontaneous chemical reaction of Mo with Li₂O₂ was confirmed by the presence of Li₂MoO₄ using XAS (FIG. 8A) and XRD (FIG. 15). FIG. 15 shows XRD of pristine Mo:Li₂O₂ (0.667:1) electrode. Clear evidence of Li₂MoO₄ is observed prior to electrochemical treatment which attests of the strong chemical conversion of Mo with Li₂O₂. After half and ‘full’ charge, the Mo L edge spectra shows obvious growth of these peaks in FIG. 8A (L₃: 2523.9 (2) and 2526 eV (3); L₂: 2628.6 (5) and 2630.4 eV (6)) compared to the Mo powder and pristine electrode, which indicates further oxidation of Mo. These new peaks can be matched to tetrahedrally coordinated Mo⁶⁺ in reference compound Li₂MoO₄ as shown by peaks (2), (3), (5), and (6) in FIG. 8A. Ratios of peaks (1) through (6) in the fully charged compared to the half charged Mo electrodes shows signs of shift back to lower oxidation states of Mo which indicates a potential reversal as seen with Cr. Incomplete reversal of Mo⁶⁺ back to lower oxidation state is likely as a result of incomplete charging in Al:Mo electrodes seen in FIG. 4C. Note that due to incomplete charging of carbon-free Mo electrodes, partial charging was defined at 300 mA·g⁻¹Mo. The fully charged Mo electrode terminated at ˜600 mA·g⁻¹Mo, which may explain the persistence of oxidized Mo in the electrode labelled “fully charged”. Analysis of the L edge spectra of the promoter powder, pristine, half-charged and fully charged electrodes for Co nanoparticles (FIG. 8B) shows no resolved changes in the oxidation state of Co. Comparing the XAS spectra of Co and Co₃O₄ powder in FIG. 16, the surfaces of Co nanoparticles are identified as Co₃O₄-like. FIG. 16 shows Co L edge TEY spectra of Co nanoparticles compared to Co₃O₄and shows that the surfaces of Co nanoparticles are mostly oxidized to a Co₃O₄layer. FIGS. 17A-17B shows metal L edge spectra of oxides MnO₂ and Co₃O₄ nanoparticles, pristine, half-charged, and fully charged carbon-free electrodes in the surface sensitive total electron yield (TEY) mode. Half and full charging for the electrodes examined here was performed at 3.9 V_{Li}. This XAS probing of Co₃O₄ and α-MnO₂-promoted electrodes shows no changes in oxidation state of Co or Mn during charge. It is interesting to observe that prominent changes in the oxidation state of Mo and Cr during Li₂O₂ oxidation coincide with greater activity compared to the apparently stable Co, Co₃O₄ and α-MnO₂. As the changes in oxidation observed during Li₂O₂ oxidation could result in metal dissolution into the electrolyte, the presence of transition metal in the electrolyte after charging was investigated in carbon-free electrodes using ICP-AES.

III. Promoter Dissolution During Li₂O₂ Oxidation and Implication on the Li₂O₂ Oxidation Kinetics

Table 1 summarizes the results of probing the presence of soluble metal species in the electrolyte post-charging. The molar amount of soluble metal in the electrolyte generally increases with greater activation of Li₂O₂ oxidation and XAS-resolved oxidation state changes in the promoter: Mo>Cr>Co≈Co₃O₄>α-MnO₂. It is conceivable that dissolved promoter- derived complexes in the electrolyte are acting as redox mediators to the electrochemical oxidation of Li₂O₂. However, the measured concentrations of dissolved species are one order of magnitude lower compared to the typical concentrations of more than 10 mM of redox mediators used in the literature. See, Y. Chen, S. A. Freunberger, Z. Peng, O. Fontaine and P. G. Bruce, Nat. Chem., 2013, 5, 489, and B. J. Bergner, A. Schürmann, K. Peppler, A. Garsuch and J. Janek, J. Am. Chem. Soc., 2014, 136, 15054, each of which is incorporated by reference in its entirety.

TABLE 1
Summary of ICP-AES investigation post-charging of
carbon-free promoter:Li₂O₂ = 0.667:1 electrodes

| Promoter | Mo | Cr | Co | Co₃O₄ | α-MnO₂ |
|---|---|---|---|---|---|
| ppm in 10 mL solution | 0.58 | 0.4 | 0 | 0 | 0.1 |
| Conc. in 100 μL (mM) | 0.61 | 0.77 | 0 | 0 | 0.18 |

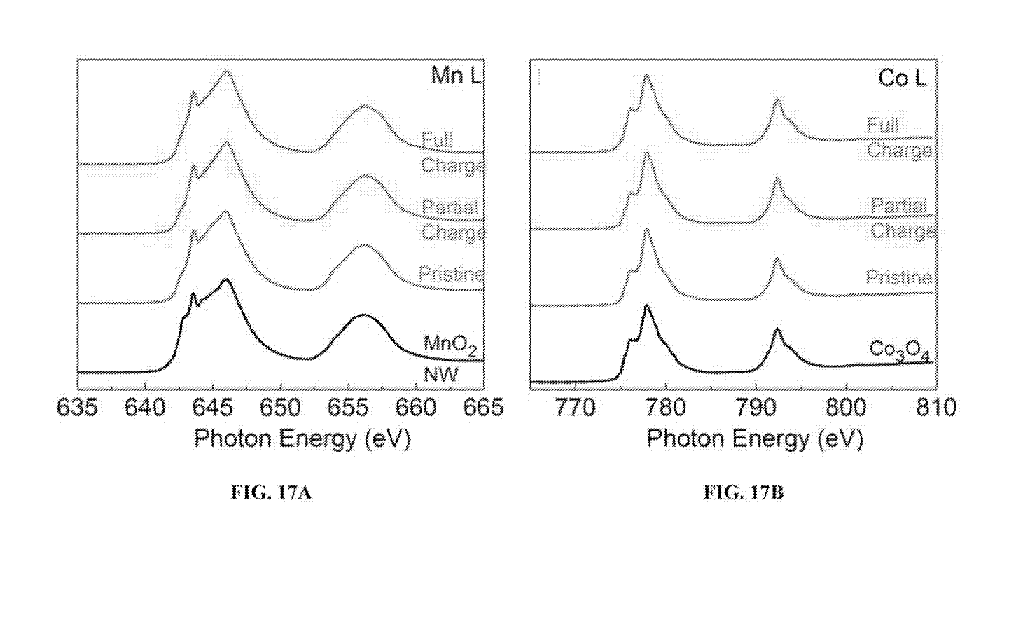

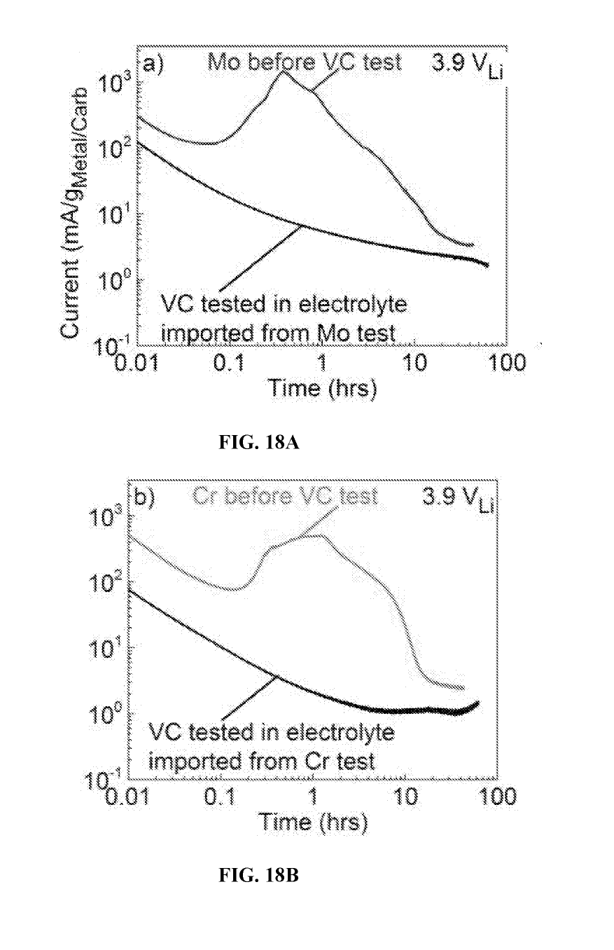

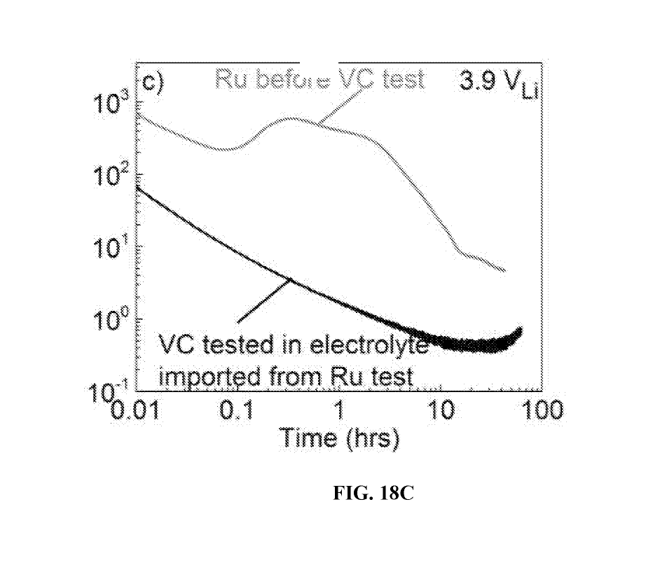

To examine the influence of these soluble species on the observed enhancement of Li₂O₂ oxidation with Cr, Mo and Ru, a promoted high activity electrode (Mo, Cr, and Ru) was allowed to fully charge at 3.9 V_{Li} in 0.1 M LiClO₄/DME electrolyte (see EXAMPLES), likely resulting in dissolved transition metal species in the electrolyte. Immediately afterwards, a carbon electrode (VC:Li₂O₂=1:1, without promoter) was substituted into the cell (reusing the exact previous electrolyte layer containing the dissolved metal species) and similarly charged at 3.9 V_{Li}. The absence of electrochemical activation in all three VC:Li₂O₂ electrodes in FIGS. 18A, 18B, and 18C verify the absence of redox mediator effect during enhancement of Li₂O₂ oxidation reaction using transition metal oxides and suggests that the leached metal species in the electrolyte are not responsible for the enhanced kinetics of Li₂O₂ with Cr, Mo, and Ru.

IV. Influence of Water On The Li₂O₂ Oxidation Kinetics

Meini et al. demonstrate that impurities such as water (produced from electrolyte degradation in operando) can enhance the electrode activation. See, S. Meini, S. Solchenbach, M. Piana and H. A. Gasteiger, J. Electrochem. Soc., 2014, 161, A1306, which is incorporated by reference in its entirety. FIGS. 18A-18C show the effect of impurities (transition metal species dissolved in the electrolyte, water, and other in operando impurities) during Li₂O₂ oxidation tested by substituting a VC-promoted (VC:Li₂O₂:LiNafion=1:1:1) electrode into the cell immediately after full charge of a VC: promoter:Li2O2:LiNafion=1:0.667:1:1. ICP-AES data revealed that dissolved metal cations from the preceding promoted electrodes charged at 3.9 V_{Li} were present. The inactivity of the VC-only electrode thus tested suggests that the dissolved cations are not the source of activity in promoted electrodes.

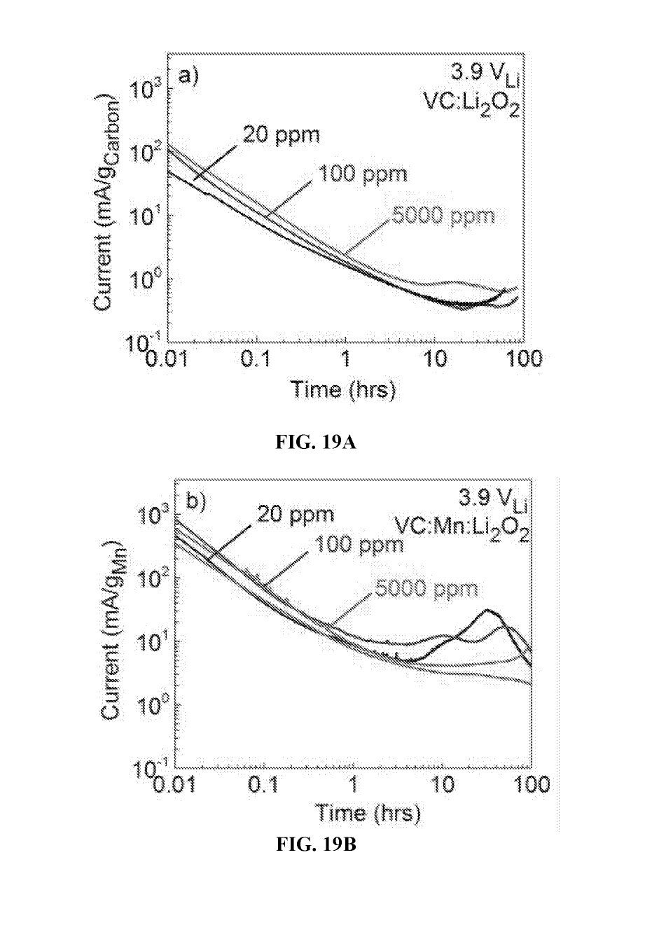

Similarly to observations made for the leached metal species, the absence of electrochemical activation in all three VC:Li₂O₂ electrodes in FIGS. 18A-18C suggests that water potentially produced in operando is not the origin of the enhanced kinetics of Li₂O₂ oxidation with Cr, Mo, and Ru. The influence of increased water content (baseline 20 ppm, 100 ppm, and 5000 ppm) on the activation of a promoter-free VC:Li₂O₂ as well as the least active VC:Mn:Li₂O₂ at 3.9 V_{Li} was investigated (FIGS. 19A and 19B). An earlier dip-then-rise in current (˜8 hours) is observed in VC:Li₂O₂ electrodes which might indicate electrode activation from less than 100 ppm to 5000 ppm in agreement with the work of Mieni et al. However, no reduction in activation time was observed in the case of VC:Mn:Li₂O₂ electrodes. In agreement with Mieni et al., the overall activity (average current at the applied voltage of 3.9 V_{Li}, <20 mA/gₚᵣₒₘₒₜₑᵣ) was not greatly enhanced at higher water contents in both types of electrodes tested.

FIGS. 19A-19B shows the effect of electrolyte water (baseline 20 ppm, 100 ppm, and 5000 ppm) content on the activation of Li₂O₂ oxidation in VC-promoted (VC:Li₂O₂:LiNafion=1:1:1) (FIG. 19A) and the least active Mn-promoted (VC:Mn:Li₂O₂:LiNafion=1:0.667:1:1) (FIG. 19B). A slightly lowered activation time might be evident in the VC-promoted electrode at the increased water content of 5000 ppm, although still on the order of 10 hours compared to less than 1 hour in high activity Mo, Cr, and Ru promoted electrodes. The overall activity (average current at the applied voltage of 3.9 V_{Li}, <20 mA/gₚᵣₒₘₒₜₑᵣ) was not significantly enhanced at higher water contents. In the case of Mn-promoted electrodes, addition of water appears detrimental to activity (FIG. 19B). Overall, in operando increase in water-content and other impurities cannot explain the two order of magnitude enhancement in electrode performance using nanoparticles such as Mo, Cr, and Ru. A unifying descriptor for the solid-state activation of the Li₂O₂ oxidation reaction is discussed below.

V. Unified Mechanism of Solid-State Activation of Li₂O₂ Oxidation

Further insights into the enhanced Li₂O₂ kinetics are gained from examining the enthalpies for conversion reactions: Li₂O₂+MₐO_{b}±O₂→LiₓM_{y}O_{z}, where MₐO_{b} is the surface composition of the promoter. Values of computed enthalpies for a number of representative Li₂O₂ reactions with transition metal (oxides) towards formation of lithiated metal oxides are tabulated in Table 2.

TABLE 2
List of potential reactions of the type Li₂O₂ + MₐO_{b} ± O₂ →
LiₓM_{y}O_{z} and associated enthalpy of reaction using the materials project database (A.
Jain, G. Hautier, S. P. Ong, C. J. Moore, C. C. Fischer, K. A. Persson and G. Ceder,
Phys. Rev. B, 2011, 84, 045115, which is incorporated by reference in its entirety).

| | | | Enthalpy of reaction |
|---|---|---|---|
| Reaction | | | per mole of Catalyst |
| Number | Catalyst | Reaction | (kJ/mol) |
| 1 | MnO₂ | Li₂O₂ + MnO₂ [symbol] ½ O₂ + Li₂MnO₃ | −104.5 |
| 2 | | Li₂O₂ + ⅔MnO₂ [symbol] ⅓O₂ + ⅔Li₃MnO₄ | −56.5 |
| 3 | | Li₂O₂ + 4MnO₂ [symbol] O₂ + 2LiMn₂O₄ | −13.5 |
| 3 | Mn₃O₄ | Li₂O₂ + ⅓Mn₃O₄ [symbol] ⅙ O₂ + Li₂MnO₃ | −492 |
| 4 | | Li₂O₂ + 2/9Mn₃O₄ [symbol] 1/9O₂ + ⅔Li₃MnO₄ | −349 |
| 5 | | Li₂O₂ + 4/3Mn₃O₄ + ⅓O₂ [symbol] 2Li₃MnO₄ | −218 |
| 6 | Co₃O₄ | Li₂O₂ + ⅔Co₃O₄ [symbol] ⅓O₂ + 2LiCoO₂ | −151 |
| 7 | Cr₂O₃ | Li₂O₂ + Cr₂O₃ + O₂ [symbol] Li₂Cr₂O₇ | −247 |
| 8 | | Li₂O₂ + 3Cr₂O₃ + 5/2O₂ [symbol] 2LiCr₃O₈ | −137.17 |
| 9 | | Li₂O₂ + Cr₂O₃ [symbol] ½O₂ + 2LiCrO₂ | −82 |
| 10 | | Li₂O₂ + ½Cr₂O₃ + ½O₂ [symbol] Li₂CrO₄ | −440 |
| 11 | | Li₂O₂ + ⅓Cr₂O₃ [symbol] ⅙O₂ + ⅔Li₃CrO₄ | −338 |
| 12 | | Li₂O₂ + Cr₂O₃ + O₂ [symbol] Li₂Cr₂O₇ | −247 |
| 13 | Mo | Li₂O₂ + Mo + O₂ [symbol] Li₂MoO₄ | −939 |
| 14 | | Li₂O₂ + ½Mo + ¼O₂ [symbol] ½Li₄MoO₅ | −952 |
| 15 | | Li₂O₂ + ⅔Mo + ⅙O₂ [symbol] ⅓Li₆Mo₂O₇ | −603.75 |
| 16 | | Li₂O₂ + Mo + ½O₂ [symbol] Li₂MoO₃ | −645 |
| 17 | | Li₂O₂ + 2Mo + O₂ [symbol] 2LiMoO₂ | −473.5 |
| 18 | | Li₂O₂ + 3/2Mo + O₂ [symbol] ½Li₄Mo₃O₈ | −609 |
| 19 | | Li₂O₂ + 5/2Mo + 13/4O₂ [symbol] Li₄Mo₅O₁₇ | −837.3 |
| 20 | MoO₃ | Li₂O₂ + MoO₃ [symbol] Li₂MoO₄ + ½O₂ | −158 |
| 18 | Ru | Li₂O₂ + Ru + ½O₂ [symbol] Li₂RuO₃ | −446 |
| 19 | | Li₂O₂ + 2/7Ru [symbol] 1/7O₂ + 2/7Li₇RuO₆ | −463.5 |
| 20 | | Li₂O₂ + 2Ru + O₂ [symbol] 2LiRuO₂ | −290.5 |
| 21 | RuO₂ | Li₂O₂ + RuO₂ [symbol] ½O₂ + Li₂RuO₃ | −19.5 |
| 22 | | Li₂O₂ + 2/7RuO₂ [symbol] 3/7O₂ + 2/7Li₇RuO₆ | −37 |

TABLE 3
Estimated values of log(i)~−ΔH + α ·
n · e · η_{applied} assuming α ≈ 0.5 and n is the
number of Li⁺ cations in the lithiated compound.

| | Intermediate | | | η at | | |
|---|---|---|---|---|---|---|
| | Lithiated | −ΔH | Eᵣₑᵥ | 3.9 | α · n · e · η | (−ΔH + |
| Catalysts | compound | (kJ/mol) | (V) | V_{Li} | (eV) | α · n · e · η) |
| MnO₂ | Li₂MnO₃ | −104.5 | 4.6⁴ | −0.7 | −0.7 | N/A (η < 0) |
| Mn, Mn₃O₄ | Li₂MnO₃ | −492 | 4.6 | −0.7 | −0.7 | N/A (η < 0) |
| Cr, Cr₂O₃ | Li₂CrO₄ | −440 | 3.7⁵ | 0.2 | 0.2 | 4.78 |
| Mo | Li₂MoO₄ | −939 | 2.0⁶ | 1.9 | 1.9 | 11.66 |
| Ru | Li₂RuO₃ | −446 | 3.5^{7, 8} | 0.4 | 0.4 | 5.04 |
| RuO₂ | Li₂RuO₃ | −37 | 3.5^{7, 8} | 0.4 | 0.4 | 0.78 |
| Co, Co₃O₄ | LiCoO₂ | −151 | 3.8⁹ | 0.1 | 0.1 | 1.62 |

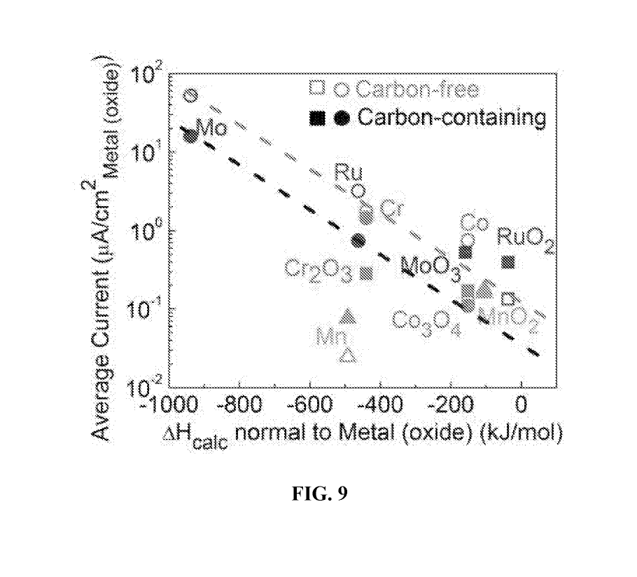

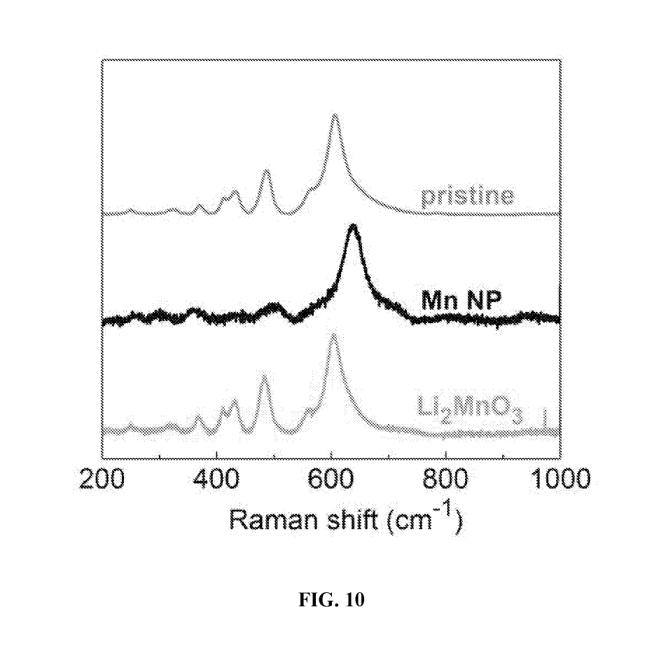

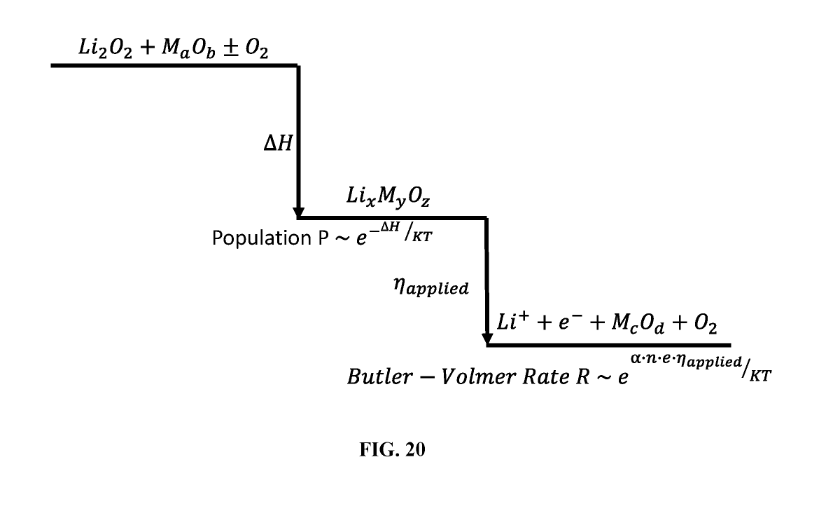

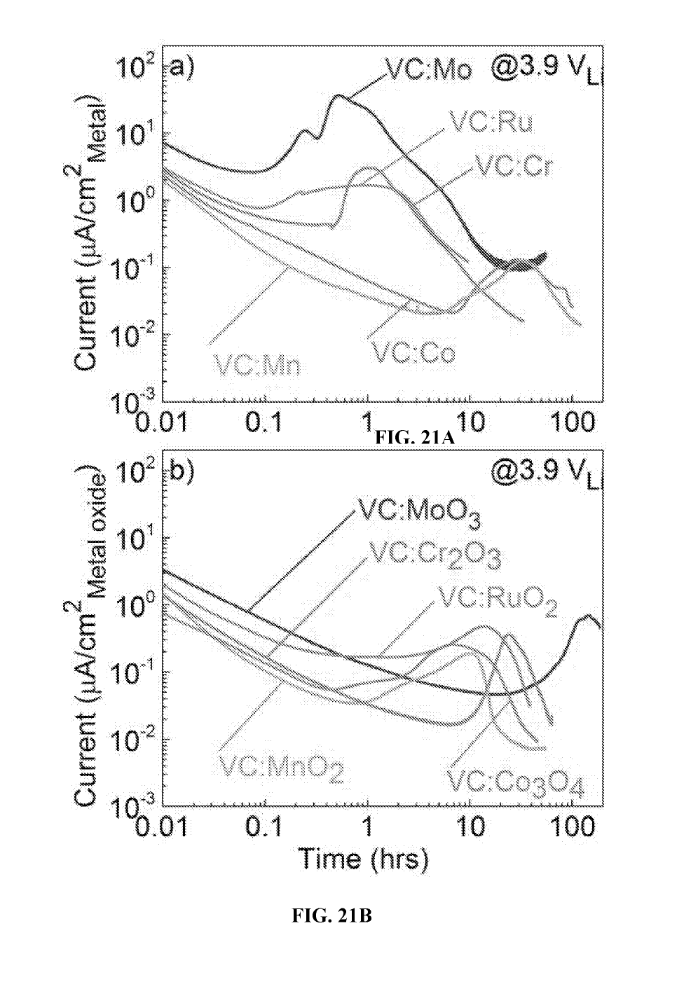

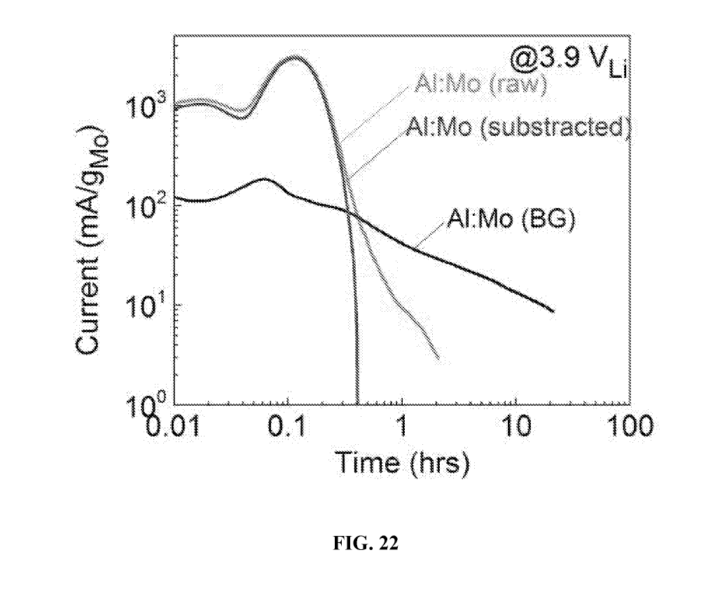

Based on the L edge XAS results of pristine Cr, Mo, and Co particles, their surfaces were identified as Cr₂O₃, Mo/MoOₓ, and Co₃O₄, respectively. It is assumed that the surface of Mn particles was covered by Mn₃O₄ as reported by American Elements and that of Ru by Ru/RuO₂ based on previous studies. See, K. S. Kim and N. Winograd, J. Catal., 1974, 35, 66, which is incorporated by reference in its entirety. In the case of the metal oxides, the surfaces of MoO₃, Cr₂O₃, Co₃O₄, α-MnO₂ and RuO₂ are comparable to the bulk. Additionally, the reaction intermediates of Cr and Mo are Li₂CrO₄ and Li₂MoO₄, respectively, as revealed from XAS measurements. Increasing enthalpy for chemical reaction between Li₂O₂ and the promoter was correlated with increasing specific Li₂O₂ oxidation currents in both carbon free and carbon-containing electrodes, as shown in FIG. 9. This trend shows that the generally reduced activities from metals to metal oxides (FIGS. 6A-6B) is related to the relative thermochemical stability of metal oxides in presence of Li₂O₂ which results in reduced conversion. A notable exception in the correlation of enthalpy with activity in FIG. 9 arises with Mn nanoparticles (with Mn₃O₄ surfaces) which a priori would be expected to have activity on the order of Cr and Ru promoter. Using Au nanoparticles enhanced Raman spectroscopy, spontaneous conversion of the promoter to Li₂MnO₃ is observed in pristine Mn:Li₂O₂ electrodes (FIG. 10) in agreement with a relatively large expected conversion enthalpy in Table 2. However, contrary to the other promoters investigated for which the LiₓM_{y}O_{z} intermediates have reversible delithiation potentials below the 3.9 V_{Li} applied potential (Table 3), the delithiation potential of Li₂MnO₃ is reported above 4.5 V_{Li}. See, F. Zhou, M. Cococcioni, C. Marianetti, D. Morgan and G. Ceder, Phys. Rev. B, 2004, 70, 235121, and P. Lanz, C. Villevieille and P. Nóvak, Electrochim. Acta, 2013, 109, 426, each of which is incorporated by reference in its entirety. Table 3 shows theoretical analysis of expected catalytic activity under mechanism of chemical conversion of Li₂O₂ and catalyst to LiₓM_{y}O_{z} followed by delithiation. Under these observations, the pathway of electrode activation during Li₂O₂ oxidation is identified as chemical conversion of the promoter to a corresponding lithium metal oxide LiₓM_{y}O_{z} followed by electrochemical delithiation (schematic in FIG. 20) with generally better kinetics compared to the direct oxidation of Li₂O₂→2Li⁺+2e⁻O₂. Derivation of log(i) as a function of enthalpy of conversion and applied overpotential is shown below (the symbol ‘˜’ is used to signify ‘proportional to’):

i˜P.R˜e^{-ΔH}/KT.e^{α.n.e.η}^{_{applied}}/KT

[symbol]

i˜e^{-Δh+α.N.Eη}^{_{applied}}/KT

log*)˜−ΔH+α.n.e.η_{applied}

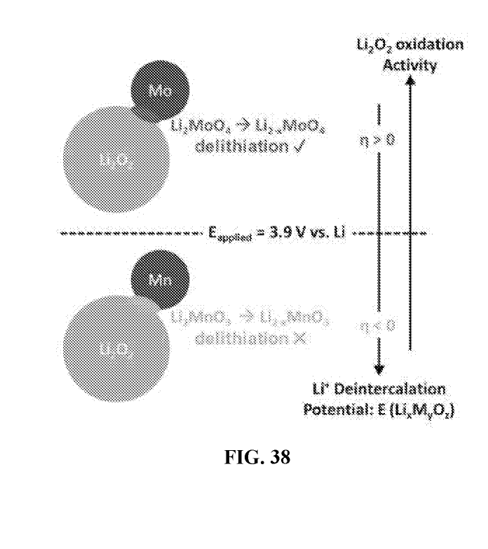

In the particular case of Mn, activity is limited by the delithation step, which would not be possible at the 3.9 V_{Li} applied potential here. FIG. 38 shows the schematic comparison of delithiation of Mo and Mn. Theoretical analysis under this proposed pathway would result in log(i)≈C.(−ΔH+α.n.e.η) where C, ΔH, α, n, e, η are a constant, enthalpy of chemical conversion, charge transfer coefficient, electron charge, and effective overpotential with respect to the intermediate lithium metal oxide, respectively. From estimations presented in Table 3, good agreement is found between this theoretical model and the experimentally measured activity trend. It is worth noting that complete delithiation of Li₂CrO₄, Li₂MoO₄, Li₂RuO₃, and Li₂MnO₃ (above ˜4.5 V_{Li}) would result in oxygen evolution LiₓM_{y}O_{z}→Li⁺+M_{c}O_{d}+O₂ as desired in Li—O₂ batteries. See, F. Zhou, M. Cococcioni, C. Marianetti, D. Morgan and G. Ceder,

Phys. Rev. B, 2004, 70, 235121, P. Lanz, C. Villevieille and P. Novak, Electrochim. Acta, 2013, 109, 426, and S. Sarkar, P. Mahale and S. Mitra, J. Electrochem. Soc., 2014, 161, A934, each of which is incorporated by reference in its entirety. On the other hand, the delithiation reaction will likely result in a metal oxide deposit but not necessarily the regeneration of the original promoter. The proposed pathway can be used to explain the surface behavior during Li₂O₂ oxidation of the reported TiC and Ti₄O₇ promoters. See, M. M. Ottakam Thotiyl, S. A. Freunberger, Z. Peng, Y. Chen, Z. Liu and P. G. Bruce, Nat. Mater., 2013, 12, 1050, and D. Kundu, R. Black, E. J. Berg and L. F. Nazar, Energy Environ. Sci., 2015, each of which is incorporated by reference in its entirety. X-ray photoelectron spectra (XPS) after first discharge on TiC and Ti₄O₇ in Li—O₂ batteries reveal the growth of peaks at ˜458.5 and ˜464 eV, indicative of Ti⁴⁺2p_{3/2} and Ti⁴⁺2p_{1/2} in Li₂TiO₃. See, H. Deng, P. Nie, H. Luo, Y. Zhang, J. Wang and X. Zhang, J. Mater. Chem. A, 2014, 2, 18256, which is incorporated by reference in its entirety. The thermodynamically spontaneous reactions between Li₂O₂ and TiC and Ti₄O₇ in presence of oxygen such as Li₂O₂+TiC+3/2O₂→Li₂TiO₃+CO₂ (ΔH_{calc}=−1459 kJ/mol), Li₂O₂+TiC+O₂→Li₂TiO₃+CO (ΔH_{calc}=−1071 kJ/mol) and 4Li₂O₂+Ti₄O₇→4Li₂TiO₃+3/2O₂ (ΔH_{calc}=−753 kJ/mol) have high enthalpies. See, A. Jain, G. Hautier, S. P. Ong, C. J. Moore, C. C. Fischer, K. A. Persson and G. Ceder, Phys. Rev. B, 2011, 84, 045115, which is incorporated by reference in its entirety. Regarding delithiation of the intermediate, Li₂TiO₃ is stable against delithiation above 4.7 V which would explain the relatively low surface-area-normalized activity of Ti₄O₇ (˜4V at ˜8.4.10⁻³ μA·cm⁻²_{BET}) electrodes loaded with crystalline Li₂O₂ and the persistence of the Ti⁴⁺ XPS peak during cycling beyond the first discharge.

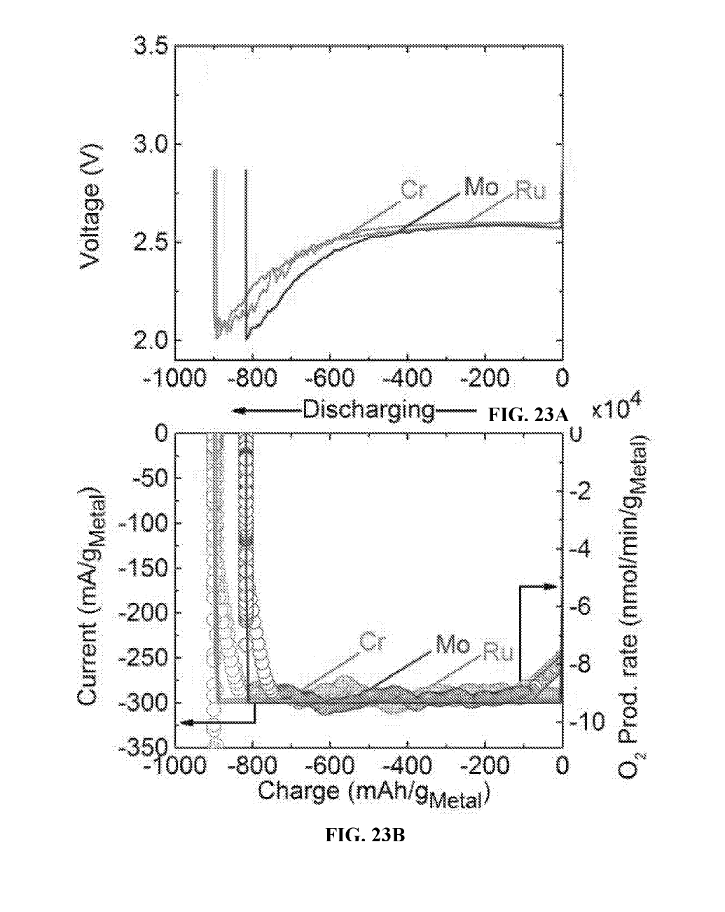

FIG. 23A-23B shows electrochemical performance of carbon-free Mo:Li₂O₂=0.667:1 (mass ratios, supported on aluminum foil) electrodes at 3.9 VLi and associated background current (Mo on Al foil without Li₂O₂). Upon subtracting the background current from the Li₂O₂ oxidation current, it is clear that the large current observed in Mo-promoted electrodes cannot be attributed electrolyte decomposition by Mo but rather Li₂O₂ oxidation.

In summary, mechanistic insights into the kinetics of Li₂O₂ oxidation has been presented by coupling electrochemical Li₂O₂ oxidation trends of metal and oxide promoters with spectroscopic measurements and the reactivity energetics between Li₂O₂ and the promoter. The measured activities of Cr, Mo and Ru particles are an order of magnitude greater than those of Co and Mn as well as those of corresponding oxides. Upon Li₂O₂ oxidation, XAS measurements show that Cr and Mo particles become highly oxidized to M⁶⁺ in CrO₄²⁻ and MoO₄²⁻ environments such as Li₂CrO₄ and Li₂MoO₄, respectively, which is accompanied with soluble Cr and Mo-based species in the electrolyte. However, those soluble species as well as other potential impurities such as water generated in operando are not the main source for the order of magnitude enhancement in electrode activity in presence of Mo, Cr, and Ru for example. A strong correlation between increasing specific Li₂O₂ oxidation currents in both carbon free and carbon-containing electrodes and increasing enthalpy for chemical reaction between Li₂O₂ and the promoter were found. This result proposes a universal mechanism for promoting Li₂O₂ oxidation kinetics via solid-state activation, which involves thermochemical conversion of the promoter surface and Li₂O₂ towards a lithium metal oxide, which can subsequently undergo electrochemical delithiation. The influence of such solid-state activation of Li₂O₂ oxidation for the voltage and faradaic efficiency of rechargeable Li-air batteries require further studies.

### Process Efficiency in Li—O2 Batteries Using Reaction Promoters

The Li—O₂ system holds promise in revolutionizing gravimetric energy density in the battery energy storage field. A variety of transition metal based nanoparticles are candidate promoters in lowering recharge potentials and boosting its round trip efficiency. Chemical lithiation followed by electrochemical delithiation provides kinetic enhancement measured in presence of promoters such as Mo, Cr, and Ru. The present work focuses on the process efficiency during charging of Li—O₂ batteries in presence of Mo, Cr, and Ru metal promoters using differential electrochemical mass spectrometry (DEMS). Oxygen consumption during discharge abides by the 2 e⁻/O₂ desired for formation of Li₂O₂ for three cycles of all three promoters. On potentiostatic charging at 3.9 V_{Li}, in agreement with current state of the art, all three promoters display sub-stoichiometric oxygen regeneration albeit with negligible CO₂, CO, and H2O generation. Mo, with the highest activity enabled by its large conversion enthalpy with Li₂O₂ operates farthest from ideal at 4.82 e⁻/O₂, while Cr, and Ru with comparable conversion enthalpies and electrochemical Li₂O₂ oxidation activities operate with ˜3.0 e⁻/O₂. This study reinforces that low cost transition metals such as Cr are excellent substitutes for the noble metal Ru used extensively in promoting the charging of Li—O₂ batteries.

The Li-Ion battery system has taken center-stage in high-energy and high-power applications; it is currently the chemistry of choice for powering portable electronics and the upcoming electric vehicles. However, their typical gravimetric energy density of ca. 100 Wh·kg₋₁ falls short of the US electric vehicle (EV) target 350 Wh·kg⁻¹. See, P. Simon and Y. Gogotsi, Nat. Mater., 2008, 7, 845, and USCAR, Energy Storage System Goals, Accessed Jan. 1, 2016, 2016, each of which is incorporated by reference in its entirety. Several next generation chemistries generally based on conversion of oxygen or sulfur with lithium or sodium are in various stage of development. See, P. G. Bruce, S. A. Freunberger, L. J. Hardwick and J.-M. Tarascon, Nat. Mater., 2012, 11, 19, which is incorporated by reference in its entirety. Li—O₂ batteries have captured vigorous scientific interest owing to their promise of providing double to triple the energy density of state-of-the-art Li-Ion batteries. See, K. G. Gallagher, S. Goebel, T. Greszler, M. Mathias, W. Oelerich, D. Eroglu and V. Srinivasan, Energy Environ. Sci., 2014, 7, 1555, and Y.-C. Lu, B. M. Gallant, D. G. Kwabi, J. R. Harding, R. R. Mitchell, M. S. Whittingham and Y. Shao-Horn, Energy Environ. Sci., 2013, 6, 750, each of which is incorporated by reference in its entirety.

However, their viability is hindered by several cell-level factors. Severe degradation of the solvents is observed for most aprotic electrolytes including alkyl carbonates used in Li-Ion cells, ethereal solvents and organosulfurs. See, S. A. Freunberger, Y. Chen, Z. Peng, J. M. Griffin, L. J. Hardwick, F. Bardé, P. Novák and P. G. Bruce, J. Am. Chem. Soc., 2011, 133, 8040, B. D. Adams, R. Black, Z. Williams, R. Fernandes, M. Cuisinier, E. J. Berg, P. Novak, G. K. Murphy and L. F. Nazar, Adv. Energy Mater., 2015, 5, S. A. Freunberger, Y. Chen, N. E. Drewett, L. J. Hardwick, F. Bardé and P. G. Bruce, Angew. Chem. Int. Ed., 2011, 50, 8609, and D. G. Kwabi, T. P. Batcho, C. V. Amanchukwu, N. Ortiz-Vitoriano, P. Hammond, C. V. Thompson and Y. Shao-Horn, J. Phys. Chem. Lett., 2014, 5, 2850, each of which is incorporated by reference in its entirety. The electrolyte degradation couples with the formation of parasitic discharge products and the poor electronic conductivity of the main discharge product Li₂O₂ to cause high recharge overpotentials, low round trip efficiencies and limited cycle life. See, B. D. McCloskey, A. Speidel, R. Scheffler, D. C. Miller, V. Viswanathan, J. S. Hummelshøj, J. K. Nørskov and A. C. Luntz, J. Phys. Chem. Lett., 2012, 3, 997, B. D. McCloskey, A. Valery, A. C.

Luntz, S. R. Gowda, G. M. Wallraff, J. M. Garcia, T. Mori and L. E. Krupp, J. Phys. Chem. Lett., 2013, 4, 2989, 0. Gerbig, R. Merkle and J. Maier, 2013, 25, 3129, and S. P. Ong, Y. Mo and G. Ceder, Phys. Rev. B, 2012, 85, 081105, each of which is incorporated by reference in its entirety. To address the coupled issues of high overpotentials and poor round trip efficiencies, reaction promoters consisting of metal (oxides) nanoparticles are commonly employed. See, K. P. C. Yao, Y.-C. Lu, C. V. Amanchukwu, D. G. Kwabi, M. Risch, J. Zhou, A. Grimaud, P. T. Hammond, F. Barde and Y. Shao-Horn, Phy. Chem. Chem. Phys., 2014, 16, 2297, K. P. C. Yao, M. Risch, S. Y. Sayed, Y.-L. Lee, J. R. Harding, A. Grimaud, N. Pour, Z. Xu, J. Zhou, A. Mansour, F. Barde and Y. Shao-Horn, Energy Environ. Sci., 2015, 8, 2417, F. Li, R. Ohnishi, Y. Yamada, J. Kubota, K. Domen, A. Yamada and H. Zhou, Chem. Commun., 2013, 49, 1175, R. Black, J.-H. Lee, B. Adams, C. A. Mims and L. F. Nazar, Angew. Chem. Int. Ed., 2013, 52, 392, and Z. Jian, P. Liu, F. Li, P. He, X. Guo, M. Chen and H. Zhou, Angew. Chem. Int. Ed., 2014, 53, 442, each of which is incorporated by reference in its entirety. Recent systematic probing of electrochemical and thermochemical trends aided by ex-situ X-ray absorption spectroscopy revealed the chemical conversion of the promoter with the discharge product Li₂O₂ to form lithiated metal oxides. See, K. P. C. Yao, Y.-C. Lu, C. V. Amanchukwu, D. G. Kwabi, M. Risch,

J. Zhou, A. Grimaud, P. T. Hammond, F. Barde and Y. Shao-Horn, Phy. Chem. Chem. Phys., 2014, 16, 2297, K. P. C. Yao, M. Risch, S. Y. Sayed, Y.-L. Lee, J. R. Harding, A. Grimaud, N. Pour, Z. Xu, J. Zhou, A. Mansour, F. Bardé and Y. Shao-Horn, Energy Environ. Sci., 2015, 8, 2417, and D. Kundu, R. Black, B. Adams, K. Harrison, K. Zavadil and L. F. Nazar, J. Phys. Chem. Lett., 2015, 6, 2252, each of which is incorporated by reference in its entirety. The latter delithiation of the lithiated metal oxide intermediates is revealed to be the source of the observed enhanced kinetics of Li₂O₂ oxidation. See, K. P. C. Yao, M. Risch, S. Y. Sayed, Y.-L. Lee, J. R. Harding, A. Grimaud, N. Pour, Z. Xu, J. Zhou, A. Mansour, F. Barde and Y. Shao-Horn, Energy Environ. Sci., 2015, 8, 2417, which is incorporated by reference in its entirety. A mechanism which differs significantly from traditional oxygen evolution (OER) catalysis in which the catalyst lowers the barrier of the rate limiting step through tuned binding of oxygenated intermediates on the surfaces. See, I. C. Man, H.-Y. Su, F. Calle-Vallejo, H. A. Hansen, J. I. Martinez, N. G. Inoglu, J. Kitchin, T. F. Jaramillo, J. K. Nørskov and J. Rossmeisl, ChemCatChem, 2011, 3, 1159, and J. Suntivich, K. J. May, H. A. Gasteiger, J. B. Goodenough and Y. Shao-Horn, Science, 2011, 334, 1383, each of which is incorporated by reference in its entirety. In light of this finding, it becomes imperative to investigate the process efficacy of the OER from Li₂O₂ oxidation necessary to regenerate a Li—O₂ cell for the following discharge.

McCloskey et al. employed differential electrochemical mass spectrometry (DEMS) to investigate the OER during the charge reaction of Li—O₂ batteries using either polycarbonate:dimethoxyethane (PC:DME) or 1, 2 dimethoxyethane (DME) as electrolyte solvent. See, B. D. McCloskey, R. Scheffler, A. Speidel, D. S. Bethune, R. M. Shelby and A. C. Luntz, J. Am. Chem. Soc., 2011, 133, 18038, which is incorporated by reference in its entirety. Their work concluded that metal nanoparticles in Li—O₂ cells only affected the removal of soluble parasitic products in PC-based electrolytes evolving CO₂ on charge, while no effect is observed in DME-based electrolytes where the desired Li₂O₂ product is being oxidized to evolve O₂. Later work by the same author comparing the Li—O₂ and Na—O₂ systems further suggests that in the absence of carbonate side products, recharge of the alkali-air cell should be efficient without needing promoter nanoparticles. See, B. D. McCloskey, J. M. Garcia and A. C. Luntz, J. Phys. Chem. Lett., 2014, 5, 1230, which is incorporated by reference in its entirety. These conclusions do not agree with the clear charging trends observed for Li₂O₂ decomposition using carbon-free electrodes preloaded Li₂O₂ where little to no carbonates are expected. See, K. P. C. Yao, M.

Risch, S. Y. Sayed, Y.-L. Lee, J. R. Harding, A. Grimaud, N. Pour, Z. Xu, J. Zhou, A. Mansour, F. Bardé and Y. Shao-Horn, Energy Environ. Sci., 2015, 8, 2417, which is incorporated by reference in its entirety. In the work of Kundu et al. exploring the effect of Mo₂C on charge, a charging plateau below 3.6 V_{Li} (strong enhancement effect) and online electrochemical mass spectrometry (OEMS) measurement of mostly O₂ with only trace CO₂ are observed. See, D. Kundu, R. Black, B. Adams, K. Harrison, K. Zavadil and L. F. Nazar, J. Phys. Chem. Lett., 2015, 6, 2252, which is incorporated by reference in its entirety. The authors report by X-ray photoelectron spectroscopy the conversion of the promoter surface to LiₓMoO₃ per the proposed mechanism by Yao et al. (Energy Environ. Sci., 2015). Furthermore, comparison of the oxidation kinetics of Li₂O₂ in Li—O₂ and NaO₂ in Na—O₂ in this case (B. D. McCloskey, J. M.

Garcia and A. C. Luntz, J. Phys. Chem. Lett., 2014, 5, 1230, which is incorporated by reference in its entirety) disregards the anticipated slower kinetics of a two-electron transfer vs. a one-electron transfer reaction as well as the possible differences in charge transport from one to the other.

In the present work the process efficiency of Li—O₂ cells was investigated in presence of the Mo, Cr, and Ru which are the most active Li₂O₂ oxidation promoters (described above) using DEMS. Characteristic similarities between Cr and noble metal Ru and their difference from Mo are revealed. Those similarities and differences as found explicable by values of conversion enthalpies of the promoter with Li₂O₂ towards lithiated metal oxides upon charging. First the discharge process in presence of Mo, Cr, and Ru in carbon supported electrodes was investigated during galvanostatic discharge at 200 mA·g⁻¹_{Carbon}=300 mA·g⁻¹_{Promoter}. The desired discharge reaction in Li-—O₂ batteries is the conversion of lithium with oxygen in the gas phase to form a lithium oxide (LiO₂, Li₂O₂, and/or Li₂O). Since the first publication by Kumar et al. (B. Kumar, J. Kumar, R. Leese, J. P. Fellner, S. J. Rodrigues and K. M. Abraham, J. Electrochem. Soc., 2010, 157, A50, which is incorporated by reference in its entirety), the Li—O₂ electrochemical system in absence of parasitic decomposition of the electrolyte or carbon cathode is been reported to discharge through formation of Li₂O₂ as the final discharge product (2Li⁺+2e⁻+O₂⇄Li₂O₂). See, S. A. Freunberger, Y. Chen, N. E. Drewett, L. J. Hardwick, F. Bardé and P. G. Bruce, Angew. Chem. Int. Ed., 2011, 50, 8609, and Y.-C. Lu, D. G. Kwabi, K. P. C. Yao, J. R. Harding, J. Zhou, L. Zuin and Y. Shao-Horn, Energy Environ. Sci., 2011, 4, 2999, each of which is incorporated by reference in its entirety) The stoichiometry of this reaction dictates the consumption of one oxygen molecule per two electrons passed (2e⁻/O₂).

FIGS. 23A-23B summarizes the first cycle discharge of VC:(Mo, Cr, Ru):LiNafion electrodes at 200 mA·g⁻¹_{Carbon}=300 mA·g⁻¹_{Promoter}. The discharge voltage vs. charge passed at 200 mA·g⁻¹_{Carbon}=300 mA·g⁻¹_{Promoter} in FIG. 23A are comparable with a prolonged plateau at ˜2.6 V_{Li} for all three promoters investigated. This voltage profile is characteristic of the VC carbon support used; the promoter nanoparticles have little enhancement effect on the extended discharge as previously reported. See, K. P. C. Yao, Y.-C. Lu, C. V. Amanchukwu, D. G. Kwabi, M. Risch, J. Zhou, A. Grimaud, P. T. Hammond, F. Barde and Y. Shao-Horn, Phy. Chem. Chem. Phys., 2014, 16, 2297, which is incorporated by reference in its entirety. FIG. 23B shows the current and gas consumption rate versus charge, both normalized to the mass of Mo, Cr, or Ru particles in the electrode. A ratio of 2e⁻/O₂ is equivalent to ˜311 mA per nmol·min⁻¹ of oxygen consumed or produced; this factor is used to compare faradaic current to gas production rate in all figures herein. Comparing the gas consumption rate with faradaic current, it is clear that a nominally 2e⁻/O₂ process is occurring throughout discharge for all promoters studied (FIG. 23B). Therefore that formation of Li₂O₂, the desired discharge product, is the main electrochemical process occurring in presence of Mo, Cr, and Ru.

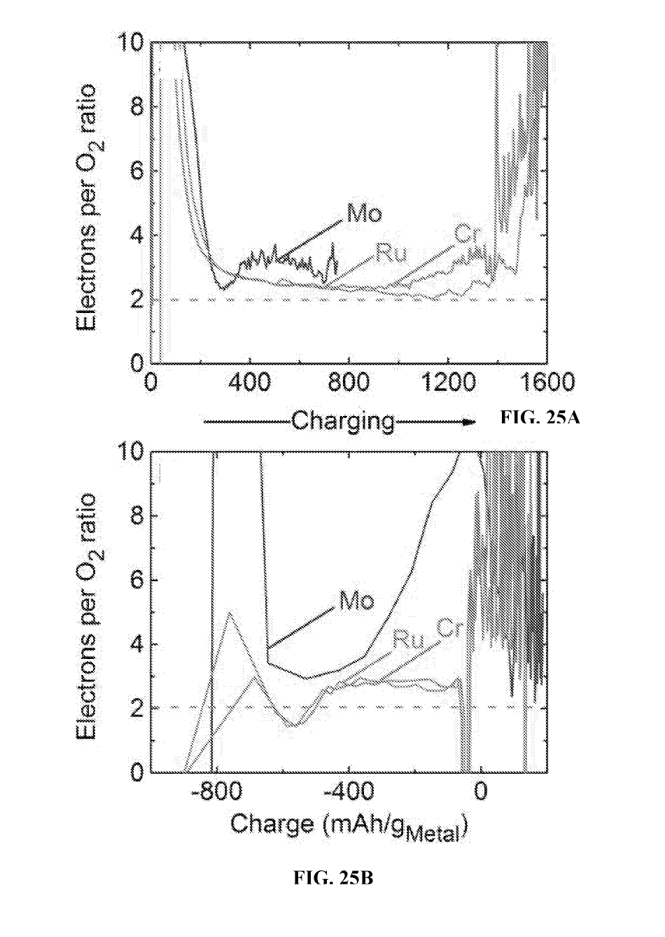

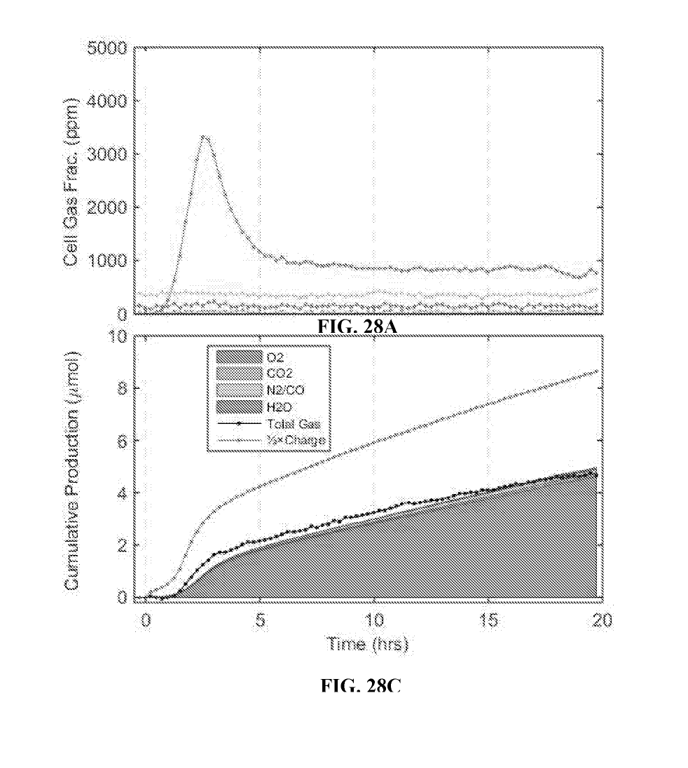

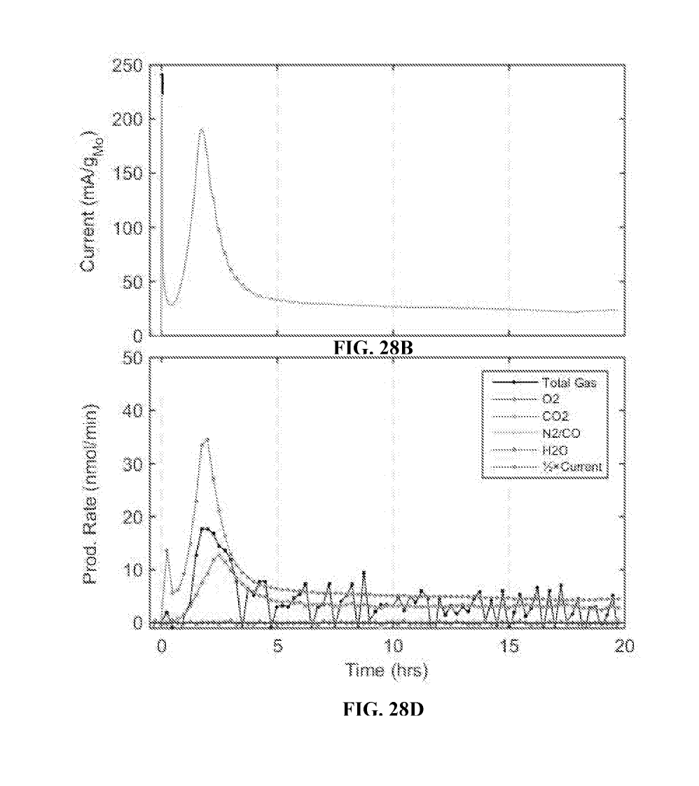

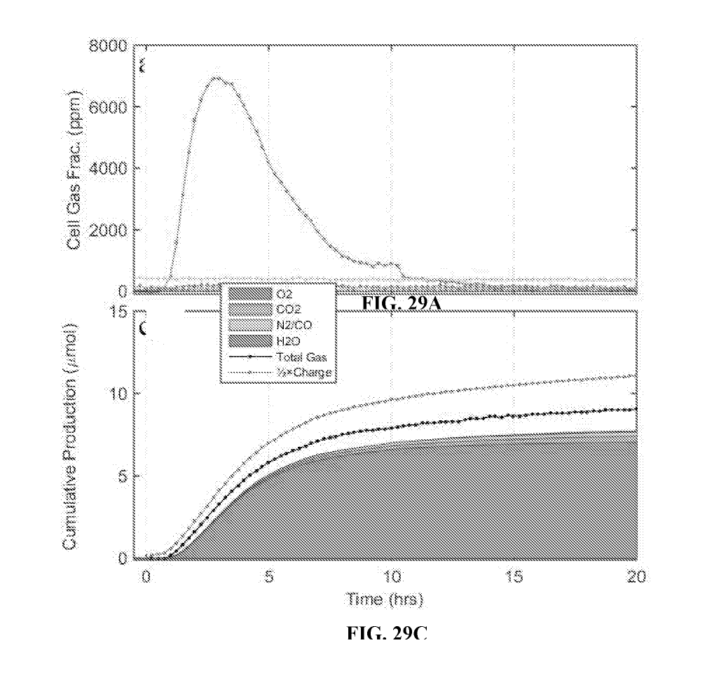

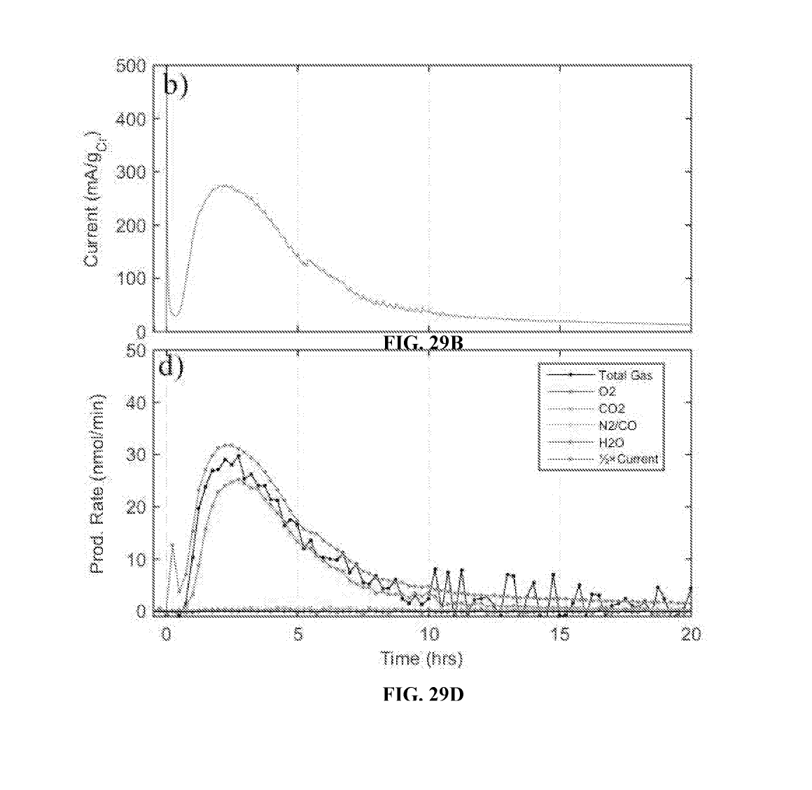

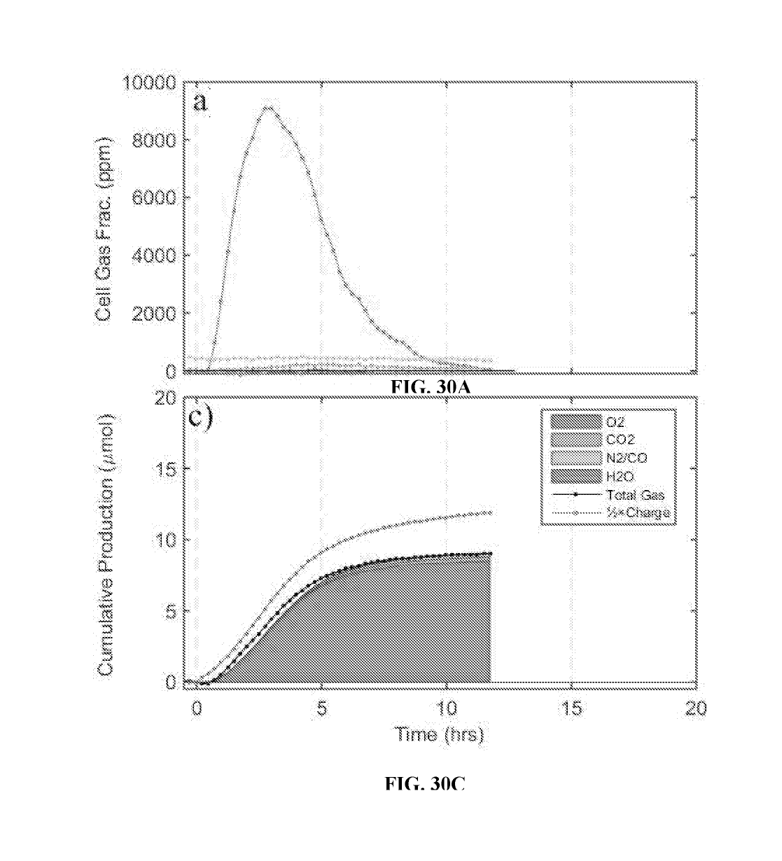

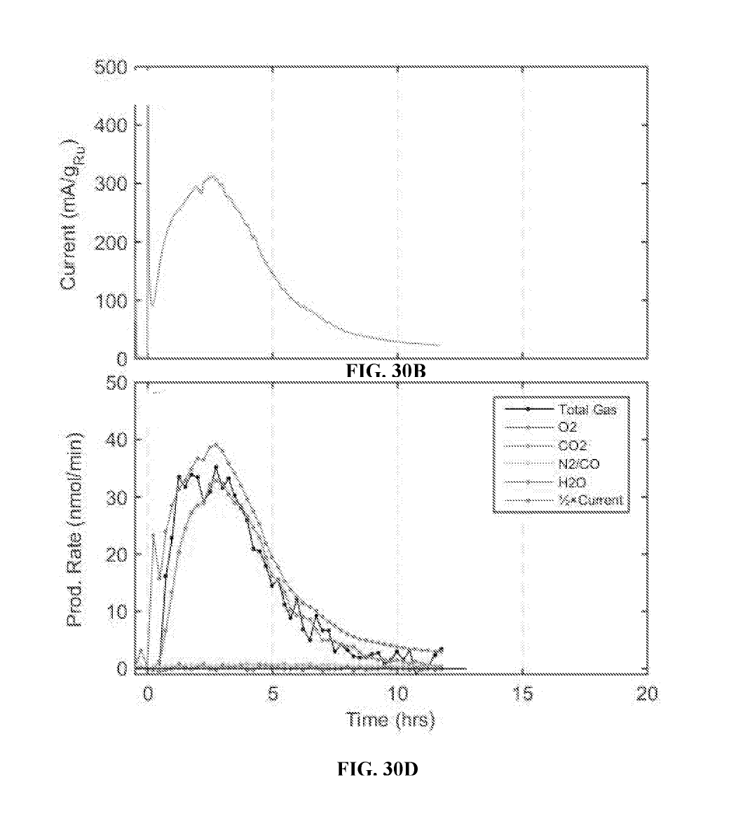

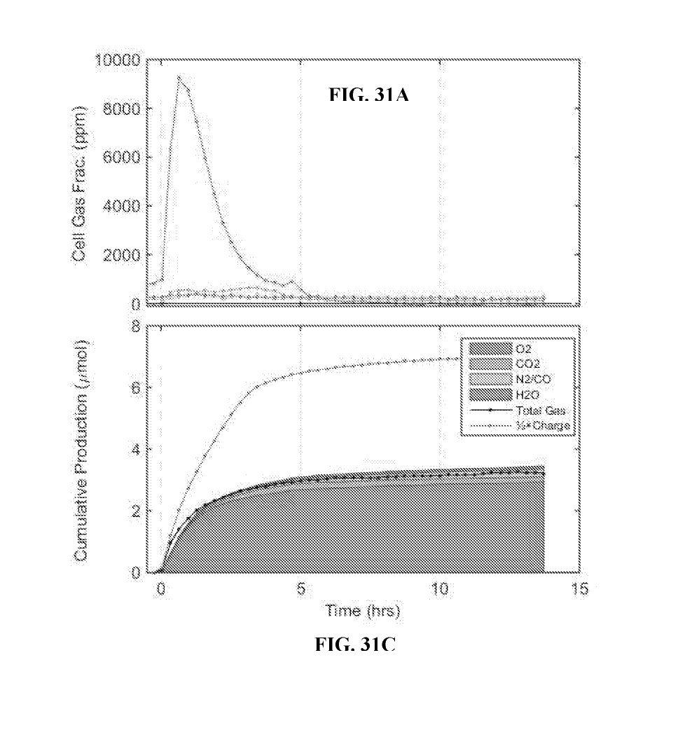

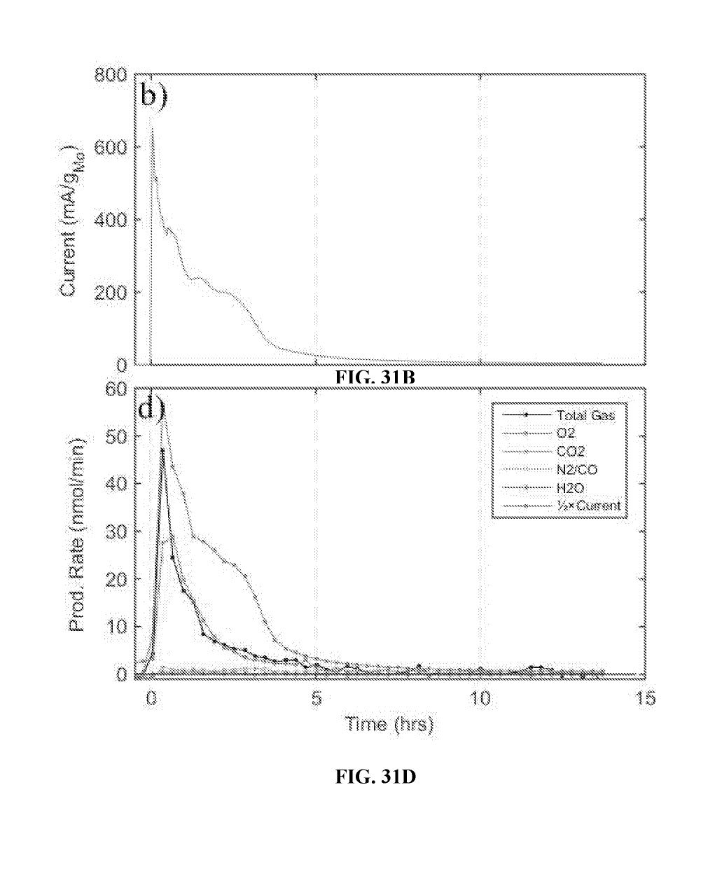

The most significant enhancement effect of the promoter nanoparticles is observed on the Li₂O₂ oxidation reaction during cell charging. The previous probing by X-ray absorption spectroscopy of the chemical processes occurring at 3.9 V_{Li} in presence of metal nanoparticles revealed the chemical conversion of the promoter with Li₂O₂ towards formation of a lithiated metal oxide LiₓM_{y}O_{z} (Li₂O₂+MₐO_{b}±O₂→LiₓM_{y}O_{z}). Therefore, the potential effect of this pathway was investigated on the regeneration of O₂ (Li₂O₂⇄2Li⁺+2e⁻+O₂) and compare the actual process efficiencies across the high activity promoters Mo, Cr, and Ru identified previously. FIGS. 24A-24C and FIG. 25A present the results of DEMS probing of Li₂O₂ electrooxidation in Li₂O₂-preloaded electrodes. FIGS. 24D-24F and FIG. 25B present the results of DEMS probing of Li₂O₂ electrooxidation in O₂-electrodes on charging following their discharge shown in FIGS. 23A-23B. First, for all promoters, the amount of parasitic CO₂ as well as CO, and H₂O formed on charging can be considered negligible at 3.9 V_{Li} in Li₂O₂-preloaded electrodes (FIG. 24C). This observation is further clarified in the raw gas fractions presented in FIGS. 28A, 29A, and 30A; the fractions of CO₂, CO, and H₂O remain flat at background levels seen before initiation of cell charging. In O₂-electrodes, Li₂O₂ electrooxidation following discharge presents a modestly greater fraction of CO₂ (FIG. 25F and FIGS. 31A, 32A, and 33A) as compared to Li₂O₂-preloaded electrodes. This finding is in keeping with the reported formation of Li₂CO₃, HCO₂Li, CH₃CO₂Li electrolyte decomposition products on discharge in ethers such as diglyme. See, S. A. Freunberger, Y. Chen, N. E. Drewett, L. J. Hardwick, F. Bardé and P. G. Bruce, Angew. Chem. Int. Ed., 2011, 50, 8609, and B. D. McCloskey, A. Speidel, R.

Scheffler, D. C. Miller, V. Viswanathan, J. S. Hummelshøj, J. K. Nørskov and A. C. Luntz, J. Phys. Chem. Lett., 2012, 3, 997, each of which is incorporated by reference in its entirety. The decomposition of these carbonates on subsequent charging explains the greater amount of CO₂ compared to preloaded electrodes where discharge is bypassed for the purpose understanding the Li₂O₂ oxidation reaction with minimal interference from parasitic products.

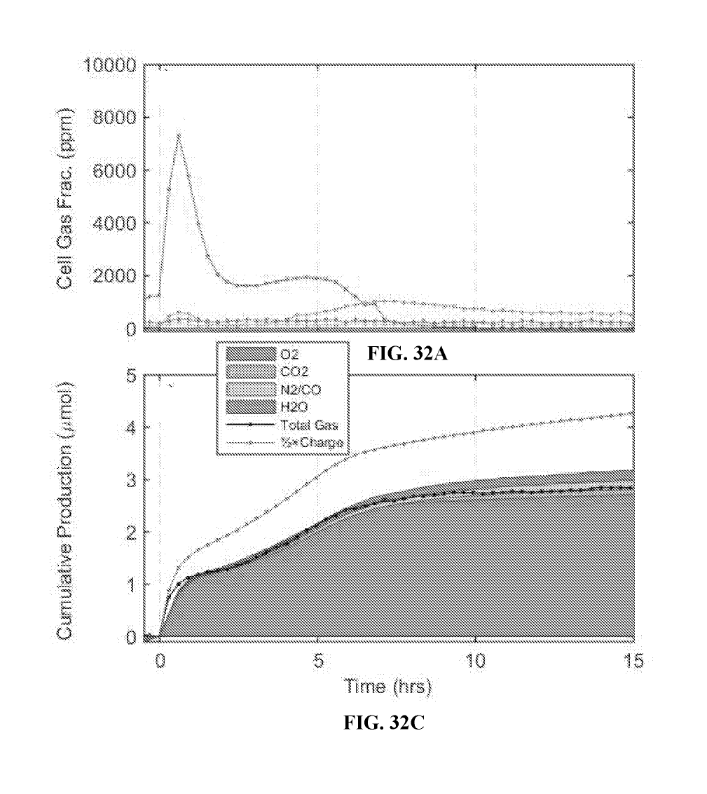

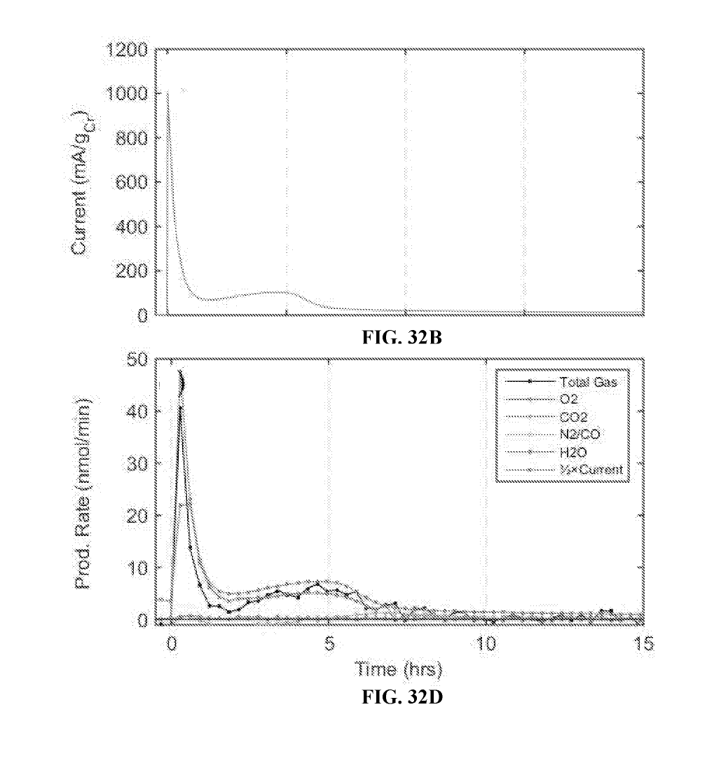

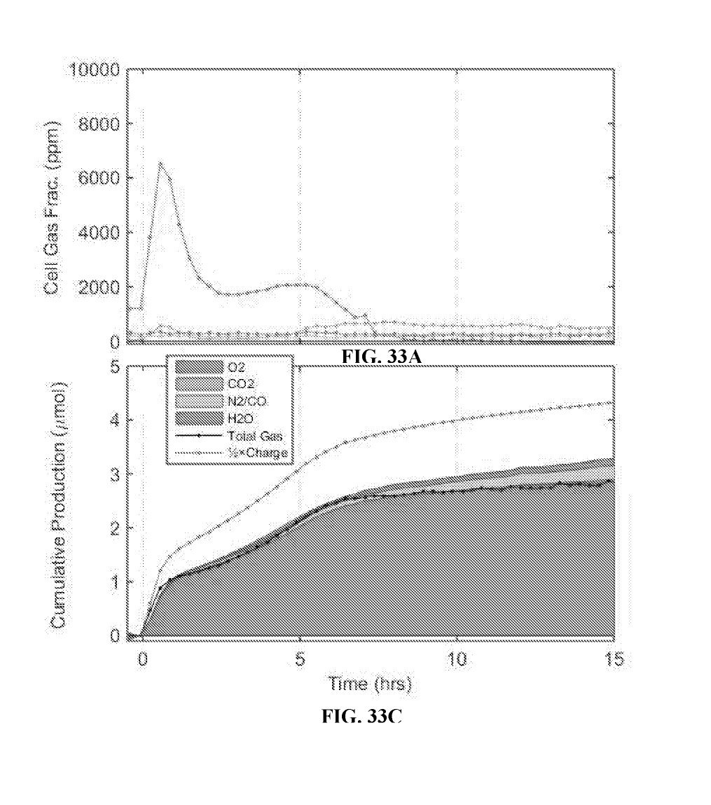

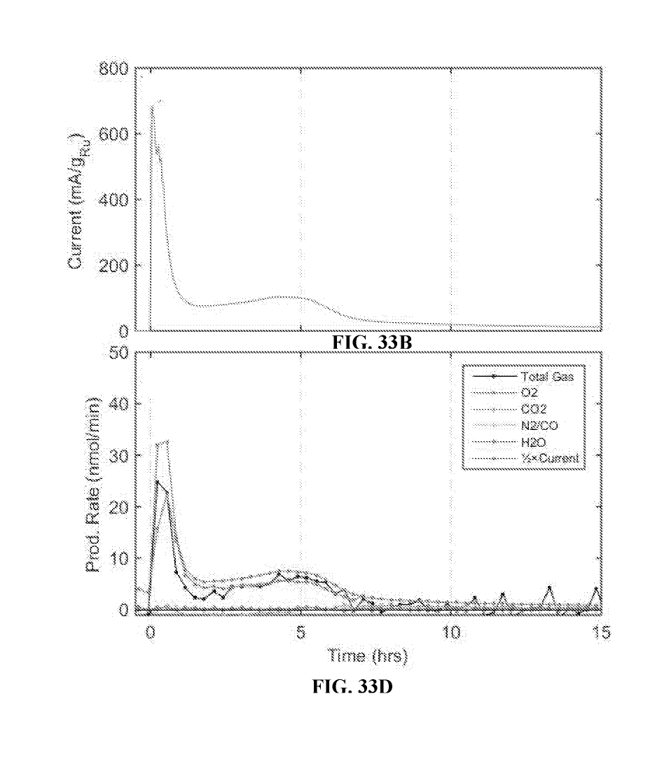

FIGS. 24A and 24D show the current profiles normalized to the promoter masses in Li₂O₂-preloaded and O₂-electrodes, respectively. Contrary to the findings in DME-based electrolytes (see above), a much degraded performance of preloaded Mo electrodes was observed compared to Cr and Ru (FIG. 24A). This degradation of performance of Mo electrodes could be a result of stronger conversion of Mo and Li₂O₂ to form Li₂MoO₄ in the pristine electrode state which was identified as causing incomplete and degraded electrode recharge. This postulate is corroborated in FIG. 24D. Contact time between Li₂O₂ formed in operando and Mo is on the order of 10 hour (imposed rest period between discharge and charge) in O₂-electrode compared to a few days of drying and storage in the case of preloaded electrodes. With limited contact between Li₂O₂ and Mo, limited surface conversion occurs that maintains the greater activity of Mo compared to Cr and Ru in agreement with previous observations. Desired O₂ is the main gas observed in both Li₂O₂-preloaded and O₂-electrodes as seen in FIGS. 24B and 24E, respectively. The trend in O₂ production rate agrees well with measured currents in FIGS. 24A and 24D. Noteworthy is the fact that with their very similar electrochemical activities, Cr and noble metal Ru display practically identical O₂ evolution profiles for Li₂O₂ oxidation (FIGS. 24B and 24E, FIGS. 32C and 33C). Albeit, the performance of Mo is poor in preloaded electrodes in the present study with diglyme-based electrolyte (FIG. 24B), its greater activity in O₂-electrodes is accompanied with improved oxygen evolution (FIG. 24E).

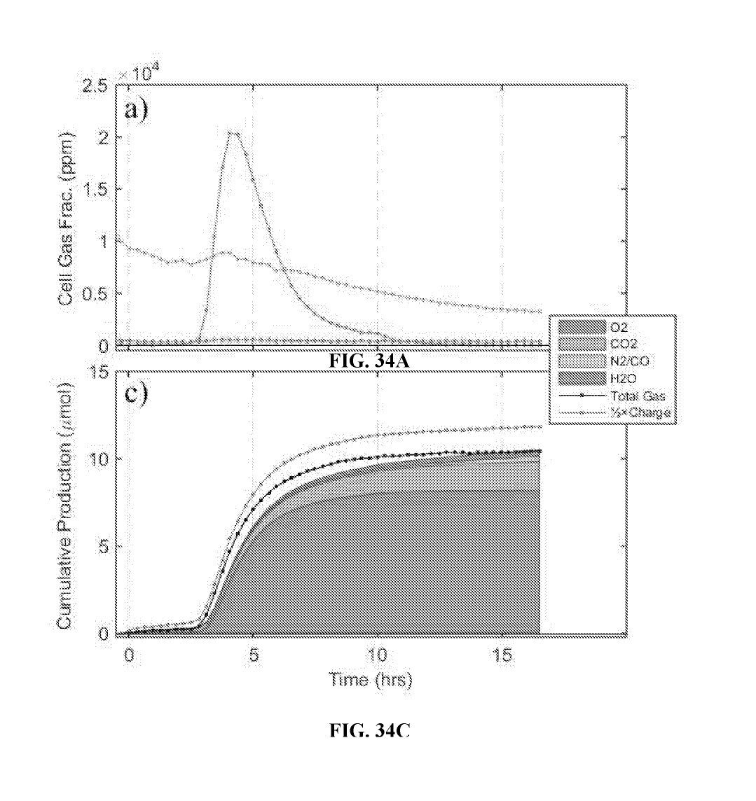

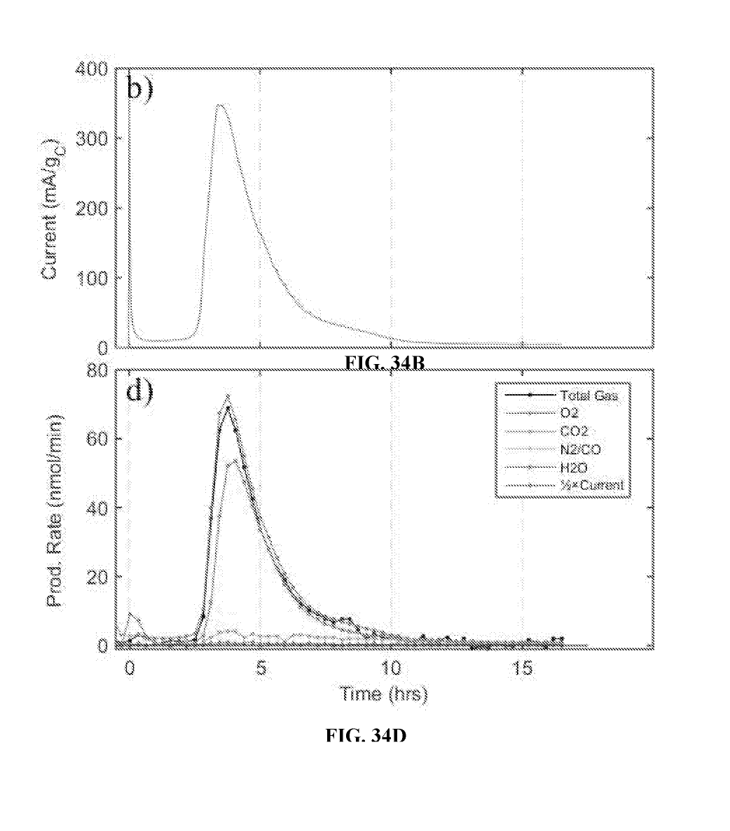

Nonetheless, rates of oxygen evolution upon charging is sub-stoichiometric compared to the current observed considering the 2e⁻/O₂ reaction (Li₂O₂ [symbol] 2Li⁺+2e⁻+O₂) both in Li₂O₂-preloaded electrodes (FIG. 25A) and O₂-electrodes (FIG. 25B). In Li₂O₂-preloaded electrodes, Cr electrodes follow a similar trend as Ru for e⁻/O₂ vs. charge (FIG. 25A) although the calculated average values are 3.37 and 2.82 respectively. A similar agreement in trend is observed in O₂-electrodes (FIG. 25B) with computed average values of 3.02 and 3.06 e⁻/O₂ for Cr and Ru respectively. Similarity between Cr and Ru agrees with their comparable enthalpies of conversion with Li₂O₂ and BET surface areas as discussed above. Mo-based electrodes average 3.73 and 4.82 e⁻/O₂ in preloaded and O₂-electrodes respectively although no significantly greater amount of CO₂ is observed (FIGS. 28A-28D and 31A-31D respectively). The greater deviation of Mo electrodes from the stoichiometric value of 2e⁻/O₂ is a reflection of the greater driving force for conversion with Li₂O₂ to Li₂MoO₄ (partially oxidized, −939 kJp19 mol⁻¹) compared to Li₂CrO₄ for Cr (Cr₂O₃-coated, −440 kJ·mol⁻¹) and Li₂RuO₃ for Ru (partially oxidized, −446 kJ·mol⁻¹). The delithiation at 3.9 V_{Li} (Li₂MO_{(y=3,4)} [symbol] 2Li⁺+MOₓ+½(y−x)O₂) of the chemically lithiated metal oxide which contributes to the externally measured activity of electrodes cannot be expected to result in 2e⁻/O₂, hence likely to cause greater stoichiometric deviations. Prior studies utilizing DEMS or OEMS for gas quantification generally report sub-stoichiometric O₂ regeneration from Li₂O₂ oxidation in Li—O₂ cells. See, B. D. McCloskey, J. M. Garcia and A. C. Luntz, J. Phys. Chem. Lett., 2014, 5, 1230, S. Meini, S. Solchenbach, M. Piana and H. A. Gasteiger, J. Electrochem. Soc., 2014, 161, A1306, B. D. McCloskey, D. S. Bethune, R. M. Shelby, T. Mori, R. Scheffler, A. Speidel, M. Sherwood and A. C. Luntz, J. Phys. Chem. Lett., 2012, 3, 3043, and S. Meini, N. Tsiouvaras, K. U. Schwenke, M. Piana, H. Beyer, L. Lange and H. A. Gasteiger, Phys. Chem. Chem. Phys., 2013, 15, 11478, each of which is incorporated by reference in its entirety. McCloskey et al. report values of 2.59 e⁻/O₂ in recharging O₂-electrodes with the LiTFSI/monoglyme (DME) electrolyte. See, B. D. McCloskey, R. Scheffler, A. Speidel, D. S. Bethune, R. M. Shelby and A. C. Luntz, J. Am. Chem. Soc., 2011, 133, 18038, and B. D. McCloskey, D. S. Bethune, R. M. Shelby, T. Mori, R. Scheffler, A. Speidel, M. Sherwood and A. C. Luntz, J. Phys. Chem. Lett., 2012, 3, 3043, each of which is incorporated by reference in its entirety. Gasteiger et al. used OEMS to report values of 2.6 e⁻/O₂ and 2-2.4 e⁻/O₂ in preloaded electrodes with LiTFSI/diglyme electrolyte and carbon-only electrode. See, S. Meini, N. Tsiouvaras, K. U. Schwenke, M. Piana, H. Beyer, L. Lange and H. A. Gasteiger, Phys. Chem. Chem. Phys., 2013, 15, 11478, and S. Meini, S. Solchenbach, M. Piana and H. A. Gasteiger, J. Electrochem. Soc., 2014, 161, A1306, each of which is incorporated by reference in its entirety. The potentiostatic DEMS investigation at 4.4 V_{Li} (chosen to enable reasonable rate of oxygen evolution in VC-only electrodes) of VC:Li₂O₂:LiNafio=1:1:1 electrodes yielded 2.89 e⁻/O₂ with a relatively greater amount of CO₂ evolved (FIG. 34A-34D). The greater CO₂ evolution compared to metal promoted electrodes polarized to 3.9 V_{Li} is a consequence of the higher 4.4 V_{Li} applied voltage resulting in enhanced oxidation of the diglyme electrolyte; a fact which highlights the usefulness of promoter nanoparticles in enabling lower recharge potentials to mitigate electrolyte oxidation.

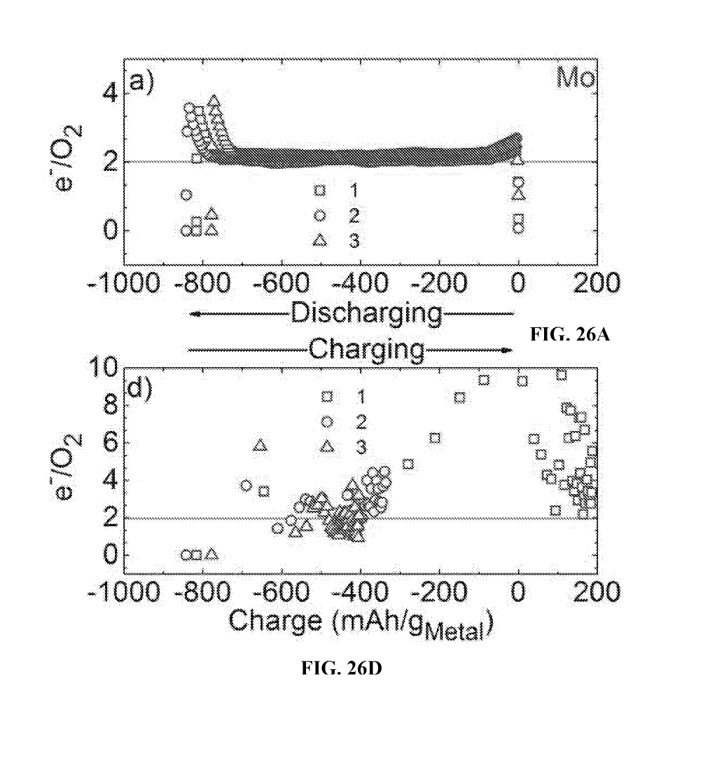

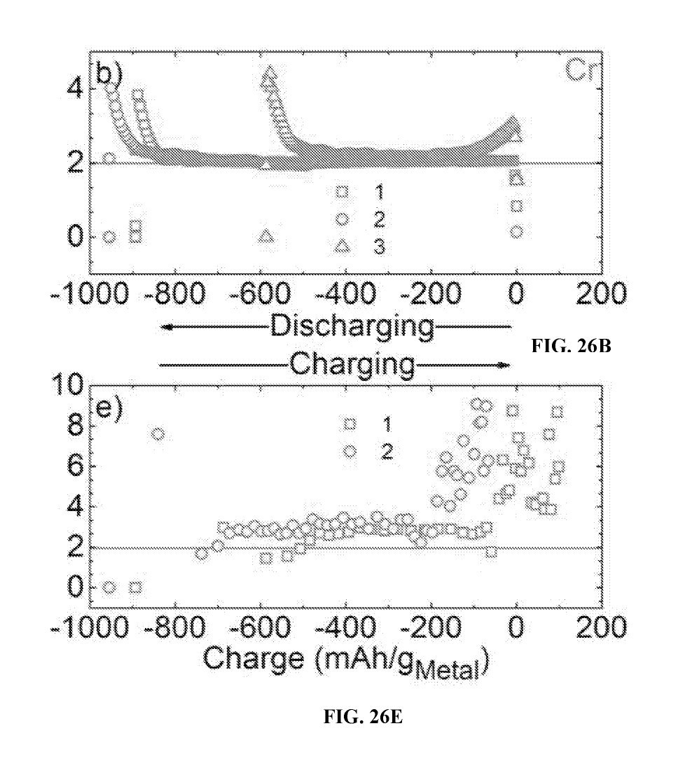

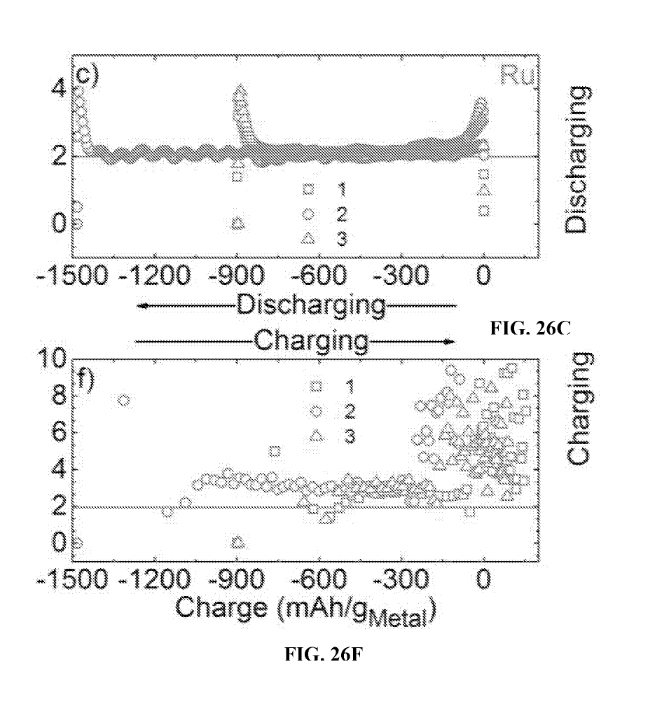

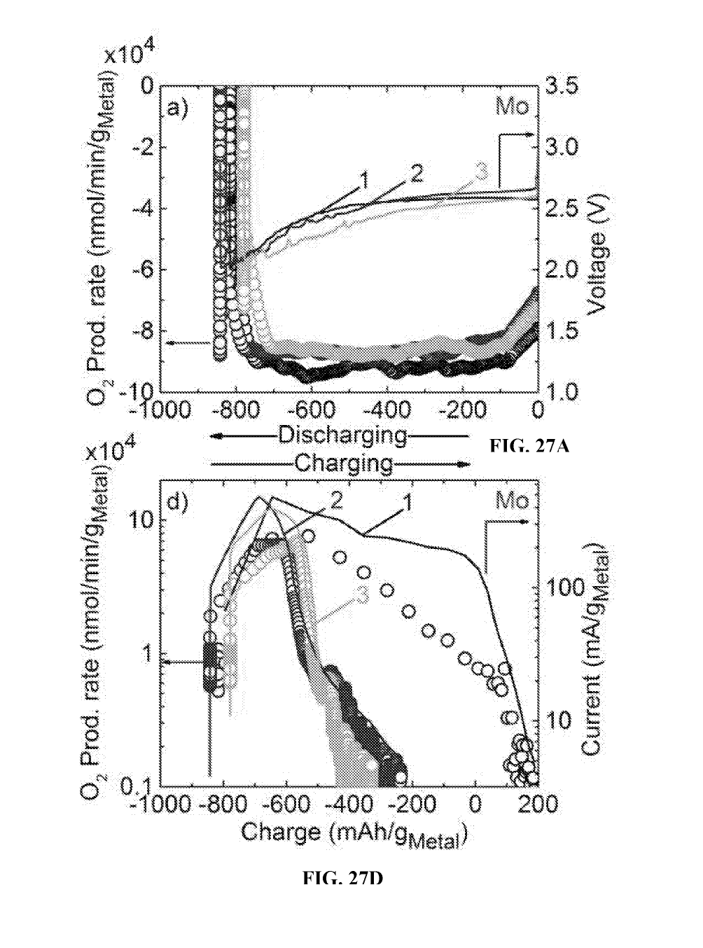

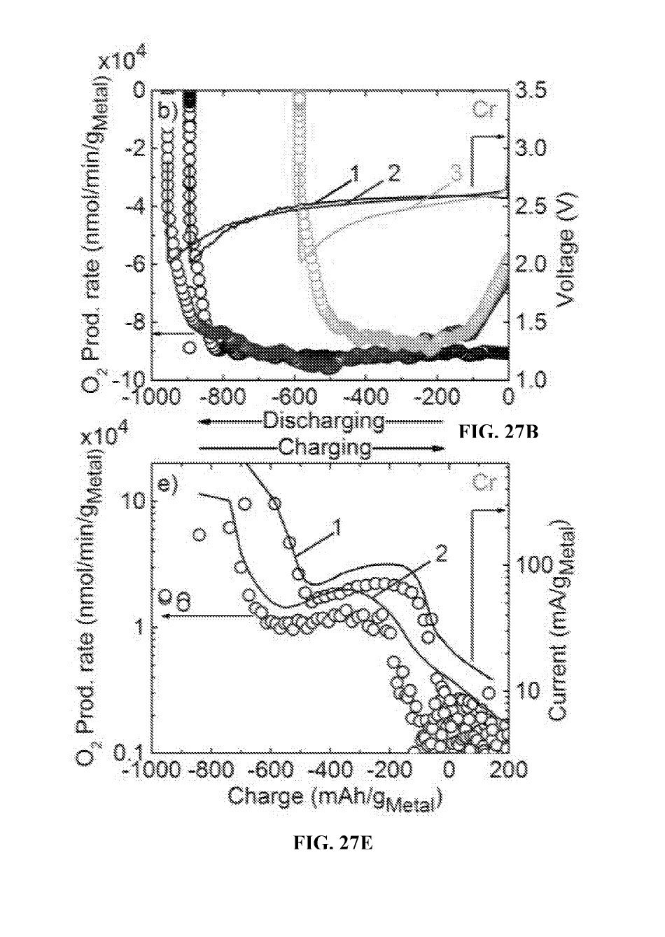

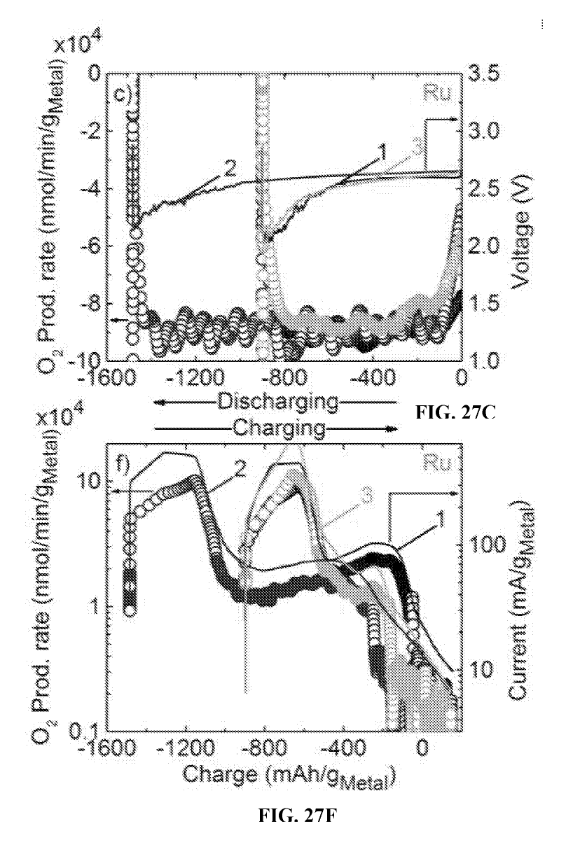

The consumption and regeneration of O₂ during cycling of Mo, Cr, and Ru-promoted O₂-electrodes was investigated (FIGS. 26A-26F and 27A-27F). All promoted electrodes display approximately the ideal 2 e⁻/O₂ from one cycle to the next for the first three discharge cycles investigated (FIGS. 26A, 26B, and 26C). Rates of oxygen consumption over three cycles are comparable (in agreement with the constant applied current at 200 mA·g⁻¹_{Carbon}=300 mA·g⁻_{Promoter}) for Mo, Cr, and Ru-promoted electrodes which suggests that the promoters do not significantly affect the discharge mechanism (FIGS. 27A, 27B, and 27C). Variations in discharge capacity over cycles are observed which also do not appear to have effects on the gas consumption rates; Li₂O₂ appears to be the major discharge product throughout discharge for three cycles of Mo, Cr, and Ru-promoted O₂-electrodes.

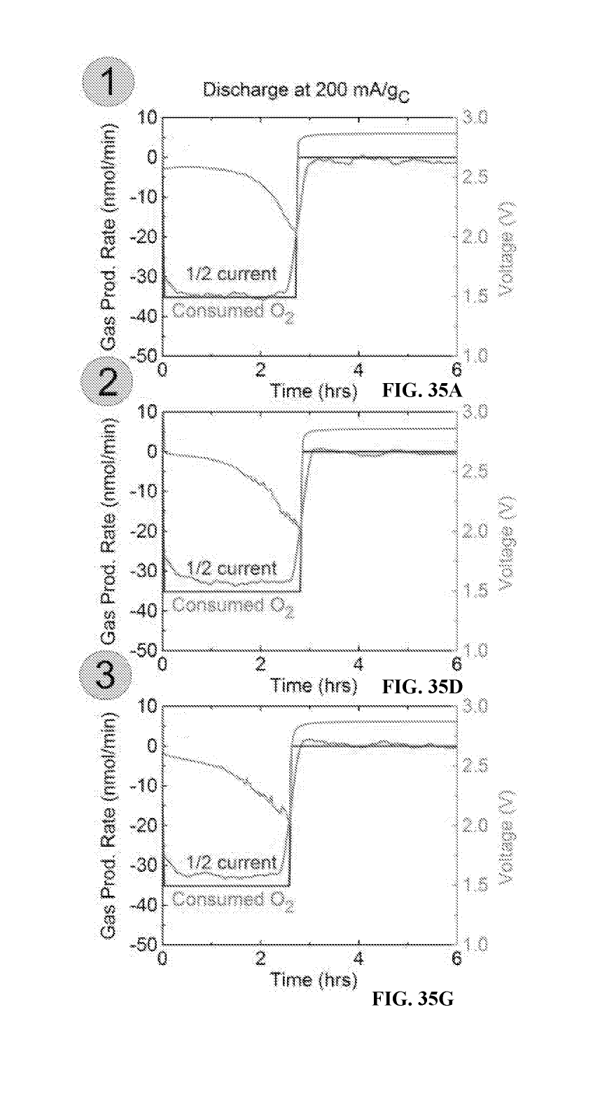

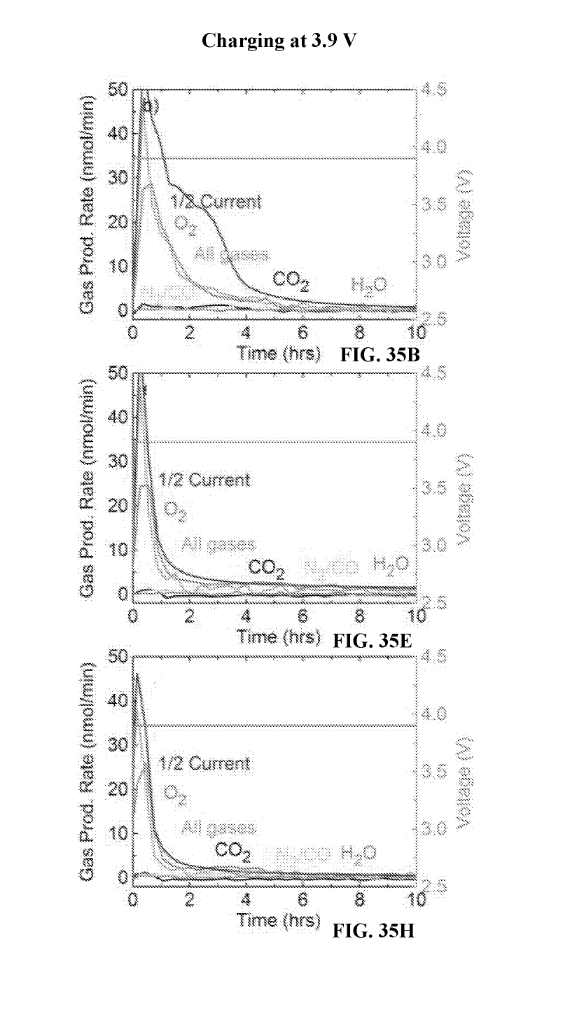

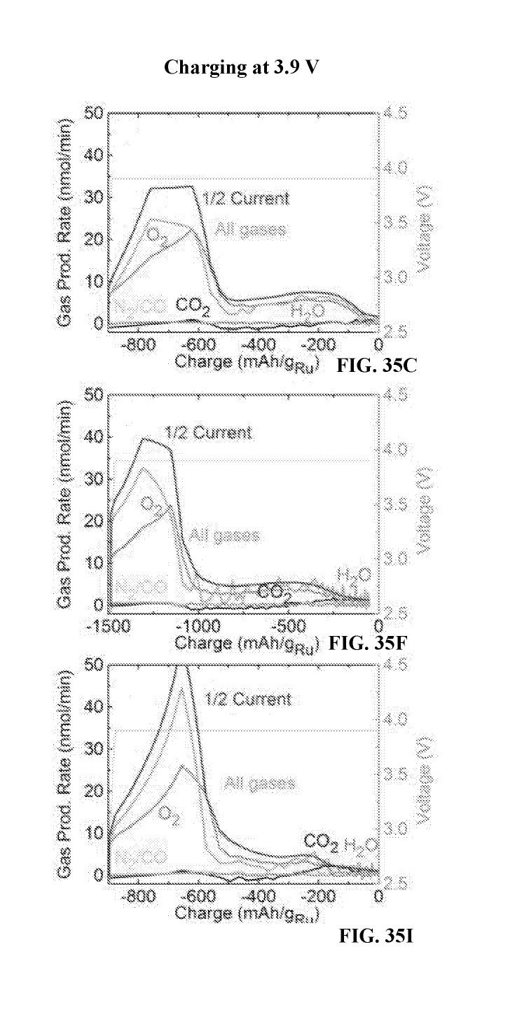

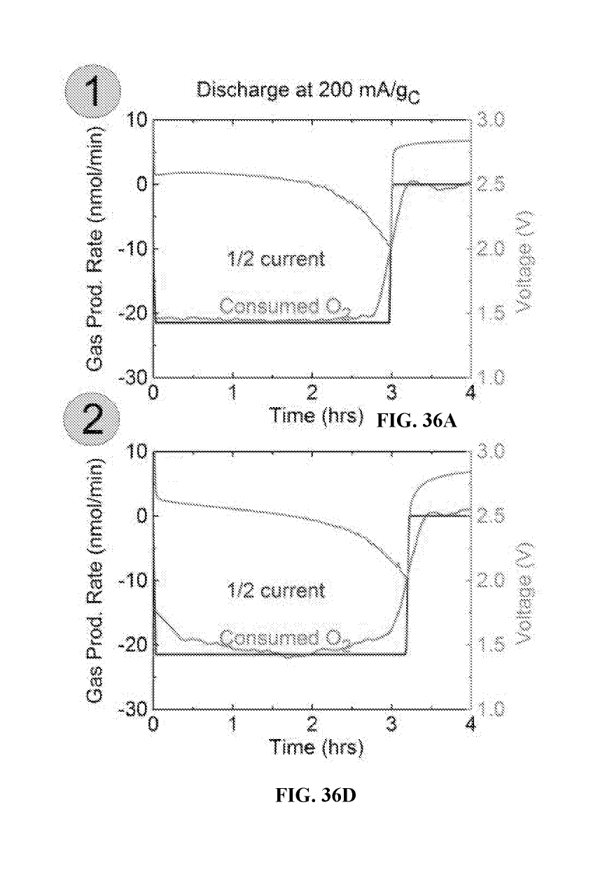

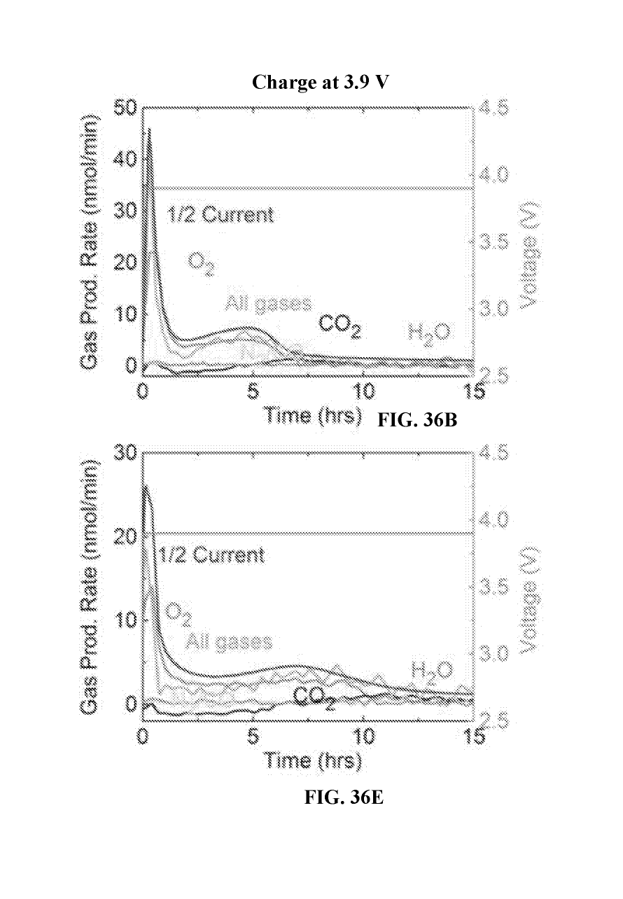

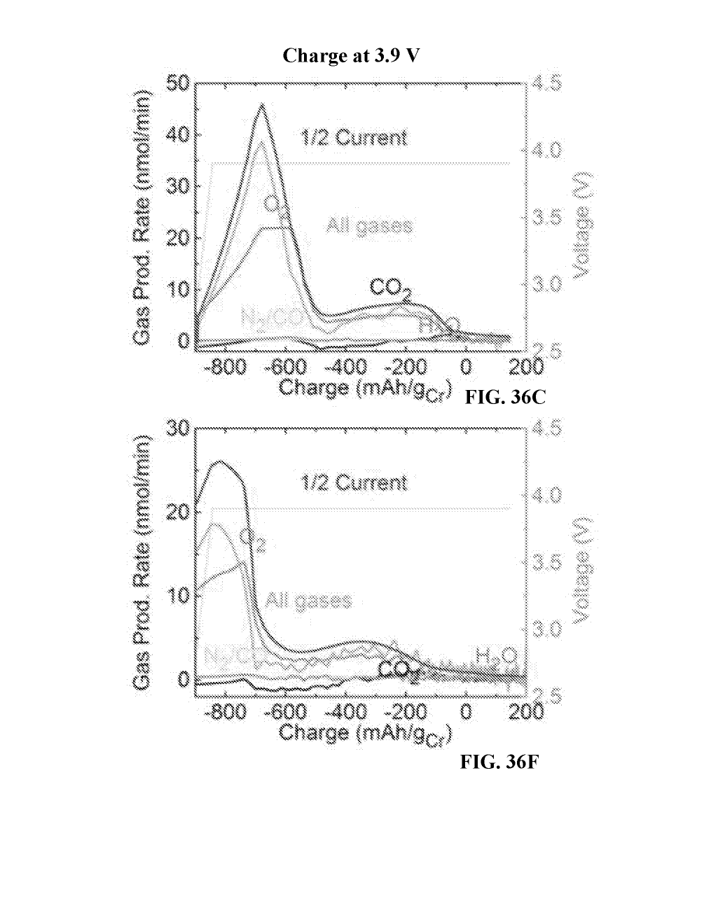

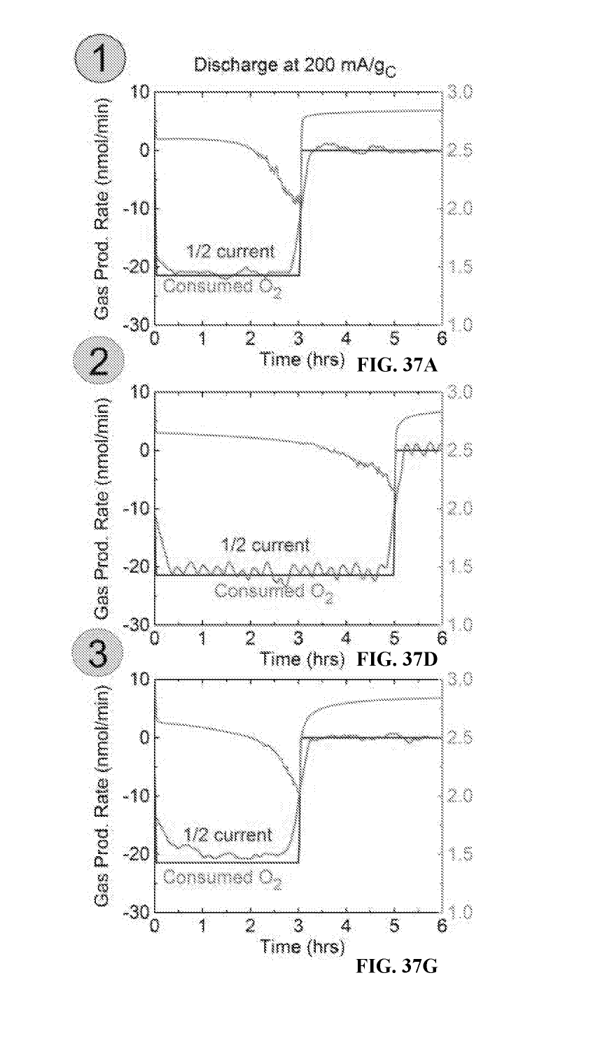

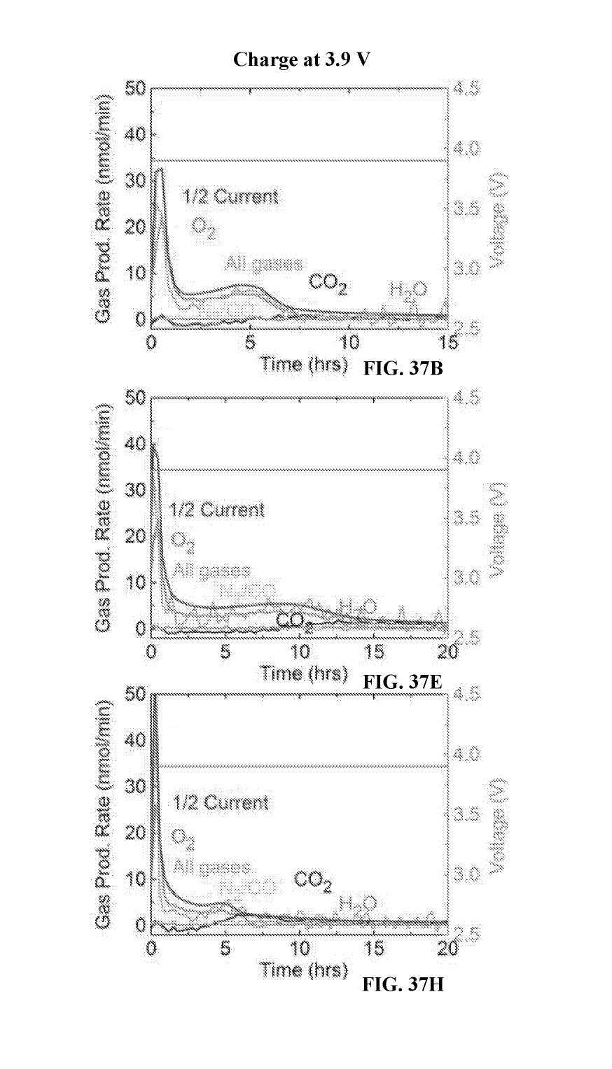

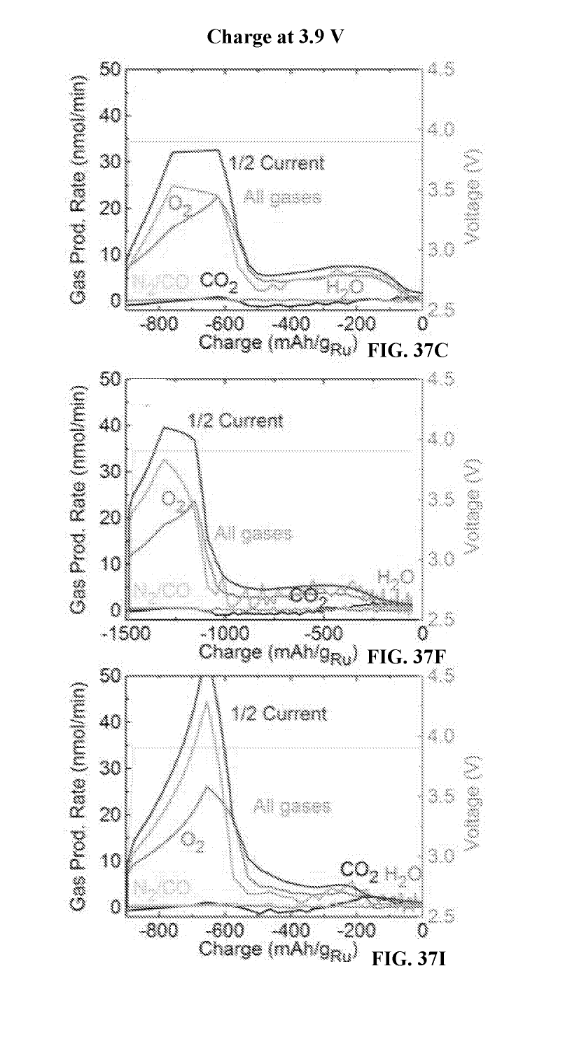

As discussed above, charging of Li—O₂ cells generally does not follow the desired 2e⁻/O₂ decomposition of the Li₂O₂ formed on discharge. Upon charging in FIGS. 26D, 26E, and 67F, Mo, Cr, Ru-promoted electrodes all depart from the ideal 2e⁻/O₂ seen on discharge. FIGS. 27D, 27E, and 27F detail the correspondence between O₂ production rate (left axis) and current (right axis) for the first three cycles. Both axes are scaled to be equivalent according to 311 mA per nmol·min⁻of oxygen for 2 e⁻/O₂ reaction. Although the general shape of O₂ production rates trace that of the current profile, it is obvious that more current is generated than O₂ collected for all promoters. Noteworthy is that Cr and Ru maintain rather comparable e⁻/O₂ on charge over the first two cycles measured (FIGS. 26E and 26F) with comparable current generated (FIGS. 27E and 27F). Cr electrodes averaged 3.02 and 3.90 e⁻/O₂ on the first and second cycles respectively while Ru electrodes averaged 3.07, 3.8 and 3.7 e⁻/O₂. The process efficiency in Mo-promoted O-electrodes deviates more significantly from ideal (FIG. 26D). Soon as the first cycle, Mo electrodes oxidize the Li₂O₂ generated on discharge with strongly fluctuating e⁻/O₂ as compared to Cr and Ru electrodes and averages 4.82 e⁻/O₂ (FIG. 26D). However, 3.06 and 2.49 e^{-l /O}₂ are recorded on the second on third cycles of Mo, an improved correspondence between current and O₂ generation over the first cycle 4.82 e⁻/O₂ (FIG. 26D). A permanent oxide layer may form (MoO₂ or MoO₃) on the surface of Mo particles after the first delithiation of Li₂MoO₄ that mitigates the conversion process on subsequent cycles. This fact translates into reduced faradaic activity on the second and third cycles in agreement with MoO₂ and/or MoO₃ having lower activity accompanying greater stability against conversion to Li₂MoO₄. It is worth noting that contrary to Cr and Ru which showed slight excess capacity, incomplete recharge (charging terminated when current falls below ˜5 mA·g⁻¹_{Metal}) occurs in Mo electrodes except on the first higher activity cycle. In spite of the excess current per oxygen generated and deviation from 2C e⁻/O₂ in Cr and Ru, only trace amounts of CO₂, CO, and H₂O were observed during the potentiostatic charging cycles at 3.9 V_{Li}. Other parasitic oxidation reactions might be occurring that do not evolve O₂, CO₂, CO, and H₂O (FIGS. 35, 36, and 37). Once more, an obvious candidate for such reaction is the “surface chemical lithiation followed by electrochemical delithiation” mechanism which underlies the measured high activity of certain metal (oxide) such as Mo, Cr, and Ru nanoparticles.

In conclusion, metal nanoparticle promoters offer an avenue for reduction of the large overpotential pervasive during Li—O₂ cells recharge and thereby increase recharge efficiency and lower parasitic oxidation of the organic electrolyte. Here the process efficiency of promising promoter nanoparticles Mo, Cr, and Ru are shown. The following four major findings are highlighted: (i) Li₂O₂ with 2 e⁻/O₂ is the major discharge product independent of the presence of Mo, Cr, or noble metal Ru. The discharge pathway (2Li⁺+O₂ [symbol] Li₂O₂) is unaffected by the promoter nanoparticle as revealed through comparable discharge voltage of ˜2.6 V_{Li} at 200 mA·g⁻¹_{Carbon}=300 mA·g⁻¹_{Promoter} for all three promoters studied. (ii) Oxidation of the Li₂O₂ discharge product results in sub-stoichiometric regeneration of O₂ in agreement with literature reports. In particular, Mo electrodes depart strongly from 2 e⁻/O₂ with significant fluctuations likely as a result of the greater thermodynamic driving force (−939 kJ·mol⁻¹ for Li₂O₂+Mo+O₂ [symbol] Li₂MoO₄) for conversion of Mo with Li₂O₂ towards Li₂MoO₄. In contrast Cr and Ru with medium and similar conversion enthalpies (approximately −440 kJ·mol⁻¹ for Li₂O₂+½Cr₂O₃+½O₂ [symbol] Li₂CrO and Li₂O₂+Ru+½O₂ [symbol] Li₂RuO₃), display values around 3 e⁻/O₂ prior to fluctuations observed beyond full recharge. Remarkably, the correlation between conversion enthalpy and promoter electrochemical activity is further reflected in the similarity between Cr and Ru in terms of both current and oxygen evolution rates at 3.9 V_{Li} in Li₂O₂ preloaded as well as O₂-electrodes. Low cost Cr nanoparticle promoted electrodes would be an excellent substitute for higher cost noble metal Ru electrodes extensively used in Li—O₂ batteries. (iii) Only minor amount of CO₂, CO and H₂O are measured during cycling charging at 3.9 V_{Li}, which emphasize the utility of promoter nanoparticles to enable charging voltage below 4.0 V_{Li}, for electrolyte stability.

### EXAMPLES

Electrode Preparation

The electrochemical oxidation kinetics of Li₂O₂ were studied using promoters including metal nanoparticles of Mo (US Research Nanomaterial Inc., Purity=99.9%, SSA_{BET}=4 m²·g⁻¹), Cr (US Research Nanomaterial Inc., 99.9%, 26 m²·g⁻¹), Co (US Research Nanomaterial Inc., 99.8%, 21 m²·g⁻¹), Ru (Sigma Aldrich, ≧98%, 23 m²·g⁻¹), Mn (American Elements, Mn₃O₄ shell, 99.9%, 24 m²·g⁻¹) and metal oxide particles of MoO₃ (Sigma Aldrich, 99.98%, 1.8 m²·g⁻¹) Cr₂O₃ (Sigma Aldrich, 99%, 20 m²·g⁻¹), Co₃O₄ (Sigma Aldrich, 99.5%, 36 m²·g⁻¹), RuO₂ (Sigma Aldrich, 99.9%, 16.2 m²·g⁻¹) nanoparticles and α-MnO₂ nanowires (Synthesized, SSA_{BET}=85 m²·g⁻¹, X-ray diffraction pattern provided in FIG. 11; All major peaks of α-MnO₂ are resolved confirming the effective synthesis of the intended phase.). See, S. Devaraj and N. Munichandraiah, J. Phys. Chem. C, 2008, 112, 4406, which is incorporated by reference in its entirety. BET specific surface areas were determined using a Quantachrome ChemBET. Carbon-free, gold-foil (Sigma Aldrich, 99.99%) supported, and carbon-containing, aluminum-foil (Targray Inc.) supported electrodes were entirely prepared in an argon-filled glovebox (MBraun, water content <0.1 ppm, O₂ content <1%). All fabrication tools were dried at 70° C. prior to use. All nanoparticles and Vulcan XC72 carbon (Premetek, ˜100 m²·g⁻¹) were dried under 30 mbar vacuum, at 100° C., in a Buchi® B585 glass oven and transferred into the glovebox without further exposure to air.

Carbon and binder free gold-supported electrodes, having a fixed promoter:Li₂O₂ mass ratio of 0.667:1, were prepared using the following method reported previously. See, K. P. C. Yao, Y.-C. Lu, C. V. Amanchukwu, D. G. Kwabi, M. Risch, J. Zhou, A. Grimaud, P. T. Hammond, F. Bardé and Y. Shao-Horn, Phys. Chem. Chem. Phys., 2014, 16, 2297, which is incorporated by reference in its entirety. Due to embrittlement of the gold foil in presence of Mo, Mo-promoted electrodes were deposited on battery grade aluminum foil. Masses of 10 mg promoter and 15 mg of ball-milled Li₂O₂ (Alfa Aesar, ≧90%, ˜345 nm after ball-milling) were mixed in 1 mL anhydrous 2-propanol (IPA, Sigma Aldrich, 99.5%) and horn-sonicated at 50% pulses of 30 W for 30 minutes. After sonication, 40 μL of the slurry is dropcasted onto ½ inch diameter gold foil, resulting in a material loading of ˜0.8 mg·cm⁻². Upon evaporation of the IPA, the gold disk was enclosed between two dried aluminum sheets and sealed in an argon-filled heat-seal bag. The sealed bag was removed from the glovebox and pressed at 5 tons under a hydraulic press to secure the promoter:Li₂O₂ mixture onto the gold foil.

Carbon-containing electrodes, with Vulcan XC72 carbon as electrically conducting backbone, were deposited on battery grade aluminum foil at a mass ratio of promoter:VC:Li₂O₂:LiNafion binder=0.667:1:1:1 using a #50 Mayer rod. See, J. R. Harding, Y.-C. Lu, Y. Tsukada and Y. Shao-Horn, Phys. Chem. Chem. Phys., 2012, 14, 10540, and K. P. C. Yao, Y.-C. Lu, C. V. Amanchukwu, D. G. Kwabi, M. Risch, J. Zhou, A. Grimaud, P. T. Hammond, F. Barde and Y. Shao-Horn, Phys. Chem. Chem. Phys., 2014, 16, 2297, each of which is incorporated by reference in its entirety. Prior to ink casting, 75 mg of Vulcan XC72, 50 mg of promoter, 75 mg of Li₂O₂, and 75 mg equivalent of IPA-dispersed lithium-substituted Nafion (LiNafion, Dupont) were horn-sonicated in IPA at 50% pulses of 30 W for 30 minutes. All electrodes were dried at 70° C. in the Buchi® vacuum oven for a minimum of 12 hours and transferred into the glove box without ambient exposure. The fabrication of electrochemical cells was performed without atmospheric exposure in an Argon-filled glovebox (Mbraun, H₂O<0.1 ppm, O₂<0.1%).

### Electrochemical Testing

The oxidation kinetics of Li₂O₂ was studied in electrochemical cells consisting of an 18 mm diameter lithium foil (Chemetall Germany), 150 μL of 0.1 M LiClO₄ in 1,2 dimethoxyethane (0.1 M LiClO₄/DME, BASF, H₂O<20 ppm by Karl Fischer titration), two pieces of Celgard C480, and an Li₂O₂-preloaded electrode. These cells were tested potentiostatically using a VMP3 potentiostat (BioLogic Inc.).

### X-Ray Absorption Spectroscopy

Ex situ X-ray absorption spectroscopy was performed at the SGM beamline of the Canadian Light Source at first-row transition metal L edges in vacuum. Molybdenum L edges were recorded in vacuum at the SXRMB beamline of the Canadian Light Source and in a helium atmosphere at the 9-BM-B beamline station at the Advanced Photon Source. Chromium K-edges were collected in a helium atmosphere at beamline X11A of the National Synchrotron Light Source. All spectra were acquired in the surface sensitive electron yield mode at room temperature. The spectra were processed as reported previously. See, K. P. C. Yao, Y.-C. Lu, C. V. Amanchukwu, D. G. Kwabi, M. Risch, J. Zhou, A. Grimaud, P. T. Hammond, F. Bardé and Y. Shao-Horn, Phys. Chem. Chem. Phys., 2014, 16, 2297, and M. Risch, A. Grimaud, K. J. May, K. A. Stoerzinger, T. J. Chen, A. N. Mansour and Y. Shao-Horn, J. Phys. Chem. C, 2013, 117, 8628, each of which is incorporated by reference in its entirety. Energy axes are calibrated to appropriate metal references. The promoter metal (Mo, Cr, Co, Mn) L-edges were collected for the nanoparticle powder, a pristine electrode, a partially charged electrode, and fully charged electrode. Mo L edge spectra of MoO₂ (Alfa-Aesar, 99%), MoO₃ (Sigma Aldrich, 99.98%), Li₂MoO₄ (Alfa Aesar, 99.92%), Mo foil (Sigma Aldrich, 99.9%) and Cr K edge K₂CrO₄ (Alfa Aesar, 99%) were collected and used as references.

### Inductively Coupled Plasma Atomic Emission Spectra

Inductively coupled plasma atomic emission spectra (ICP-AES) were collected from the electrolyte after electrochemical oxidation of Li₂O₂ in presence of Mo, Cr, Co, Co₃O₄, and α-MnO₂. As any dissolution of transition-metal-containing species could plate on the lithium anode, “2-compartment” cell was utilized reported by Gasteiger et al., which consists of lithium foil||Celgard C480 with 50 μL 0.1 M LiClO₄/DMEH||Ohara solid electrolyte||Celgard C480 with 100 μL 0.1 M LiClO₄/DME||Carbon-free Li₂O₂-loaded electrode. See, R. Bernhard, S. Meini and H. A. Gasteiger, J. Electrochem. Soc., 2014, 161, A497, which is incorporated by reference in its entirety. The C480 separator in contact with the Li₂O₂ electrode was collected post charging, and was immersed in DME (BASF, H₂O<20 ppm by Karl Fischer titration), which was combined with DME that was used to rinse the surface of the solid electrolyte for a total of 3 mL DME.

The resulting DME solution was then centrifuged at 7000 rpm for 10 minutes to remove solid particulates, which was pipetted subsequently out into a new vial and evaporated slowly at 40° C. on a hot plate. 0.5 mL of 37 wt % HCl was added to the dried vial to dissolve any solid precipitates, which was then evaporated slowly on a hot plate. Finally, the vial was rinsed with 10 mL of 2 wt % nitric acid (Sigma Aldrich, TraceSelect®) to create the ICP sample. ICP standards at 0, 1, 2, and 5 ppm were also generated for Mo (RICCA CHEMICAL COMPANY® 1000 ppm in 3% HNO₃ with trace HF), Cr, Co, and Mn from standard solutions (Fluka TraceCERT®, 1000 ppm in 2% HNO₃). ICP-AES data were collected using a Horiba ACTIVA-S spectrometer.

E lectrode Preparation for DEMS Experiments

The most active metal nanoparticles discovered above, namely Mo (US Research Nanomaterial Inc., purity=99.9%, SSA_{BET}=4 m²·g⁻¹), Cr (US Research Nanomaterial Inc., 99.9%, 26 m²·g⁻¹), Ru (Sigma Aldrich, ≧98%, 23 m²·g⁻¹) were selected for further study using DEMS. Vulcan XC72 (VC, Premetek, ˜100 m²·g⁻¹) carbon-supported electrodes containing these three promoter nanoparticles where fabricated in an argon-filled glovebox (MBraun, water content <0.1 ppm, O₂ content <1%). Fabrication tools consisting of a #50 mayer rod, battery grade aluminum foil (Targray Inc.), and Celgard C480 cell separator sheet (Celgard Inc.) were dried at 70° C. prior to use. Nanoparticles powders of VC, Mo, Cr, and Ru were dried at 100° C. under a 30 mbar vacuum in a Buchi® B585 oven. Transfer of the dried nanoparticles occurred with isolation from ambient air within the Buchi® vacuum tube.

Oxygen electrodes of VC:(Mo, Cr, Ru):LiNafion=1:0.667:1 (mass ratios) were obtained by ink-casting on a sheet of Celgard C480. A mixture of 75 mg of Vulcan XC72, 50 mg of promoter, and 75 mg equivalent of IPA-dispersed lithium-substituted Nafion (LiNafion, Dupont) was homogenized in IPA by horn-sonication at 50% pulses of 30 W for 30 minutes. Similarly, Li₂O₂-preloaded electrodes of VC:(Mo, Cr, Ru):Li₂O₂:LiNafion=1:0.667:1:1 (mass ratios) were obtained by ink-casting on a sheet of aluminum. A mixture of 75 mg of Vulcan XC72, 50 mg of promoter, 75 mg of Li₂O₂ (Alfa Aesar, ≧90%, ˜345 nm after ball-milling), and 75 mg equivalent of IPA-dispersed LiNafion was homogenized in IPA by horn-sonication at 50% pulses of 30 W for 30 minutes.

Within the anaerobic environment of the glovebox, half-inch diameter discs were punched and secured in the vacuum tube of the Buchi® oven tube and dried at 70° C. for a minimum of twelve hours before cell assembly.

### DEMS Experiments

Electrochemical cells made of either O₂ electrodes or Li₂O₂-preloaded electrodes were fabricated in an argon glovebox (MBraun, water content <0.1 ppm, O₂ content <0.1 ppm) and subjected to DEMS measurement. All cells consisted of 150 μm lithium foil (RockWood Lithium Inc.), 0.1 M lithium bis(trifluoromethane)sulfonimide (LiTFSI) in diglyme (20 ppm nominal after drying on molecular sieves) and an O₂ or Li₂O₂-preloaded electrode. Cells consisting of lithium foil||2 Celgard C480 separators with 150 μL of 0.1 M LiTFSI in Diglyme||0.5 inch electrode were assembled in a custom cell with an internal volume of ca. 2.9 mL. An in-house DEMS based on a design reported by McCloskey et al. and Jonathon et al. ^{25,26} was utilized to monitor oxygen consumption during discharge and gas evolution on charge. See, B. D. McCloskey, D. S. Bethune, R. M. Shelby, G. Girishkumar and A. C. Luntz, J. Phys. Chem. Lett., 2011, 2, 1161, J. R. Harding, C. V. Amanchukwu, P. T. Hammond and Y. Shao-Horn, J. Phys. Chem. C, 2015, 119, 6947, and J. R. Harding, in Chemical Engineering, Massachusetts Institute of Technology, hdl.handle.net/1721.1/98707, 2015, each of which is incorporated by reference in its entirety. Oxygen consumption during galvanostatic discharge at 200 mA·g⁻¹_{Carbon}=300 mA·g⁻¹_{Promoter} of O₂ electrodes was quantified via pressure drop monitoring at two second intervals. O₂, CO₂, and H₂O evolution during potentiostatic charge of both O₂ and Li₂O₂-preloaded electrodes was quantified at 15-minute intervals using a mass spectrometer coupled with pressure monitoring. Linear interpolation is used to match electrochemical and DEMS measurement in the all figures presented herein. Details of DEMS and cell technical construction are available online. See, J. R. Harding, in Chemical Engineering, Massachusetts Institute of Technology, hdl.handle.net/1721.1/98707, 2015, which is incorporated by reference in its entirety.

Other embodiments are within the scope of the following claims.

1. A metal-air electrochemical system comprising:
a first electrode and a second electrode; and an electrolyte in contact with the first electrode and the second electrode; wherein the second electrode includes a promoter including a transition- metal-containing species.

2. The electrochemical system of claim 1, wherein the first electrode includes lithium (Li).

3. The electrochemical system of claim 1, wherein the second electrode includes oxygen.

4. The electrochemical system of claim 1, wherein the transition-metal-containing species is molybdenum (Mo)-containing species.

5. The electrochemical system of claim 1, wherein the promoter is in form of nanoparticles.

6. The electrochemical system of claim 1, wherein the promoter further includes a metal selected from a group consisting of Ru, Ir, Pt, Au, Cr, and Ni.

7. The electrochemical system of claim 1, wherein the promoter includes a transition metal oxide.

8. The electrochemical system of claim 1, wherein the promoter includes a molybdenum oxide.

9. The electrochemical system of claim 1, wherein the promoter includes a lithiated molybdenum oxide.

10. The electrochemical system of claim 1, wherein the promoter includes a Mo metal, a molybdenum oxide, a lithiated molybdenum oxide, a molybdenum sulfide, or any combination thereof.

11. The electrochemical system of claim 1, wherein the promoter further comprises carbon.

12. The electrochemical system of claim 1, wherein the second electrode is pre-filled with Li2O2.

13. The electrochemical system of claim 1, wherein Li2O2 is formed during discharge.

14. The electrochemical system of claim 1, wherein the electrolyte is non-aqueous.

15. The electrochemical system of claim 1, wherein the electrochemical system includes a conductive support.

16. The electrochemical system of claim 15, wherein the conductive support includes Au or Al.

17. The electrochemical system of claim 1, wherein the second electrode further includes a binder.

18. The electrochemical system of claim 17, wherein the binder is an ionomer.

19. The electrochemical system of claim 1, wherein the promoter is partially dissolved in the electrolyte.

20.-66. (canceled)

67. A method of generating oxygen, comprising:
providing a first electrode and a second electrode; and an electrolyte in contact with the first electrode and the second electrode; wherein the second electrode includes a promoter including a Cr-containing species;
applying an oxygen-generating voltage across the first electrode and the second electrode;
lithiating the Cr-continaing species to a lithiated Cr-containing species; and
delithiating the lithiated Cr-containing species to the Cr-containing species.

68. The method of generating oxygen of claim 67, further comprising generating oxygen by repeating the lithiating the Cr-continaing species and the delithiating the lithiated Cr-containing species.

69. The method of generating oxygen of claim 67, wherein the first electrode includes Li.

70. The method of generating oxygen of claim 67, wherein the second electrode includes oxygen.

71. The method of generating oxygen of claim 67, wherein the promoter is in form of nanoparticles.

72. The method of generating oxygen of claim 67, wherein the promoter further includes a metal selected from a group consisting of Ru, Ir, Pt, Au, Mo, and Ni.

73. The method of generating oxygen of claim 67, wherein the promoter includes a chromium metal oxide.

74. The method of generating oxygen of claim 67, wherein the promoter includes a lithiated chromium oxide.

75. The method of generating oxygen of claim 67, wherein the promoter includes a Cr metal, a chromium oxide, a lithiated chromium oxide, or any combination thereof.

76. The method of generating oxygen of claim 67, wherein the promoter further comprises carbon.

77. The method of generating oxygen of claim 67, further comprising pre-filling the second electrode with Li2O2.

78. The method of generating oxygen of claim 67, further comprising forming Li2O2 during discharge.

79. The method of generating oxygen of claim 67, wherein the electrolyte is non-aqueous.

80. The method of generating oxygen of claim 67, further comprising providing a conductive support.

81. The method of generating oxygen of claim 80, wherein the conductive support includes Au or Al.

82. The method of generating oxygen of claim 67, further comprising providing a binder.

83. The method of generating oxygen of claim 82, wherein the binder is an ionomer.

84. The method of generating oxygen of claim 67, further comprising selecting the promoter and the electrolyte such that the promoter is partially dissolved in the electrolyte.
